(19) United States
(12) Patent Application Publication
(10) Pub. No.: US 2008/0002669 A1
(43) Pub. Date: Jan. 3, 2008

(54) Packet voice gateway

(76) Inventors: Ray O'Brien, Ardnacrusha (IE); Robert Roden, Martock (GB); Charles W. K. Gritton, Sterling, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/788,173

(22) Filed: Apr. 18, 2007

Related U.S. Application Data
(63) Continuation of application No. 10/246,577, filed on Sep. 16, 2002, now abandoned.
(60) Provisional application No. 60/322,834, filed on Sep. 14, 2001.

(51) Int. Cl. H04L 12/66

(52) U.S. Cl. 370/352

(57) ABSTRACT

The methods and apparatus of the present invention can be used to provide a high quality of service across a network that includes packet-based technology. Use of the present invention can yield networks that are more efficient, more resilient and more reliable than prior networks, thus allowing service providers to provide voice and other high quality services through the use of packet networks.

### CROSS-REFERENCE TO RELATED APPLICATION

This application is a continuation of and claims the benefit under Title 35 United States Code, Section 120 of co-pending of U.S. application Ser. No. 10/246,577 filed on Sep. 16, 2002 entitled “Packet Voice Gateway” which claims priority to U.S. Provisional Patent Application No. 60/322,834 filed on Sep. 14, 2001 having the same title.

### BACKGROUND OF THE INVENTION

The present invention relates to communication networks. In particular, the present invention relates to packetized communication networks.

### BACKGROUND OF THE INVENTION

The present invention relates to communication networks. In particular, the present invention relates to packetized communication networks.

For years, the public switched telephone network of the U.S. has provided reliable two-way telephony service. This network is made up of various types of well-known telephony switching systems and well-known physical media over which are carried electrical signals representing voice-frequency information.

Many telephone companies use Digital Loop Carrier (DLC) systems to provide telephone services to their customers. FIG. 1 illustrates an example digital loop carrier network.

In recent years, Multiple System Operators (MSOs) have begun to offer Primary Line residential telephony services using well-known telephony switching systems and circuit switched access equipment (DLC technology) adapted for use over Hybrid-Fiber Coax (HFC) networks. FIG. 2 illustrates an example telephone HFC access system.

At the headend or hub, a Host Digital Terminal (HDT) interfaces a local telephony switching system. The HDT effectively manages telephone conversations and data traffic, and provides full interoperability with the appropriate backbone networks (PSTN or data network).

Today, most HDT modems utilize QPSK technology to modulate the digital signals into narrowband RF carriers for both downstream and upstream channels. Circuit switched timeslots (64 Kbps) are multiplexed into a single multi-megabit digital stream and modulated into a 1.5 MHz wide RF carrier for straightforward insertion in the downstream path. HFC systems typically support downstream carriers in the 470 MHz to 862 MHz range.

A remote service unit (RSU) at the subscriber location receives all of the downstream signals via standard coaxial drop. The RSU locates its assigned telephony RF carrier for demodulation and passes the downstream RF to other devices (i.e. set top box, television set, etc.). The RSU shares the digital bandwidth with other RSUs on the same RF carrier frequency. The digital bandwidth is used only when telephones are “off hook”. For circuit switched cable telephony services, 64 Kbps is used for connectivity between standard telephony line interfaces in the RSU and the local telephony switch. Data services can utilize the remaining unused bandwidth, providing very efficient use of the digital pipe.

In the upstream direction, the RSU transmits digital voice and data signals to the HDT via narrowband RF carriers (typically between 5 and 42 MHz) using QPSK modulation and TDMA multiplexing. The digital bursts from multiple RSUs transmitters are received by a modem in the HDT, creating a shared multi-megabit two-way transmission path. The HDT modem manages each RSU's packet transmission timing and transmit levels to account for the different distances between the headend and subscribers and variations in the plant over time/temperature.

The industry is now migrating to packet based HFC networks to deliver voice, video, and data services. Data Over Cable System Interface Specifications (DOCSIS) have been defined by CableLabs for equipment that delivers data services over HFC networks. PacketCable interface specifications are being defined by CableLabs for equipment that will deliver Voice over IP (VoIP) and future packet based services over DOCSIS equipment. The primary difference between a DOCSIS access system and a circuit switched access system is that the DOCSIS system transports services in the form of IP packets, where the circuit switched access system transports services in the form of traditional Time Division Multiplex (TDM) links. FIG. 3 illustrates an example DOCSIS-based telephony and data HFC access system.

At the headend or hub, a Cable Modem Termination System with Edge Router (CMTS/ER) communicates through RF channels with cable modems at subscriber homes to create a virtual local area network (LAN) connection. Most cable modems are separate devices to connect to personal computers via an Ethernet or Universal Serial Bus (USB) connection.

DOCSIS CMTSs utilize 64 and 256 Quadrature Amplitude Modulation (QAM) technology to modulate the IP packets into RF carriers for downstream transmission in the HFC network. 64 QAM transmission yields approximately 27 Mbps data throughput in 6 MHz RF spectrum. 256 QAM transmission delivers approximately 36 Mbps data throughput in the same spectrum. Upstream channels can delivery between 500 Kbps and 10 Mbps using Quadrature Phase Shift Key (QPSK) or 16 QAM modulation techniques. The downstream and upstream channels are shared across many cable modems in a cable network segment, usually between 500 homes and 6000 homes.

Telephony and high speed data services are delivered to a subscriber via a Cable Modem with Multimedia Terminal Adapter (CM w/MTA). The MTA converts between voice frequency (VF) signals and IP packets for transmission to and from the HFC network.

The current public switched telephone network in the U.S. was created to provide very reliable telephone service. There is a great deal of research and development activities currently focused on creating a new packet based public network designed to provide services which cannot be offered in the current circuit switched network. However, this new packet based network will take years to complete.

In connection with the deployment of these various new packet based networks, the inventors have recognized that the service providers require an effective means to bridge packet based networks with traditional circuit switched networks to allow service operators to incrementally and effectively build new packet based infrastructures.

The inventors have also recognized that service providers require an effective means to establish a resilient communications network that provides adequate quality of service.

### SUMMARY OF THE INVENTION

The present invention addresses these and other needs that are presented by the use of packet technology, however large or small in scale, to provide voice and any other type of service that traditionally requires a very high quality of service level. The present invention can be used in the context of HFC applications, such as the sort described above by way of example, although the invention in no so limited in scope. It will be understood from the discussion below that the methods and apparatus of the present invention can be used more generally to build various different types of networks for various different types of applications, such networks being more efficient, more resilient and more reliable than prior networks.

### DESCRIPTION OF THE DRAWINGS

The present invention is illustrated by way of example, and not by way of limitation, in the figures of the accompanying drawings, in which like references indicate similar elements, and in which;

FIG. 1 illustrates an example digital loop carrier network;

FIG. 2 illustrates an example telephone HFC access system;

FIG. 3 illustrates an example DOCSIS-based telephony and data HFC access system;

FIG. 4 illustrates a top-level block diagram of DSP software architecture according to an exemplary embodiment of the invention;

FIG. 5 illustrates a block diagram of DSP API block according to an exemplary embodiment of the invention;

FIG. 6 illustrates a block diagram of DSP hardware architecture according to an exemplary embodiment of the invention;

FIG. 7 illustrates a diagram of channel setup according to an exemplary embodiment of the invention;

FIG. 8 illustrates a diagram of broadcast from 1:N cores according to an exemplary embodiment of the invention;

FIG. 9 illustrates DSP subsystem media connections according to an exemplary embodiment of the invention;

FIG. 10 illustrates DSP subsystem connection control support according to an exemplary embodiment of the invention;

FIG. 11 illustrates DSP subsystem functional block diagram according to an exemplary embodiment of the invention;

FIG. 12 illustrates an OC3 density block diagram according to an exemplary embodiment of the invention;

FIG. 13 illustrates OC12 channel density block diagram according to an exemplary embodiment of the invention;

FIG. 14 illustrates a PacketCable 1.0 reference architecture;

FIG. 15 illustrates a PacketCable LCS reference architecture;

FIG. 16 illustrates a V5/GR303 telephony server for PacketCable;

FIG. 17 illustrates certain functions of a V5/GR303 telephony server for PacketCable;

FIG. 18 illustrates a V5/GR303 telephony server for PacketCable, having a single CMTS;

FIG. 19 illustrates a local exchange telephony server for PacketCable;

FIG. 20 illustrates a local exchange telephony server for legacy (TDM-based) HFC networks;

FIG. 21 illustrates an IP telephony tandem switch application;

FIG. 22 illustrates an IP business services transport;

FIG. 23 illustrates a diagram to depict resilience in switching networks;

FIG. 24 illustrates a basic IP resilience approach;

FIG. 25 illustrates a MPLS protection mechanism;

FIG. 26 illustrates a load sharing example, according to an exemplary embodiment of the invention;

FIG. 27 illustrates a diagram to depict redundancy according to an exemplary embodiment of the invention;

FIG. 28 illustrates the copying of payload between Dragons, according to an exemplary embodiment of the invention;

FIG. 29 illustrates a typical V5.2 interface implementation;

FIG. 30 illustrates an IP to TDM traffic multicast, according to an exemplary embodiment of the invention;

FIG. 31 illustrates a TDM traffic to IP changover, according to an exemplary embodiment of the invention;

FIG. 32 illustrates the impact of failure on TDM to TDM connections with unidirectional APS;

FIG. 33 illustrates resilience with TDM to TDM connections via IP;

FIG. 34 illustrates the impact of IP delay on echo endpath with APS;

FIG. 35 illustrates SONET/SDH path overhead with APS;

FIG. 36 illustrates singalling and control links with APS;

FIG. 37 illustrates basic signaling timeslot replication;

FIG. 38 illustrates replication of stack and call state;

FIG. 39 illustrates handling of robbed-bit (channel associated) signalling;

FIG. 40 illustrates TGCP or MGCP message sequences for MG or MGC failover;

FIG. 41 illustrates an active MG initialization with MGCP;

FIG. 42 illustrates standby MG initialization with MGCP;

FIG. 43 illustrates basic MTA initialization;

FIG. 44 illustrates a basic tandem application, according to an exemplary embodiment of the invention;

FIG. 45 illustrates a basic tandem application with crosslinks, according to an exemplary embodiment of the invention;

FIG. 46 illustrates a basic tandem application with crosslinks, according to an exemplary embodiment of the invention;

FIG. 47 illustrates a pair of Dragons, according to an exemplary embodiment of the invention;

FIG. 48 illustrates a pair of Dragons, according to an exemplary embodiment of the invention;

FIG. 49 illustrates a pair of Dragons, according to an exemplary embodiment of the invention;

FIG. 50 illustrates a RSVP detour approach, according to an exemplary embodiment of the invention;

FIGS. 51(a), (b) and (c) illustrate resilient LSP approaches, according to exemplary embodiments of the invention;

FIG. 52 illustrates a resilient approach, according to an exemplary embodiment of the invention;

FIG. 53 illustrates a resiliency approach, according to an exemplary embodiment of the invention;

FIG. 54 illustrates a resiliency approach, according to an exemplary embodiment of the invention;

FIG. 55 illustrates a network management architecture, according to an exemplary embodiment of the invention;

FIG. 56 illustrates a lower-end V5/GR303 Dragon with 1×6 CMTS modules (6,300 lines);

FIG. 57 illustrates a higher-end V5/GR303 Dragon (40,000 lines);

FIG. 58 illustrates a local exchange Dragon (128,000 lines); and

FIG. 59 illustrates a local exchange Dragon for legacy HFC systems (20,000 lines).

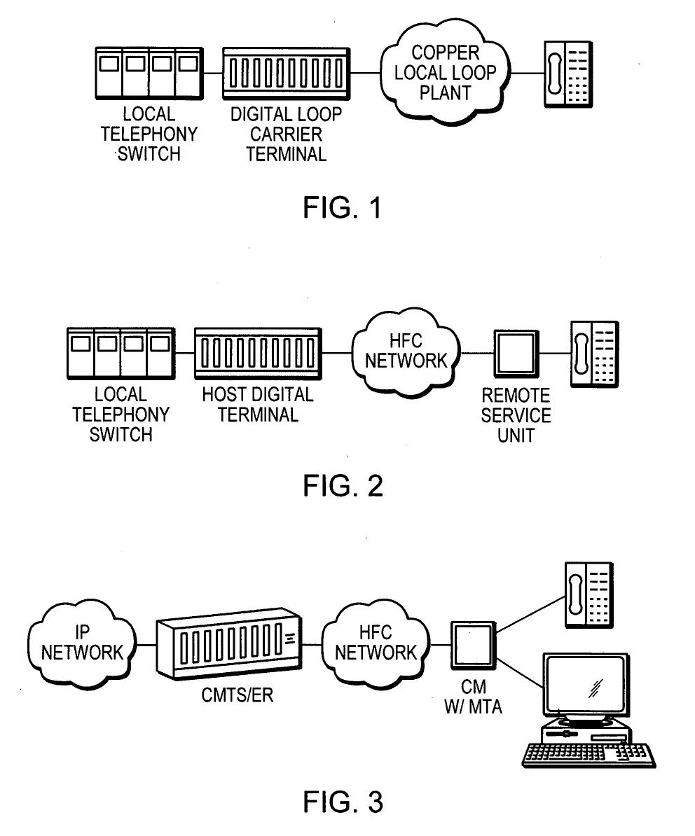

### DETAILED DESCRIPTION

The present invention relates to methods and apparatus for a Packet Voice Gateway (PVG), certain example embodiments of which are sometimes alternatively referred to herein as a telephony server specifically called “Dragon”. PVG devices in accordance with the present invention may be deployed in various environments and for various applications. Depending upon the application, such deployments may include deployment in association with CMTS equipment, IP router equipment, HDT equipment or DLC equipment, by way of example and illustration only.

For example, methods and apparatus of the present invention can be used to effectively bridge packet based access networks with circuit switched based networks such as the PSTN. Methods and apparatus of the present invention can also be used to effectively bridge circuit switched based access networks with a packet based public network. The ability to bridge circuit switched based networks with packet based networks in this regard allows service operators to, for example, extend existing circuit switched capital investment by enabling this equipment to be connected to newer packet based networks.

The following description (including without limitation the assorted Appendices hereof, which are hereby incorporated by reference) details various other objects and advantages of the present invention, with reference to numerous example embodiments. Although certain embodiments of the invention have been described and illustrated herein, it will be readily apparent to those of ordinary skill in the art that a number of omissions, modifications and substitutions can be made to the example methods and apparatus disclosed and described herein without departing from the true spirit and scope of the invention.

Various features of the system can be implemented in hardware, software, or a combination of hardware and software. By way of example only, some aspects of the subject matter described herein may be implemented in computer programs executing on programmable computers or otherwise with the assistance of microprocessor functionalities. In general, at least some computer programs may be implemented in a high level procedural or object-oriented programming language to communicate with a computer system. Furthermore, some programs may be stored on a storage medium, such as for example read-only-memory (ROM) readable by a general or special purpose programmable computer, for configuring and operating the computer or machine when the storage medium is read by the computer or machine to perform the provided functionality.

### Certain Example Embodiments

The following is a more detailed description of one example, illustrative embodiment called “Dragon”, and example applications therefor. Again, because these particular example embodiments are set forth below in some measure of detail, it bears repeating that a number of omissions, modifications and substitutions can be made to these detailed embodiments without departing from the true spirit and scope of the invention. The particular Dragon embodiments detailed below are illustrative in nature.

### Overview

The example “Dragon” embodiment that will now be described in greater detail is a fully flexible product that can be deployed in multiple applications, many of which are described for example below. The following introduction gives a brief overview of what constitutes the example Dragon embodiment (hereinafter simply referred to as “Dragon”) upon which the present discussion shall now focus, which in turn provides additional context for the specific applications described below.

The Dragon comprises a single card/plug-in module that may be deployed in a host system (or multiple host systems) either as a single card or as a group of cards. Note that when provided as a “group of cards”, it may be desirable to provide some form of integration between such cards in order to offer a single network view of the group and also to provide some level of redundancy. The extent of such integration depends on both the specific application into which the Dragon is being deployed and the host system in which it is deployed.

Such card or cards could be hosted, for example, in the physical sense and/or logical sense. Potential host systems may include without limitation routers, ATM switches, telephony switches, computing devices connected to server farms, base station controllers, mobile switches, SGSN nodes, for example. Instead of modules adapted for host systems, similar functionality alternatively could be, for example, incorporated into a separate and independent network device that operates in the overall communication network as a stand-alone box.

The core functionality of the Dragon is to provide Packet (IP) and TDM handling capabilities. In one embodiment, this can be of the form of pure TDM-IP adaptation and TDM-TDM switching. Other embodiments may provide for IP-IP stream handling.

In association with adaptation, other capabilities can be provided, including for example: Media Processing (Media Processing may include, by way of example only, one or more of echo cancellation, voice compression, tone detection/generation, fax, modem, images, video, etc.); Connection Control; and Call Control.

Also provided with the example Dragon described herein is a set of support functions such as billing, management, redundancy, security etc. Some of these support functions can be, if desired, realized with the co-operation of external systems. In other words, to the extent that the Dragon is adapted to support such functions, such functions need not necessarily be accomplished in their entirety on the Dragon itself.

The specific set of application capabilities and support functions depend on the application in which the Dragon is used, and are discussed further below.

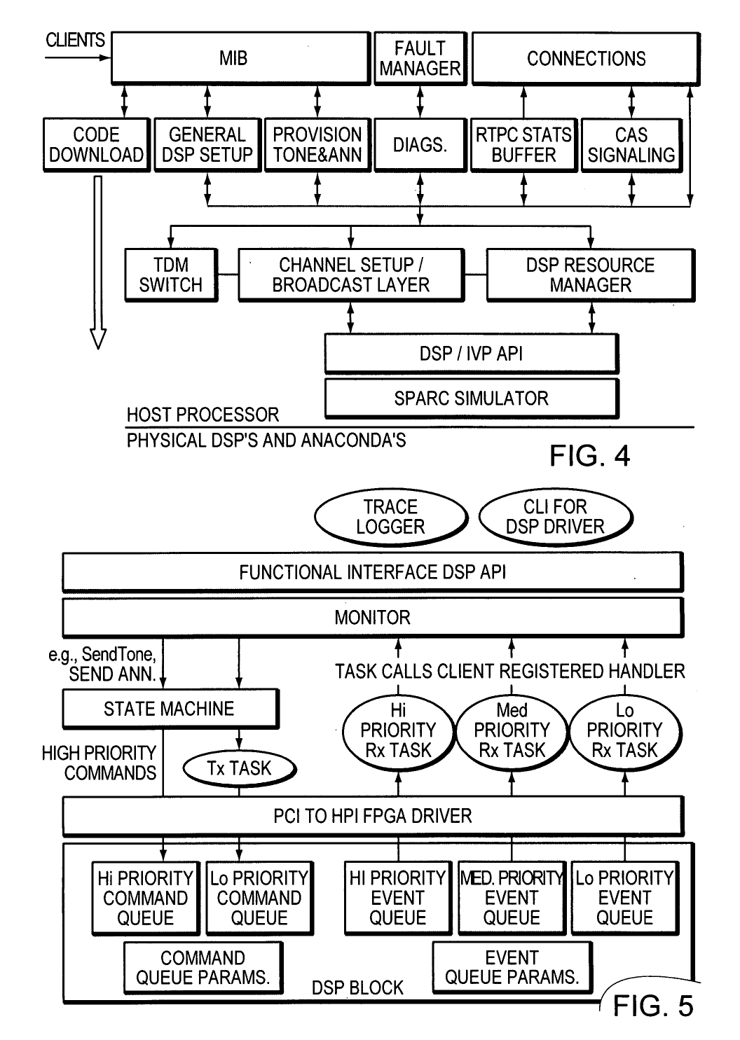

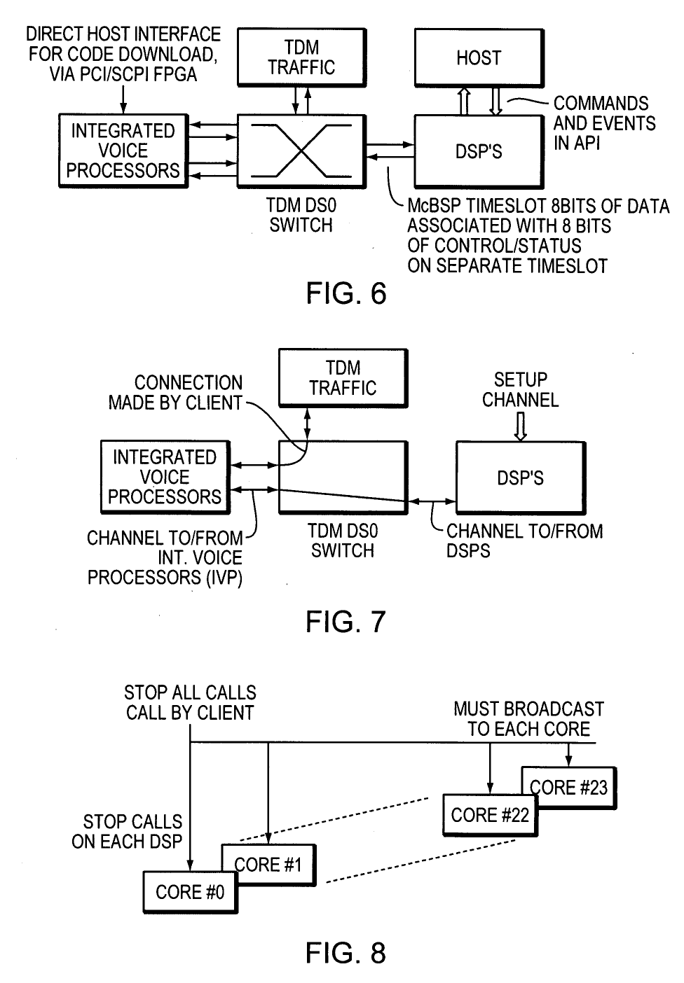

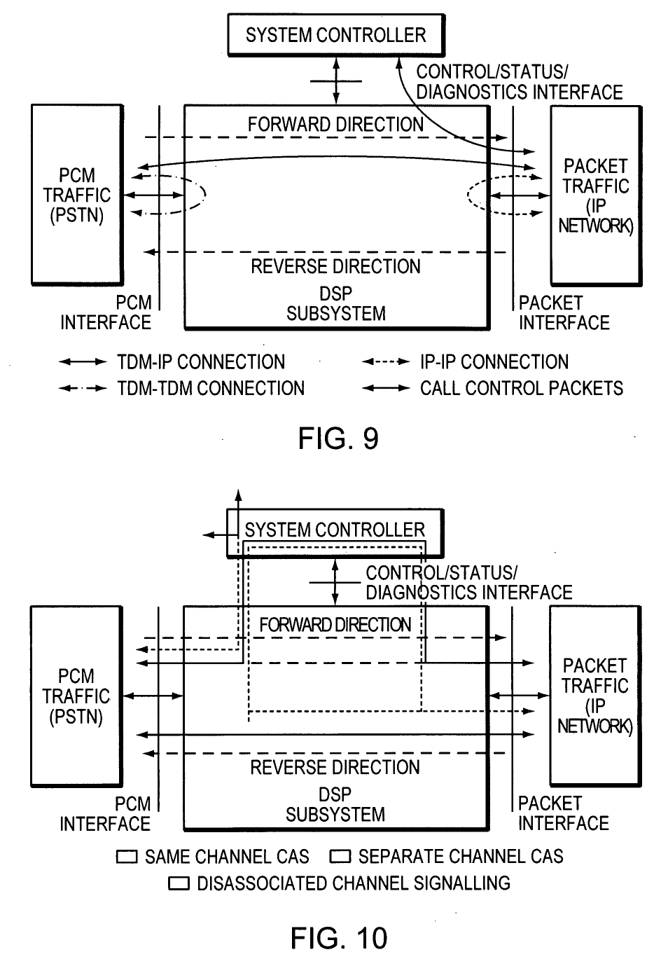

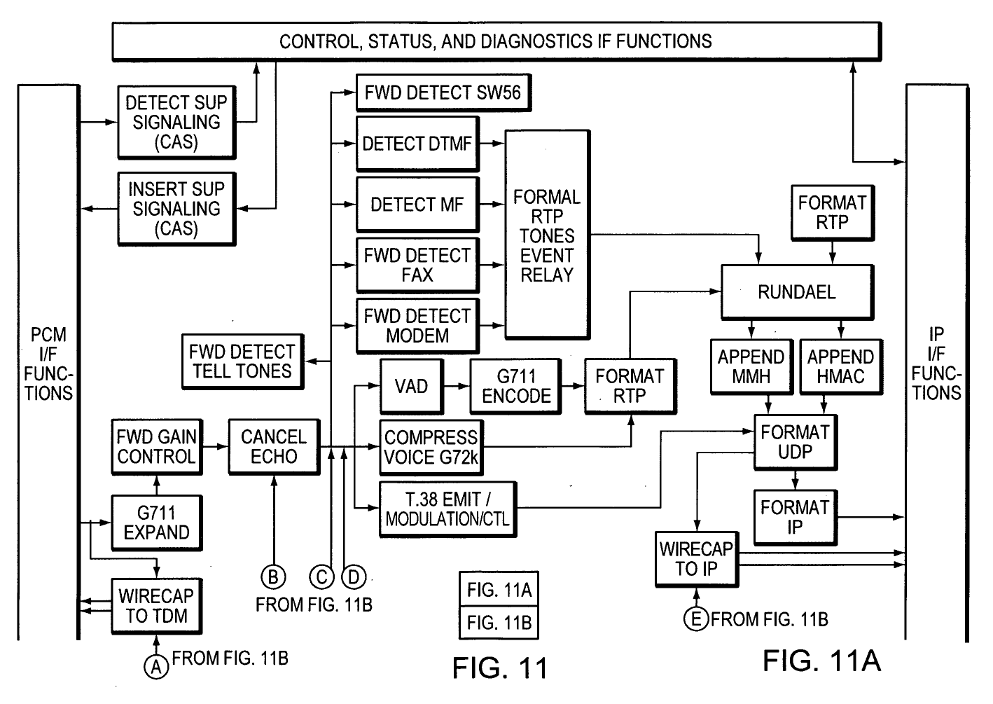

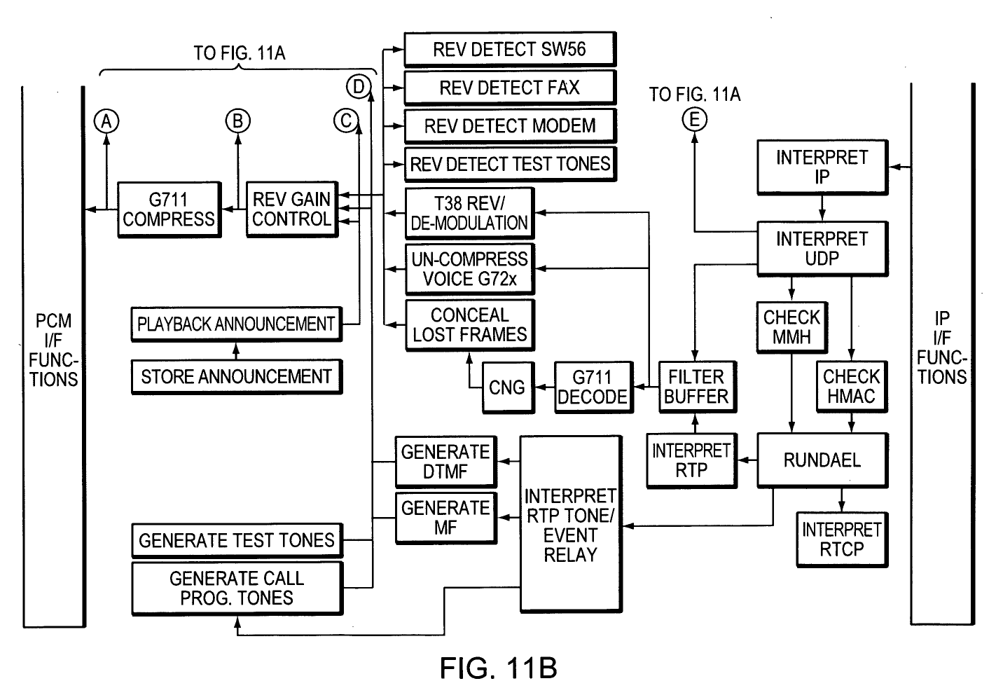

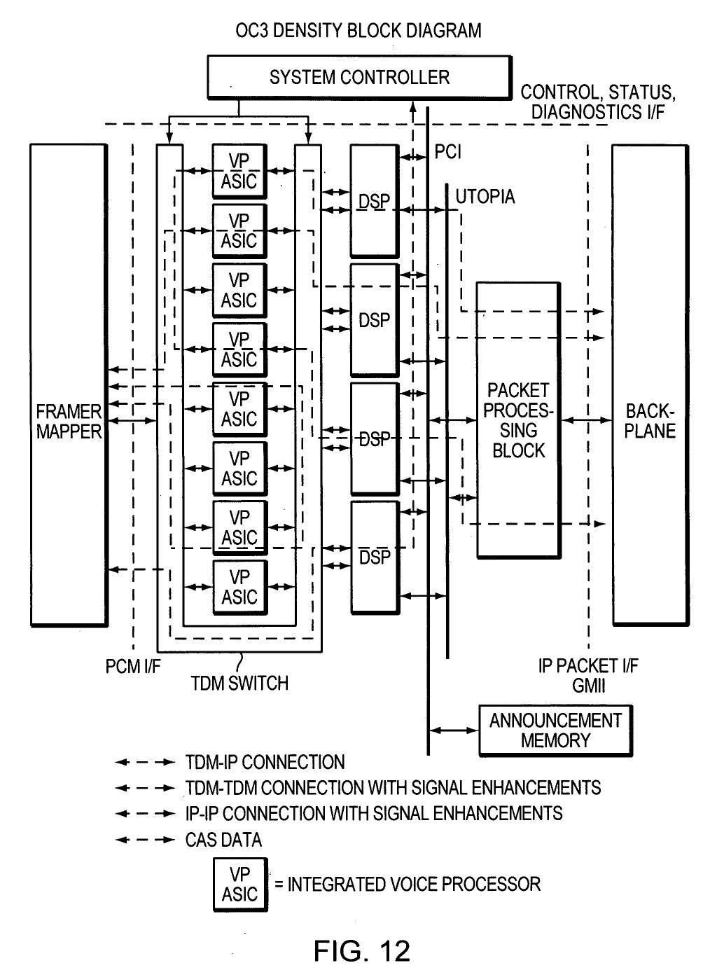

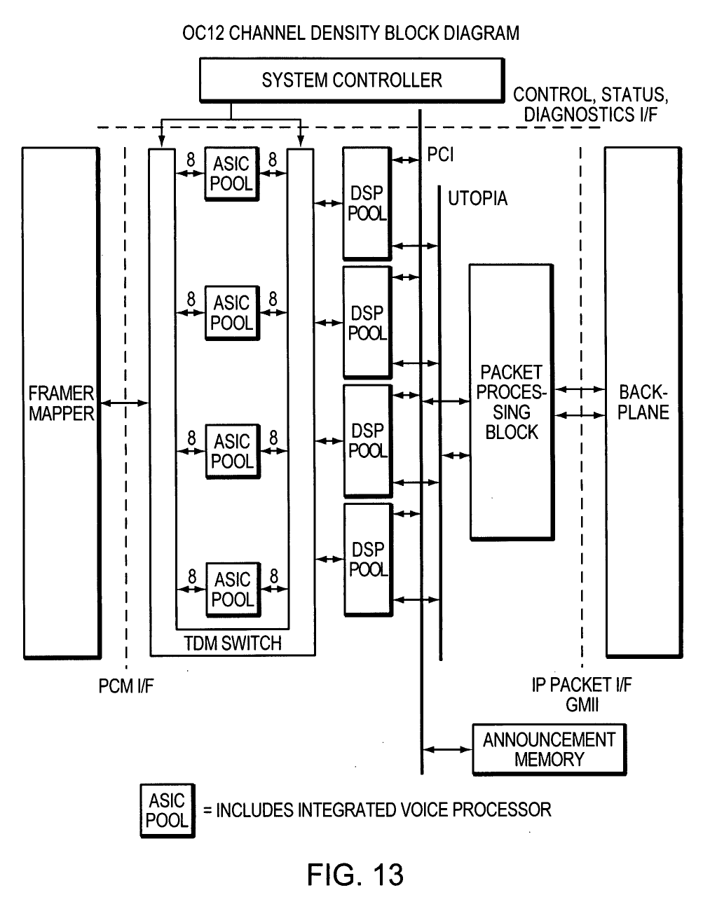

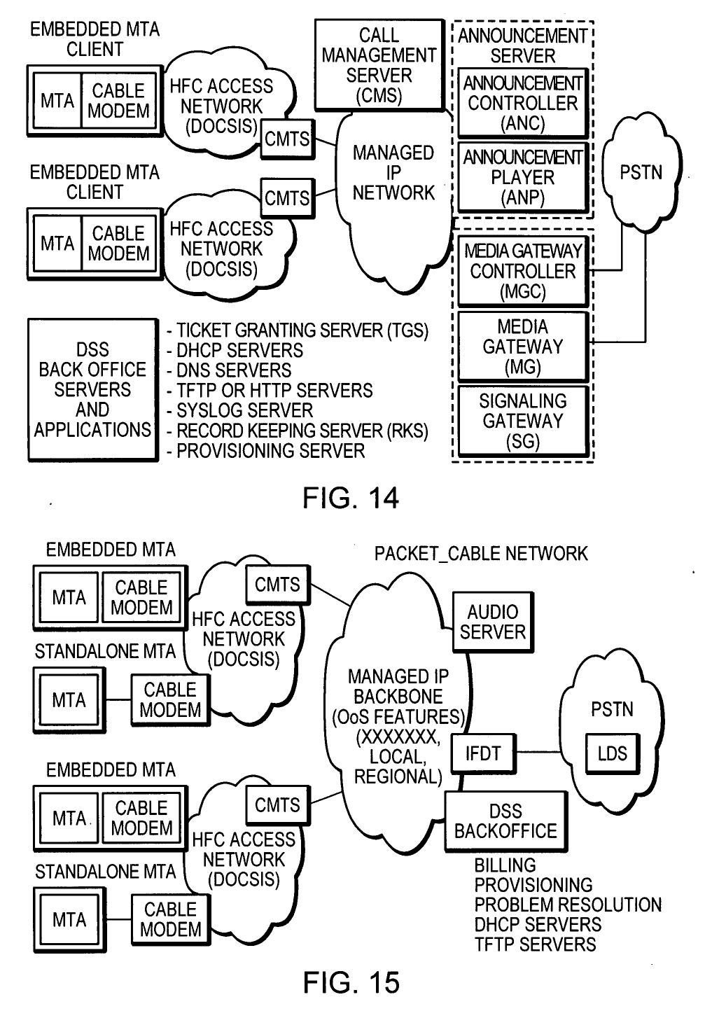

Various schematic illustrations detailing the architecture and function of a Dragon are set forth in FIGS. 4-13.

The host system for the Dragon may be any voice or data platform and may vary depending on the application. Some suitable host systems for the Dragon can include, by way of example only: Edge IP Router; Core IP Router; DSL Access Multiplexer (DSLAM); Multi-service Access Multiplexer; and Wide-band Cross Connect.

The Dragon can interface with the host system via the packet interface (for data paths and possibly control and management paths) and via a separate control interface for control and management paths.

A preferred Dragon embodiment comprises a device that can be flexibly deployed by the user in various different applications of the sort described below, and further can be readily redeployed between such various applications, allowing operators to maximize their investment in next generation telephony equipment. Preferably, the Dragon module may be applied in any such scenario without hardware changes (TDM densities permitting).

The discussion that follows may use one or more of the following acronyms in reference to the terminology that is associated below with each acronym:

ADM Add Drop Multiplexer

APS Automatic Protection Switching

CLI Command Line Interface

CMTS Cable Modem Termination System

DSL Digital Subscriber Line

DSLAM DSL Access Multiplexer

EMS Element Management System

EOC Embedded Operations Channel

GUI Graphical User Interface

HFC Hybrid Fibre Coax (typical cable TV access network).

IP Internet Protocol

LSP Label Switched Path

LTE Line Termination Equipment

MG Media Gateway

MGC Media Gateway Controller

MGCP Media Gateway Control Protocol

MPLS Multi-Protocol Label Switching

MSP Multiplex Section Protection

MTA Multimedia Terminal Adapter

NFS Network File System

OSPF Open Shortest Path First

PSTN Public Switched Telephone Network

PTE Path Termination Equipment

RBS Robbed Bit Signalling

RDI Remote Defect Indication

REI Remote Error Indication

RTP Realtime Transport Protocol

RTCP Realtime Control Protocol (used with RTP)

SDH Synchronous Digital Hierarchy

SNMP Simple Network Management Protocol

SONET Synchronous Optical Network

TDM Time Division Multiplex

VoIP Voice over IP

xDSL Any of the various DSL systems e.g. ADSL, HDSL, VDSL etc.

### Example Possible Application Scenarios

As mentioned earlier the Dragon product is fully flexible and may be deployed in various applications. These applications may include, but are not necessarily restricted to, the following: IP Telephony Access via DOCSIS HFC Cable Networks; IP Telephony Access via DSL; IP Telephony Tandem and Local Exchange/End Office Switching; IP Business Services Transport; Long Haul Transport (similar to DCME); IP Media Server; and Internet Offload (which may involve, by way of example only, modem termination on a Dragon or it may involve ISP access via PRI).

Of the above applications, the below discussion happens to be primarily focused on the “IP Telephony Access via DOCSIS HFC Cable Networks”, “IP Telephony Tandem Switching” and “IP Business Services Transport” applications. This notwithstanding, however, because the other applications and the flexibility of the preferred device as it relates to these other applications are within the scope of the present invention, this discussion may from time to time address certain aspects of such other applications.

IP Telephony Access via HFC Cable Networks

Overview of PacketCable Access

By way of background, IP access to a residential home, for example, may be provided using a Cable TV Hybrid Fibre-Coaxial (HFC) network using the DOCSIS architecture. The access network may include the following components: Multi Terminal Adapter (MTA)/Cable Modem (CM), which provides subscriber side interfaces to CPE (telephone, PC etc.) and a network side interface to call control elements in the network via the DOCSIS IP access network; DOCSIS HFC Network, which provides IP over HFC access connectivity between the MTA/CM and the CMTS; and Cable Modem Termination System (CMTS), which terminates the physical DOCSIS HFC network and provides access to a managed core IP network via packet interfaces.

An end user of a Cable Access network is provided with “always on” connectivity to a core IP network for internet access; VoIP Telephony access is provided via the PacketCable architecture as described below.

The PacketCable Architecture Framework (shown in FIG. 15, for example) defines that VoIP calls may be made from the MTA/CM (with user access being provided via a standard POTS phone) either to other MTA/CM devices (IP to IP) or to the PSTN (IP to PSTN); additionally calls can be terminated from the PSTN to MTA/CM devices (PSTN-IP). Such calls are under the control of a Call Management Server (CMS), and (for IP-PSTN and PSTN-IP calls) a PSTN Gateway. The PSTN Gateway consists of a Media Gateway (MG), a Media Gateway Controller (MGC) and a Signalling Gateway (SG). The MGC and CMS functionalities, both of which may be described as “SoftSwitch” functionality, may sometimes be combined into single platform, although this certainly is not necessarily always the case.

A variant of the PacketCable architecture is the Line Control Signaling (LCS) architecture. This architecture replaces the CMS and PSTN Gateway in the full PacketCable architecture with an Internet Protocol Digital Terminal (IPDT) that connects directly into the PSTN at the local digital switch (LDS) via a V5.2 or GR-303 interface. This architecture is shown in FIG. 15.

Example MTA/CM devices are those of the type presently offered by Tellabs, Inc., of Lisle, Ill. (Model Nos. CVM410 and CVM520, for example). Example CMTS systems include Tellabs' CableSpan® 2700 CMTS.

In order to provide a migration strategy from a (data only) DOCSIS HFC network to a fully compliant PacketCable VoIP architecture, the Dragon can provide the following application capabilities with the ability to migrate between the applications in a seamless manner: V5/GR-303 Telephony Server (PacketCable IPDT); Local Exchange Telephony Server (PacketCable PSTN Media Gateway); and Local Exchange Telephony Server for Legacy (TDM based) HFC Networks.

Each of these application capabilities is described in more detail below.

All applications within the PacketCable umbrella are believed to require full equipment redundancy as well as interface redundancy schemes. These are defined in greater detail below.

V5/GR303 Telephony Server for PacketCable

This application capability may be used in connection with the first migratory step toward providing VoIP via a DOCSIS HFC network. In this scenario, the Dragon can act as a PacketCable IPDT, which is a bridge between the PacketCable DOCSIS network (carrying VoIP) and PSTN TDM facilities on a Local (Class 5) Exchange. The interface with the local exchange may be either V5.2 or GR-303 depending on the network requirements (GR-303 is typically used in North American networks, while V5.2 is used internationally).

The major advantage of this approach is that there is no requirement for a separate SoftSwitch (CMS or MGC) to control the Dragon, and that all value adding telephony features are provided via the Local Exchange and so have no direct impact on the capabilities of the Dragon. This application is also compliant with one option for EuroPacketCable Capability Set 1 (CS-1) functionality.

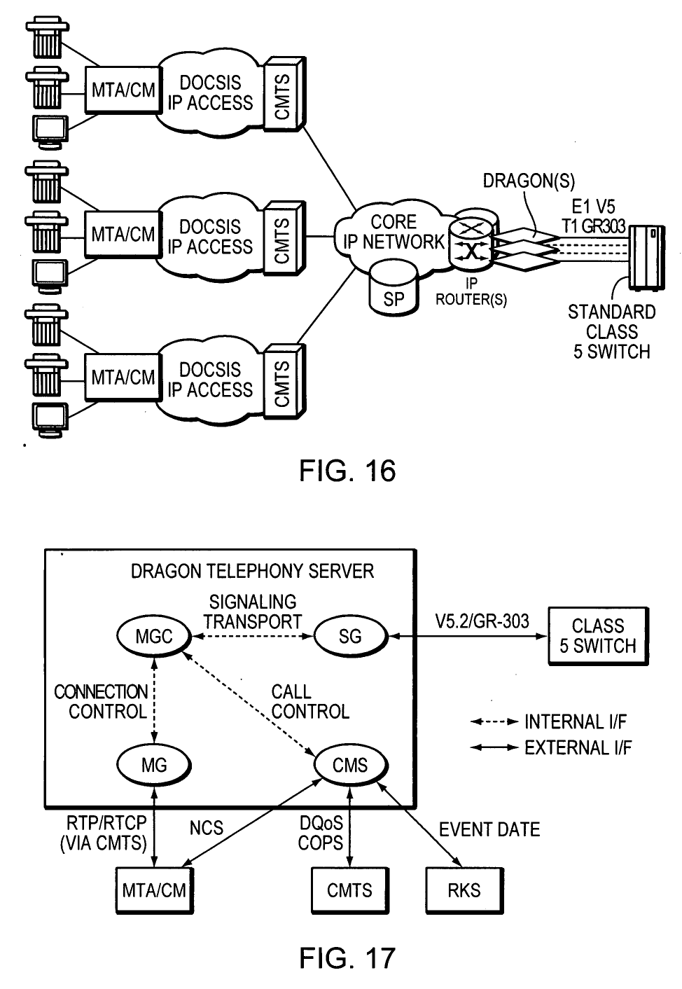

The V5/GR303 Telephony Server for PacketCable effectively integrates the CMS, MG, MGC and SG functionalities into the Dragon and is depicted in FIG. 16.

As described above in this application, the Dragon integrates CMS, MG, MGC and SG functionalities. These functionalities are described in greater detail as follows:

1. Call Management Server (CMS). When playing the role of the CMS, the Dragon is responsible for controlling the MTA/CM for the purposes of call and connection set-up/tear-down. The protocol defined for this is called Network Call Signalling (NCS), which is a PacketCable derivation of MGCP. The Dragon also adopts the CMS role of controlling the Dynamic Quality of Service (DQoS) parameters in the CMTS system using the Common Open Policy Service (COPS) protocol. Note that the provision of billing data is the responsibility of the Local (Class 5) exchange.

2. Media Gateway (MG). When playing the role of the MG, the Dragon is responsible for voice transcoding between IP and TDM as well as the relevant echo cancellation and other media processing functions.

3. Media Gateway Controller (MGC). When playing the role of the MGC, the Dragon is responsible for controlling the MG and communicating call control information with the CMS; when both the MG and CMS functions are integrated into the Dragon, these functions are thus essentially internal functions. It is also responsible for maintaining call state information, making call routing decisions and communicating with the PSTN via the Signalling Gateway function.

4. Signalling Gateway (SG). When playing the role of the SG, the Dragon is responsible for interworking between the PSTN signalling (i.e. V5.2 or GR-303) and the MGC function. A choice of mechanisms for performing such interworking are defined in PKT-TR-ARCH-LCS-VO1-01065 and 0.

Note that when playing the role of the CMS or MGC, the Dragon is slave to the call control capabilities of the Class 5 switch (via the V5/GR-303 interface).

FIG. 17 depicts the functions and interfaces of the Dragon in this application. Although FIG. 17 depicts MGC, SG, MG and CMS as separate entities for ease of illustration, this is not intended to necessarily represent separate software processes.

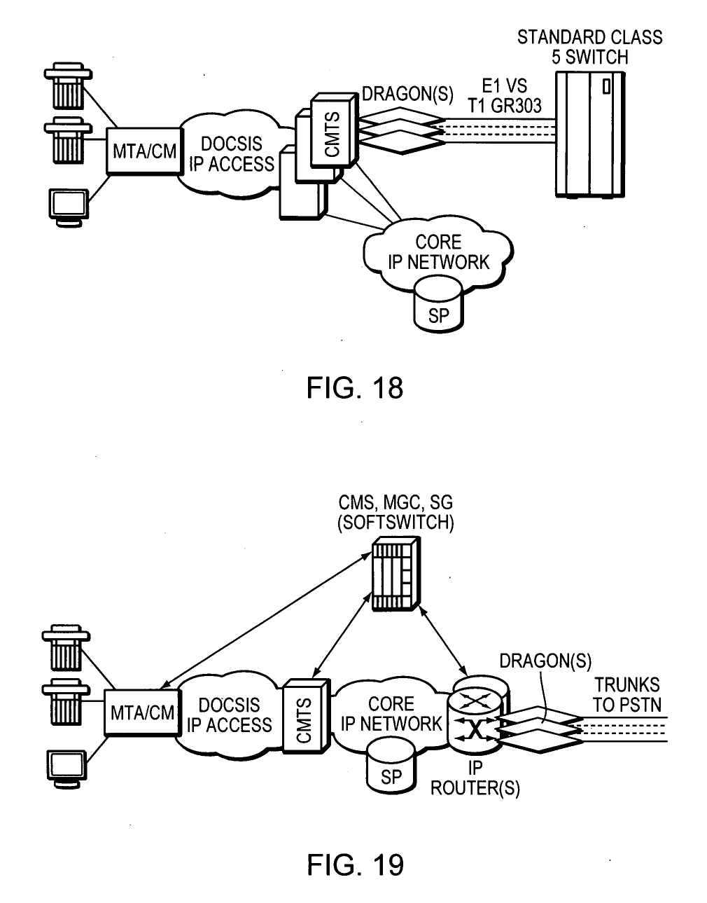

One specific instance of the V5/GR303 Telephony Server for PacketCable may be where the Dragon serves a single cluster of CMTS systems (e.g. in a hub node), in which case they could potentially be integrated into the CMTS system itself, as shown in FIG. 18.

Local Exchange Telephony Server for PacketCable

This application capability may be used either as an initial deployment or as a second migratory step toward providing VoIP via a DOCSIS HFC network (in order to support effective migration from the V5.2/GR303 application, a Dragon should provide for seamless migration in the field from supporting that application to supporting the one defined here). This is a PacketCable fully compliant scenario where the Dragon plays the role of the Media Gateway (MG). The Dragon acts as a bridge between the PacketCable DOCSIS network (carrying VoIP) and PSTN TDM facilities on a Tandem (Class 4) Exchange or the trunk side of a Local (Class 5) Exchange (as opposed to the line side of a Local/Class 5 exchange for the V5/GR303 Telephony Server).

This application involves stand-alone PacketCable components CMS, MGC, and SG and is depicted in FIG. 19.

Although this approach involves additional elements over and above the Dragon, and thus requires more to deploy than does the V5/GR303 Telephony Server, it is an approach that is compliant with the industry accepted PacketCable architecture; in addition it can provide access to additional value added IP services (such as IP Centrex, Presence, etc.) over and above those offered by a standard Class 5 switch.

The list of functionalities for the Dragon in such a network application can include, for example: transcoding VoIP streams into TDM streams; application of echo cancellation and other media processing functions; application of PSTN call progress tones and announcements; termination of MF trunks to emergency and operator service systems; and (in the case of networks using associated SS7 signalling) termination of signalling links (F-links), and transport of their upper layer payload to the SG/MGC.

FIG. 19 depicts the Call Management Server (CMS), Media Gateway Controller (MGC) and Signalling Gateway (SG) as a single entity, the SoftSwitch; whether this is actually the case or they are deployed as separate elements is transparent to the Dragon.

The functionalities of these items are as follows:

1. Call Management Server (CMS): The CMS is responsible for controlling the MTA/CM for the purposes of call and connection set-up/tear-down. The protocol defined for this is called Network Call Signalling (NCS), which is a PacketCable derivation of MGCP. The CMS controls the Dynamic Quality of Service (DQoS) parameters in the CMTS system using the Common Open Policy Service (COPS) protocol, and provides billing information to a Radius Record Keeper Server (RKS). The RKS is a PacketCable component fully defined in PKT-TR-ARCH-V01-991201. For calls destined to/from the PSTN, the CMS communicates with the Media Gateway controller (although if the CMS and MGC are integrated, for example, then this can be an internal interface). End user services (both Class 5 and next generation IP services, possibly via SIP) are also delivered from the CMS, though the delivery of such services need not have any impact on the Dragon itself.

2. Media Gateway Controller (MGC): The MGC is responsible for controlling the Dragon for the purposes of call and connection set-up/tear-down. The protocol defined for this is called Trunking Gateway Control Protocol (TGCP) which is a PacketCable profile of MGCP (see also 0 and 0). The MGC communicates call control information with the CMS (this may be an internal interface, for example, if the CMS and MGC are integrated). It is also responsible for maintaining call state information, making call routing decisions and communicating with the PSTN via the Signalling Gateway function (this may be an internal interface if the SG and MGC are integrated). The MGC may provide some access to PSTN services (in particular IN based services) that are not provided via the CMS.

3. Signalling Gateway (SG): The Signalling Gateway is responsible for maintaining SS7 links for communication with the PSTN (both ISUP for call control and TCAP for IN services). The Signalling Gateway communicates ISUP and TCAP information with the MGC (this may be an internal interface if the MGC and SG are integrated). Local Exchange Telephony Server for Legacy (TDM based) HFC Networks This application capability may be used to provide a further migratory step for providing VoIP capabilities on a DOCSIS HFC network. It allows an operator with a mature VoIP offering, with IP enhanced services, to offer an equivalent service to any customers served by legacy (TDM based) Telephony over HFC networks (e.g. Tellabs CableSpan 2300 networks), and to support calls between such legacy customers and their own VoIP customers without having to transit the PSTN. Alternatively this application may be used as an initial deployment for connecting TDM based subscribers into a core VoIP network.

The capabilities/feature set associated with this application mean that the Dragon may be used to support any GR-303 RDT or V5 Access Network of which the HFC variant is just a specific case.

In this scenario the Dragon acts as the network side of a V5.2/GR-303 interface and collects TDM based access traffic from the legacy network and delivers it onto a core IP network. This suggests that the Dragon is controlled by a SoftSwitch (perhaps, but not necessarily, the same CMS/MGC as used for the Local Exchange Telephony Server capability described above). The SoftSwitch is required to support V5.2 or GR-303 call control as a Local Exchange.

Calls can be routed between legacy customers and PacketCable customers, between legacy customers and the PSTN, and between pairs of legacy customers under the control of the SoftSwitch. Any calls from the legacy customers to the PSTN can be routed out of the IP network via the Local Exchange Telephony Server. Calls between pairs of legacy customers require support for TDM-TDM connections on the Dragon. Note that TDM-TDM connections may be realized across pairs of Dragons (either in the same router or in separate routers). In such cases the connections act as two individual TDM-IP and IP-TDM connections

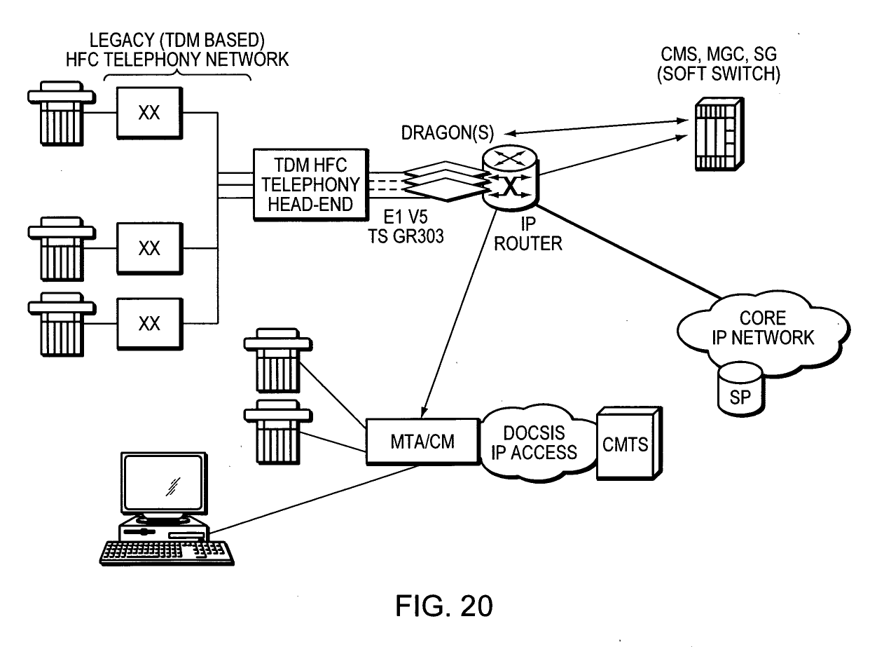

This network scenario is depicted in FIG. 20; note that this figure does not explicitly show the PSTN access. FIG. 20 shows a legacy TDM based HFC network where telephone access is provided on the customer premises via a Remote Service Unit (RSU). All RSUs are connected via the HFC network to a TDM HFC Telephony Head-end, which passes the telephony traffic to the Dragons via a V5.2 or GR-303 interface.

The overall application (including SoftSwitch) should be capable of delivering Class 5 services to the end subscriber, such as for example: Caller Identity Services (including delivery, withholding, blocking/screening etc.); Call Waiting; Call Diversion and Forwarding Services; Ring Back When Free (RBWF)/Call Completion on Busy Service (CCBS); Voice Mail; Distinctive Ringing; Three-way Calling; Last Number Redial; Speed Dial; and Call Return.

The below discussion provides further detail as to certain implications that such services can have with respect to the Dragon.

The list of functionalities for the Dragon in such a network application can include, for example: transcoding VoIP streams into TDM streams; application of echo cancellation and other media processing functions ; application of call progress tones and announcements; application of CLASS feature signalling (e.g. FSK tones); support for multi-party conferencing capabilities; termination of V5.2/GR-303 signalling (data link layer) and the transport of the signal information to the SoftSwitch; termination of MF trunks to emergency and operator service systems; and (in the case of networks using associated SS7 signalling) termination of signalling links (F-links), and transport of their upper layer payload to the SG/MGC.

The last two points above contemplate those cases where call control signalling, which is the domain of the SoftSwitch, is delivered via transport interfaces, which are the domain of the Dragon. This may either be for voice band signalling (MF trunks) or for CCS signalling using channels within a voice transport structure (SS7 F-links).

IP Telephony Tandem Switching

The IP Telephony Tandem (or Trunk) Switching application allows the Dragon to be deployed as a Media Gateway in any fixed line or mobile network at the tandem layer; that is all traffic interfaces are generally with other exchanges (Local/EO, MSC, Tandem or International), though direct customer PBX interfaces are also supported.

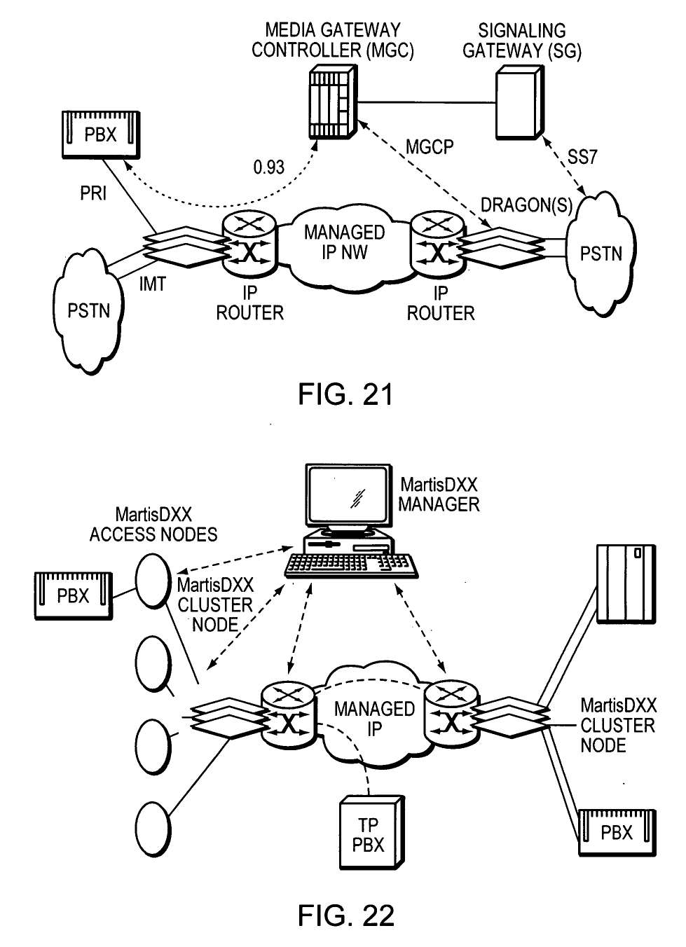

The Dragon, in conjunction with external components (such as a SoftSwitch, for example) provides the ability to interconnect traditional TDM exchanges via an IP packet based core network and switch traffic between them under PSTN signalling control. It thus can be a growth option or total replacement for an existing TDM tandem network or as a green-field tandem network deployment for newer network operators. The IP Telephony Tandem Switch application is depicted in FIG. 21.

The list of functionalities for the Dragon in such a network application can include, for example: termination of Inter Machine Trunks (IMTs) from telephony switches (LE/EO, MSC (The termination of an MSC trunk is, in this particular context, fundamentally similar to the termination of any other IMT type, with the exception that the call rate requirements are higher) or Tandem) and Primary Rate ISDN (PRI) trunks from PBXs; termination of legacy trunk interfaces (such as digital and analogue CAS interfaces) [not shown explicitly in FIG. 21]; transcoding VoIP streams into TDM streams; application of echo cancellation and other media processing functions; application of PSTN call progress tones and announcements; termination of PRI (Q.921) Data Links and the transport of their upper payload to the SoftSwitch; transport of telephony events incoming from legacy trunk interfaces to the MGC, and initiation of telephony events to legacy trunk interfaces under MGC control; and (in the case of networks using associated SS7 signalling) termination of signalling links (F-links), and transport of their upper layer payload to the SG/MGC.

This particular application likely involves full equipment redundancy as well as interface redundancy schemes. These are defined in greater detail in 0 and 0.

FIG. 21 depicts a Media Gateway Controller (MGC) and Signalling Gateway (SG) as components of the overall application. These two components may be realised within a single platform. Their functionalities can be generally described as follows:

1. Media Gateway Controller (MGC): The MGC is responsible for controlling the Dragon for the purposes of call and connection set-up/tear-down. The protocol defined for this is MGCP. The MGC communicates call control information with the PSTN (using SS7 via the Signalling Gateway), PRI PBXs (using Q.931 via the Dragons) and other MGCs (using a next generation network protocol such as BICC or SIP). It is also responsible for maintaining call state information and making call routing decisions. The MGC may provide some access to PSTN services (in particular IN based services) that are not provided via the customers End Office/Local Exchange or PBX. In a mobile tandem network then the MGC would also be responsible for determining call routing information for calls to mobile subscribers, by interrogating the mobile HLR database.

2. Signalling Gateway (SG): The Signalling Gateway is responsible for maintaining SS7 links for communication with the PSTN (both ISUP for call control and TCAP for IN services and HLR queries). The Signalling Gateway communicates ISUP and TCAP information with the MGC (this may be an internal interface if, for example, the MGC and SG are integrated).

IP Business Services Transport

The Dragon, in conjunction with appropriate access products (such as, for example, Tellabs MartisDXX® access nodes and managers), can be used to provide leased line transport over a managed core IP network. Such transport may be between managed access products, other TDM based network elements such as Telephony Exchanges and PBXs, and IP based telephony elements such as IP PBXs. This is shown, by way of example only, in FIG. 22.

The list of functionalities for the Dragon in such a network application can include, for example: termination of TDM interfaces from network elements such as MartisDXX Cluster and Access nodes, ISDN PBXs, Telephone Exchanges; transcoding VoIP streams into TDM streams; application of echo cancellation and other media processing functions; end-to-end transport of emulated TDM structures (E1, NxDS0, etc.) across IP networks; enhanced IP bandwidth utilisation via Voice Activity Detection and Silence Suppression; Interworking with IP enabled telephony devices (IP PBX etc.) and PC based IP telephony applications (e.g. NetMeeting); and TDM signalling tunnelling (for example Q.931) between TDM endpoints via an IP core network. Call control for IP telephony devices and applications could use either SIP or H.323, for example.

This application likely involves full equipment redundancy as well as interface redundancy schemes. These are defined in greater detail below.

Under the control of the MartisDXX manager, the Dragons provide IP circuit emulation of TDM structures between TDM interfaces on two distinct Dragon modules or between the TDM interfaces of a single Dragon module and an IP enabled telephony device such as an IP PBX. The statistical multiplexing characteristics of the IP network are taken advantage of to save bandwidth by transmitting IP packets at full data rates only when voice/data activity is present on a per channel basis.

### Example Possible Core Features

This portion of the discussion provides a description of certain core functionalities or features that can be provided by the Dragon example embodiment described herein, for many if not all of the applications described herein. Other features having more application-specific characteristics are addressed below. Note the Dragon product described herein may consist of one or more Dragon modules. Some features or functionalities described herein may be most effectively realized through a combination or suite of multiple modules. Moreover, applications for multiple modules may include support for increased capacity or to provide some level of redundancy.

Product Flexibility

One characteristic of the Dragon embodiment described herein is its flexibility and adaptability to differing applications. This is achieved through the use of high density voice quality components and flexible use of DSP technology. Ideally, ultimate flexibility and adaptability can be realized with the Dragon when it can simultaneously function in two distinct applications during a given migration process. For example, if migrating a Dragon from a V5/GR-303 (PacketCable IPDT) application to a Local Exchange (PacketCable MGW) application, then the Dragon preferably, during the migration process, simultaneously supports V5/GR-303 access circuits and standard trunk circuits.

In view of the use of DSP technology to achieve many of the media processing functions of the Dragon described herein, and the impact of certain such functions on the overall capacity of the Dragon, the ability upgrade individual Dragon modules with increased DSP capacity without the need to replace the whole module can prove to be a valuable feature if incorporated into the design of a given Dragon embodiment. Whether this is achieved via a field upgrade at the customer site or via recall to Tellabs manufacturing is to be determined as a general process issue.

Host System Integration

The Dragon module described herein is adapted for use in association with a host system (such as, for example, a CMTS or router system). In particular, the module described herein is inserted into a slot of the host system and interfaces with the host system via the host IP-based back-plane. Integration with the host system includes providing the basic necessary management capabilities (such as Card State Management, compatibility and backward compatibility with host APIs), and the use of the interface between the Dragon module and the IP-based back-plane for the purposes of transporting VoIP traffic to/from the core IP network via host interface cards.

TDM Voice Transport Interface

TDM Circuit Densities

The Dragon module described herein supports external optical TDM interfaces, such as for example, optical OC12 with T1 mapping via VT1.5 or DS3 (configurable per STS-1) and optical STM-4 with E1 mapping via VC-12. Such densities are mainly driven by higher end applications (e.g. VoIP Tandem, Local Exchange Dragon). Also supported are optical/electrical OC3 with T1 mapping via VT1.5 or DS3 (configurable per STS-1) and optical/electrical STM-1 with E1 mapping via VC-12. Usage of the above circuit densities for their specific application are further discussed, for example, below. Alternative embodiments may include, by way of example only, modules that are capable of supporting TDM interfaces with equivalent bandwidth of STM-16/OC48.

TDM Circuit Protection Schemes

For TDM interfaces, protection schemes are available to protect against line failures and module failures.

Particular networks may require either 1+1 APS protection schemes or (for reduced cost, reduced reliability) load sharing schemes. Such protection schemes may include one or more of the following example schemes: Full 1+1 SONET APS/SDH MSP across redundant module pairs; Reduced functionality SONET APS/SDH MSP across redundant module pairs (i.e. not necessarily meeting all the standard requirements such as timing, due to recognised implementation limitations); and Load shared interfaces across multiple modules (i.e. multiple simplex modules with calls/connections distributed across them under the control of the SoftSwitch or Local Exchange).

Embodiments of the present invention include a range of very high density media gateway boards which may interface VoIP circuits to PSTN voice circuits and may be integrated into routers or similar systems.

A portion of this discussion addresses resilience problems for various applications and provides solutions to these problems.

### Resilience Mechanisms

An aim of resiliency is to ensure that the overall service meets the appropriate availability targets. These expectations and methods of achieving them are already established in the circuit switched voice world. The expectation is that VoIP should meet similar targets but may use different methods to achieve this.

Since IP has traditionally had a very different approach to achieving availability targets this portion of the discussion will look at the different approaches to resilience with a view to seeing how they can effectively interwork to meet the overall service availability targets.

Simplex Operation

As outlined above the key requirement for a telecommunications network is to provide a certain level of overall service availability. In some cases this can be achieved using simplex non-redundant equipment. Typical examples are systems carrying small numbers of E1 or T1 links. Another example would be portions of a HFC cable access system where the co-axial cable plant and associated distribution amplifiers are not redundant.

Other examples are IP networks and switching networks as described below where resilience is achieved at the network level by using multiple simplex systems.

The basic point is that it is necessary to consider the overall application in order to determine the appropriate resilience/redundancy mechanisms in the equipment. The larger the number of calls or subscribers handled by the equipment the more critical resilience becomes.

Transport Network Resilience

At the lower end electrical E1 and T1 interfaces and transport systems do not provide standard resilience mechanisms. These systems depend on a network level or application level solution for resilience.

High capacity SONET/SDH systems with optical interfaces do however support redundancy since their failure can impact so many connections. The main approaches include ring protection for line systems themselves and APS protection for point to point high speed interfaces. SONET/SDH resilience tries to provide very fast failure detection and switchover times (approximately 50 mS) in order to be undetected by higher level applications and to avoid triggering any other protection mechanisms.

Switching Network Resilience

The traditional PSTN networks achieve resilience by connecting switches in a mesh configuration so that there are alternate routes from one switch to another.

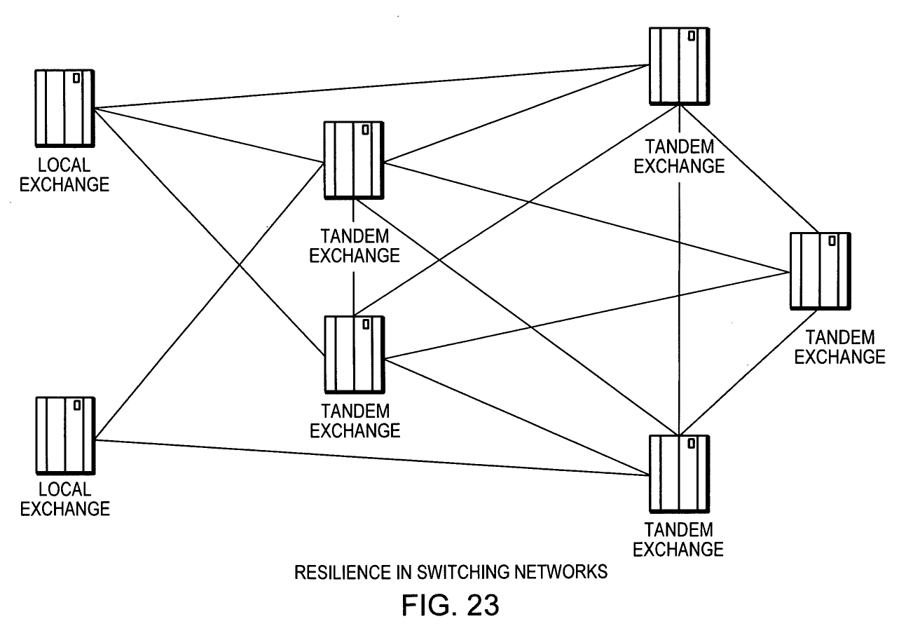

In FIG. 23, for example, there are several paths between the two local exchanges via the tandem network. Routing tables in each exchange list the primary and alternative trunk groups for reaching each number range. Trunk groups are engineered to provide a target grade of service at peak busy hour. If a trunk or trunk group fails then existing calls on that trunk group are affected. However the system will continue to handle calls but with an increased probability of blocking on calls to the affected destinations since the number of routes available is reduced.

The impact of the failure on grade of service can be reduced by over engineering the trunk groups to provide some extra capacity.

IP Network Resilience

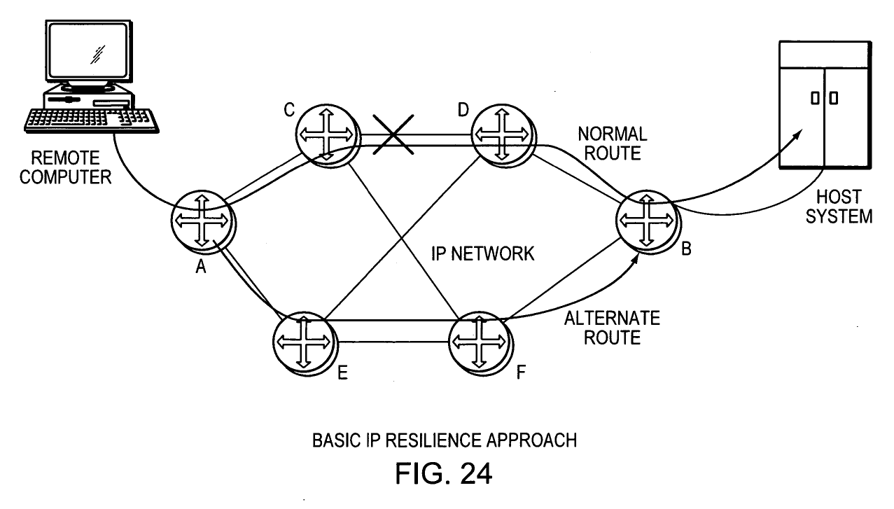

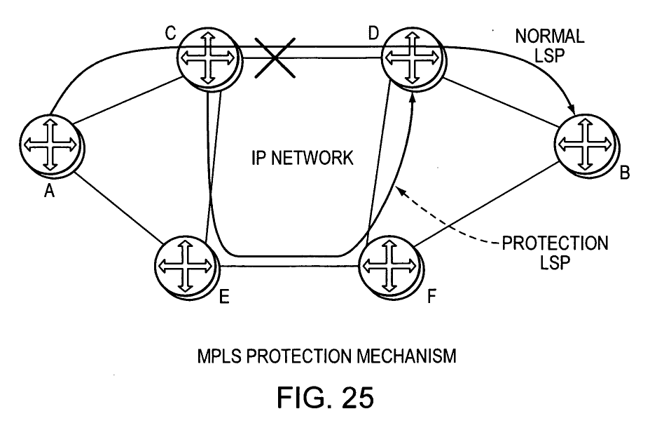

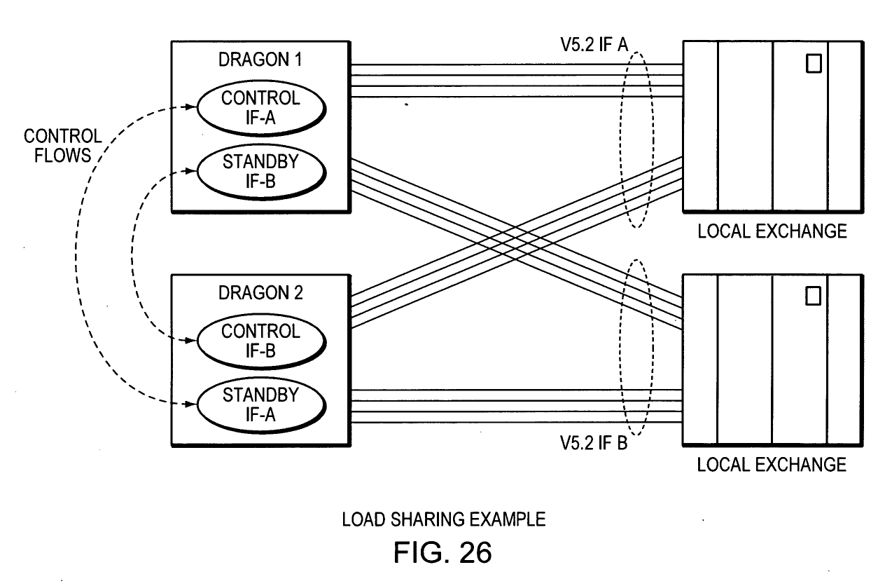

A typical IP network scenario is shown in FIG. 24. The basic IP approach uses the fact that IP is a connectionless protocol to provide resilience in the case of failures.

Packets from the computer to the host system will normally follow the “shortest path” as computed by OSPF or some similar routing algorithm. In this example the normal path is assumed to be via routers A, C, D and B.

In the event of a failure of this path the routers will exchange link state messages which will allow them to determine new paths. In this example the new path from A to B could flow via routers E and F.

This connectionless approach makes IP networks very resilient but has two problems from a VoIP viewpoint. The first is that the new path may not have sufficient bandwidth available for the redirected traffic and may become congested leading to packet loss. The second problem is that the recovery time is quite long since the failure must be detected, link state messages must be flooded through the network and the routers must calculate new routing tables.

During this routing table update period following a failure routing loops and similar inconsistencies may occur since all routers do not have the same stable picture of the network topology. To minimize the impact of these transient problems OSPF and similar protocols specify a minimum period of several seconds between routing updates.

Detection of failures on links which pass through Ethernet hubs and switches may also be relatively slow if it depends on the exchange of hello messages or similar protocols.

Therefore recovery of VoIP flows via normal routing update mechanisms would be quite slow. One approach for faster re-routing is to use constraint based MPLS. More specifically, MPLS constraint-based routing can be used to establish a protection LSP (Label Switched Path) around each segment of the path. Then if the path CD fails all the LSP traffic for D is forwarded by C over the protection LSP via routers E and F.

Additional details regarding IP network resiliency are set forth below.

Load Sharing

The basic idea here is to spread the functionality across a number of systems so that a single failure does not result in complete loss of service but merely a degradation in service. For example a V5.2 interface can consist of up to 16 E1 ports. If these are all on a single card then failure of that card leads to complete loss of service for the subscribers terminated by that V5.2 port (possibly up to 16×30×8=3840 subscribers). On the other hand if the E1 ports are spread across four boards a single failure means that 75% of peak busy hour traffic can still be handled.

Having the ports for a particular V5.2 (or GR 303) interface spread across two or more Dragons rather than all being on the same card would allow the combination of high density with the limited protection capability supported by the E1 ports of a V5.2 local exchange interface. There is of course added complexity at the V5.2 or GR 303 control functions since the control functions and stacks running on one Dragon need to provide state information to the standby control functions on the other card to avoid dropping stable calls following a changeover.

Equipment Redundancy

In some cases individual network elements need to achieve extremely high levels of availability. An example is the DSLAM in a DSL access system which provides service to a large number of subscribers but which cannot be easily duplicated at the network level.

In this case it is normal to provide redundant equipment for all common functions such as switching fabrics, control units and power supplies. If the active unit fails a standby system automatically takes over. A distinction is typically made between hot standby and cold standby systems. In hot standby the standby unit has access to the necessary state information to manage existing calls. In cold standby existing calls are lost as the system effectively resets.

An important aspect of equipment redundancy is that it is usually provided internally by a network element and the failure and switchover operations do not require interaction with other network elements.

In the case of the present invention, redundancy may involve two or more boards.

Redundancy Scenarios

This portion of the discussion looks at some general aspects of redundancy in the present invention which are relevant to several application scenarios.

A typical redundancy scenario involves two Dragons connected between TDM and IP networks. They could be in the same router or two separate routers.

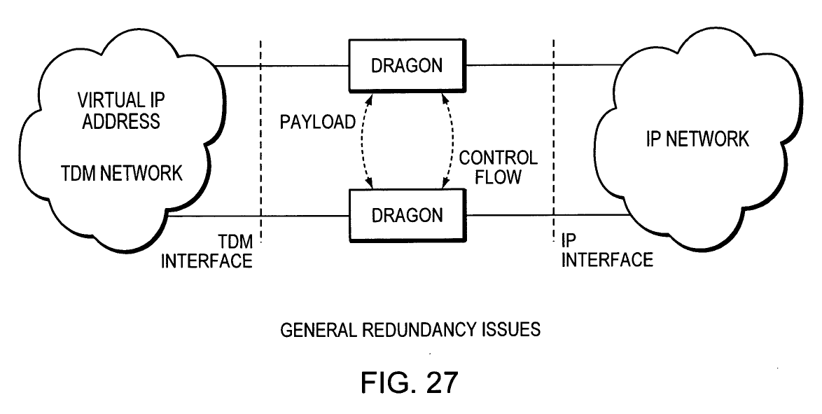

On the TDM Interface the main redundancy option is to use APS on the optical interfaces. In the case of electrical interfaces the only practical option is to use some form of load sharing. In the case of 1+1 APS the two Dragons should send exactly the same payload so that the far end TDM system can perform a protection switch autonomously. This means that TDM payload needs to be transferred between the two Dragons as indicated by the left-handed dashed line in FIG. 27. This may be achieved via the IP network or by a dedicated connection.

On the IP side, a virtual IP address may be used. This works by associating the TDM terminations on the two Dragons with a single IP address. This makes it seem to the IP routers that the two Dragons are router interfaces with connectivity to the destination virtual IP address.

The virtual IP address means that if one Dragon or its router links fail the IP network will reroute the RTP packets to the working Dragon. However under normal operation different source routers could route traffic to either Dragon since both have advertised connectivity to the destination virtual IP address. This means that on the IP side Dragons would be load sharing and neither would see the full payload. This conflicts with the TDM mode of operation described above for APS. To control this situation a Dragon interacts with its host router to modify the path costs being advertised by its router to the virtual IP address.

The diagram also shows a dashed line just to the left-hand side of the center of FIG. 27 in to indicate control flows needed to co-ordinate changeover operations. It may also include other state information which needs to be transferred between the Dragons, for example information on V5.2 call states.

Another signalling problem is how the Dragon redundancy handles signalling streams and stacks. These fall into two main categories. The first are stacks such as MGCP and V5 which are terminated within the Dragon. In this case any redundancy scheme must take account of the impact of switchover on the stacks. The second category are signalling streams, such as SS7 or Q.931 links, which are being backhauled from the TDM network to a softswitch. The Dragon should be essentially transparent to these streams but redundancy switchovers may impact them.

Finally we need to consider the impact of redundancy on network management functions. Two main problems embodiments of the present invention addresses are: a) how do we ensure consistency of configuration between redundant Dragons; and b) how do we make these interactions relatively transparent for the user. These problems are addressed below.

Transport Layer

The main problem at the transport layer is the support of APS for optical interfaces. Strictly speaking APS provides for line and section protection but not equipment redundancy. Therefore in a 1+1 APS protection scheme both optical interfaces are expected to carry the same payload. This allows the receive end to switch over locally in the event of failure although this switch is signalled back to the transmit end using the K1 and K2 bytes. Normally both directions then switch to the same fibre.

In working with an IP network this creates some difficulties since IP routers would not normally deliver packets to two destinations. In addition there may be a problem in getting all of the payload to one Dragon unless it appears as the shortest path to the destination IP address for all routers in the network. This means that using a virtual IP address concept would require the Dragons to dynamically interact with the router in order to change the path costs advertised by OSPF (or other routing protocols).

APS with IP Broadcast or Multicast Between Dragons

One embodiment of the present invention multicasts or broadcasts the IP packets to both Dragons. Of course this may consume twice the bandwidth through the IP network if the Dragons are in separate routers. In the case where both Dragons are in the same router there is no extra bandwidth required in the network but the router must be able to multicast packets to both Dragons.

APS with Direct TDM Link Between Dragons

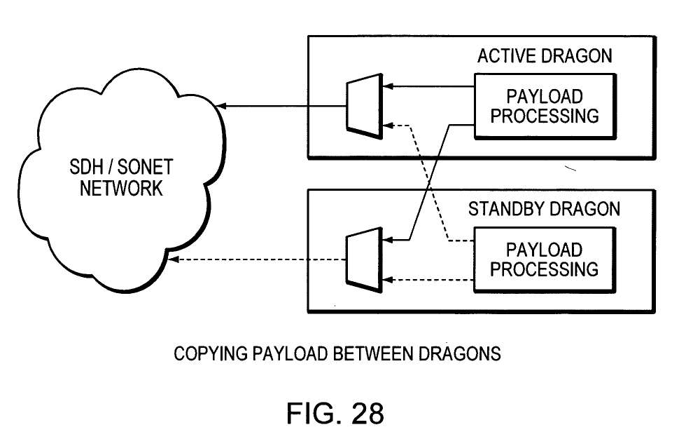

Another embodiment of the present invention links the two Dragons directly so that each receives a copy of the other's payload. This is illustrated in FIG. 28.

The payload generated by the active Dragon is copied to the standby and the standby Dragon actually transmits this payload rather than the one generated locally. This means that both links do carry the same payload. However it requires additional optical links and framers to copy the payload between Dragons.

Since both use the same payload it would not seem to be necessary to copy the IP packets to both Dragons in this case. However if the active Dragon fails the standby link will also lose its payload until the standby Dragon receives all the IP packet streams. Clearly this would not meet the normal 50 mS APS changeover expectation unless both payload processing functions are receiving the full IP packet stream.

The downside of this approach is the extra hardware (e.g. optical transceivers, SDH/SONET framers and payload switching circuitry) required to link the two Dragons. It might be possible to carry the payload between the Dragons via IP links but that effectively requires circuit emulation and packetisation functions for those links.

APS and Signalling Links

In all of the above cases it is also necessary to ensure that the signalling stacks are handled correctly. Ideally both payloads should carry the responses from the active signalling stack to ensure consistency. If the standby Dragon is generating its payload locally this may be difficult to achieve since the V5 or GR303 control functions may be inactive unless the stacks allow full hot standby operation. Note that the active/standby states of the signalling control functions and the active/standby states of the APS links may not be the same (i.e. an optical link failure might not cause the signalling control functions to switch). Therefore the active control function may need to copy all signalling messages to both Dragons.

It is also important to try and ensure that any standby protocol stacks are not confused by responding to messages they receive but having the responses ignored since they will be discarded.

APS within a Single Dragon

Some router manufacturers offer APS line protection with both interfaces terminating on the same card. This avoids the problems discussed above but provides very limited protection. Effectively protection is provided against failure of the fibre to the ADM or the optical transceivers at the Dragon or ADM etc. since ring protection is normally provided for the signal between the ADMs.

Another limitation of this approach is that replacement of the Dragon will impact both links. On the other hand the cost of this limited APS support is quite low since only the line interface components are duplicated. In the case of separate Dragons the entire card including costly DSP components is duplicated.

Signalling Interworking

Typically signalling systems operate between two signalling entities with provision for alternative transmission paths between them. The transmission paths may operate in active/standby or load shared modes. There is usually no explicit redundancy scheme for the signalling entities themselves but equipment redundancy can be provided locally on an active/standby basis.

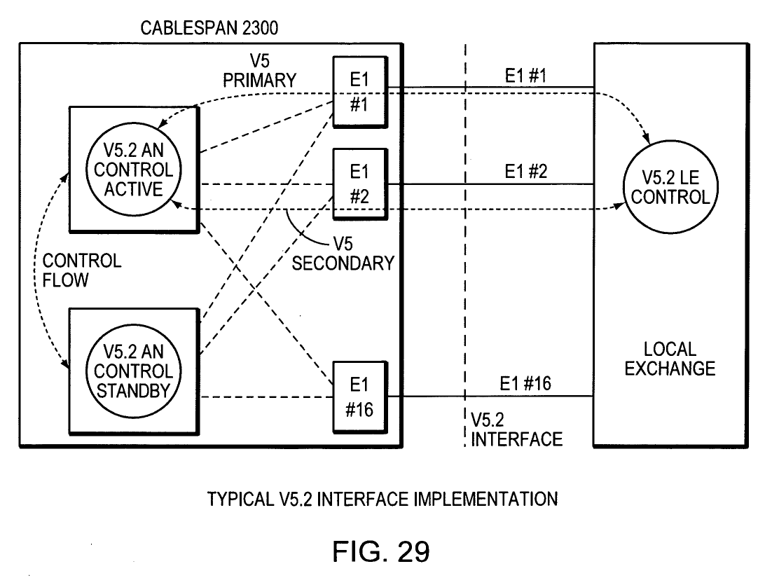

A typical V5.2 implementation, is shown in FIG. 29. There can be up to 16 E1 interface cards connected to the local exchange and there are two V5.2 controller cards. The active V5.2 controller manages all the E1 ports and terminates the higher layers of the V5 protocol stack (the physical layer typically terminates on a HDLC controller in the E1 port card).

In the event of a failure affecting E1#1 the V5.2 interface uses the protection protocol to move to the secondary V5 control channel. Typically the control cards will only switch over in the case of failure of the active control card.

A very similar method is used for GR303 interfaces with up to 28 DS1 ports.

In the case of an embodiment of the present invention, the port cards are integrated on the same card as the control functions. However the concept remains the same that the active control function must manage all signalling related functions for both sets of cards just as if the control functions were independent of the port cards.

Dragon APS/Equipment Redundancy

As outlined above there are many difficult problems in providing an APS solution for a Dragon. An embodiment of the present invention uses the general APS mechanism to provide equipment redundancy for a Dragon as well.

The basic idea is that two Dragons are configured as a protection group to provide 1+1 APS and equipment redundancy. Each Dragon contains several different functions whose detailed redundancy requirements will be examined below. Since the host router is only assumed to provide IP paths between the two Dragons the same scheme should work whether the Dragons are in the same router or in two different routers. In general providing redundancy across separate routers is preferable since it imposes less stringent resilience requirements on the host routers and gives better network level resilience.

Two scenarios can occur on the IP network side of the Dragon. In the case of access network applications the Dragon resilience is “single ended” since it must interwork with any MTA or IAD access devices. This means that it must work within the constraints of public standards. In core network applications however there is usually a Dragon at both sides of the IP network and these “double ended” applications may allow us to implement improved resilience mechanisms.

User Traffic Flows

In looking at the resilience issues it is useful to split the Dragon into two major functions: the media gateway; and control functions. The media gateway provides the processing of all packet flows to TDM and vice versa. These flows fall into two main categories: user traffic flows which pass through the media gateway; and control flows which terminate on the control function of the Dragon itself. This portion of the discussion looks at the user traffic flows.

IP to TDM Flows

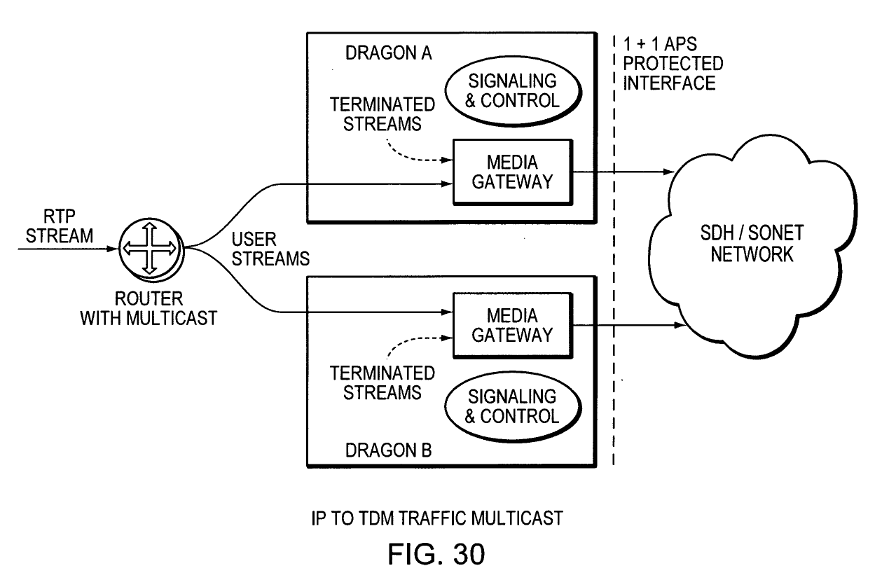

On the TDM side the APS interface requires a Dragon to provide two copies of the payload. One embodiment achieves this by multicasting the RTP packet streams from the router to both Dragons as shown in FIG. 30.

This method may not guarantee that the DS0 contents of both TDM streams are identical since both payloads are generated independently. However if we are using 10 mS packets and the Dragon only buffers one or two packets any switchover will cause less than 50 mS disruption. Even in a SONET or SDH system switchover can result in similar short disruptions due to delay differences around rings etc.

On the other hand if we were to generate the payload in the active Dragon and copy it to the standby Dragon there might be a loss of traffic if the active Dragon failed until the RTP streams were redirected to the standby Dragon.

The multicasting of the RTP streams could be provided by the routers using standard IP multicast techniques. This means that the RTP streams must be addressed to a Class D IP address which identifies a multicast host group. These addresses are allocated in the range 224.0.0.0 to 239.255.255.255 and various subranges are allocated to specific purposes in RFC 1700.

From the point of view of the sender the only real change is that it will be sending packets to a multicast IP address. The receiving host systems normally use the IGMP protocol to notify an adjacent router that they are subscribing to a specific multicast. Since the router multicasts based on IP address all the RTP and RTCP streams (within the limits imposed by UDP port numbers) can be multicast by providing a host group address for each set of media gateways (i.e. multicast does not have to be set up for each call). In an embodiment of the present invention, the host router will have to be advised that the media gateway is subscribed to a particular multicast group.

In using the classical IP multicast technique for protection, the routers will normally use spanning trees to minimize the use of bandwidth by multicasts. This means that the multicast would use a common path wherever possible, which conflicts with our requirements for redundancy. Of course with simple point to point network connections this should not be a problem.

The media gateway control function will need to obtain an IP multicast address. This could be assigned from a pool of IP multicast addresses available for local use using static configuration (RFC 2365). More generally it could be obtained from a multicast address allocation server (MAAS) using a protocol such as MADCAP. This is similar to the use of DHCP to allocate dynamic IP addresses. Multicast addresses allocated by MAAS will have an associated lifetime so that the MGC must be able to renew the multicast host group address as necessary. This also impacts the IP source (e.g. MTA) which would have to direct its RTP traffic to the new address.

TDM to IP Flows

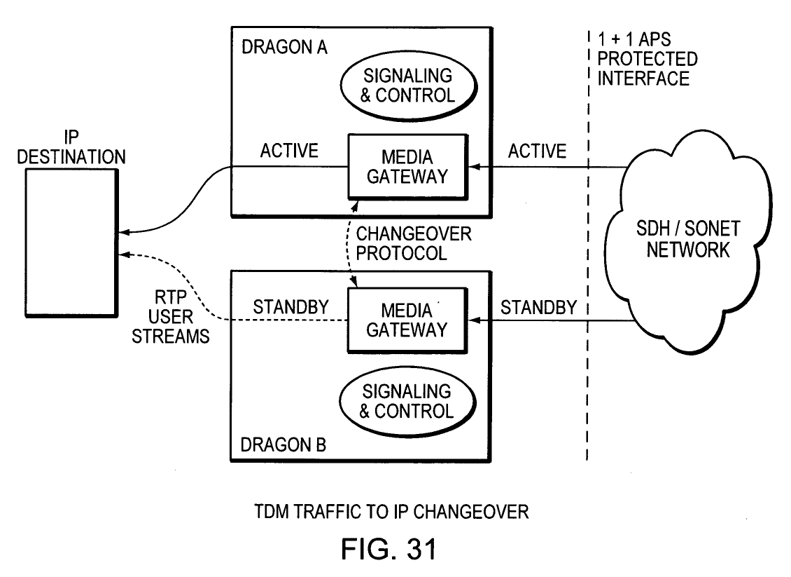

In this direction, as shown in FIG. 31, both media gateways receive the DS0 streams from the TDM network. The active media gateway will send an RTP packet stream to the destination router/IP device. as shown by the solid line. The “standby” media gateway still produces an RTP packet stream but does not transmit it to the destination. If both gateways actually transmitted RTP packets the user IP terminal would be confused.

The active/standby status of the media gateways is coordinated by a control protocol between the two Dragons. This protocol is linked to the APS K1, K2 byte protocol to ensure that the active media gateway is the one connected to the active APS link and the media gateway connected to the other link is in standby.

If a Dragon or APS link fails the changeover protocol causes the failed Dragon to switch to standby and the working Dragon to become active.

One aspect of this embodiment is that the RTP packets are built independently by the two media gateways and are not coordinated. This means that the packets may not be identical i.e. the two Dragons will assemble blocks of voice samples into packets independently. Therefore there will inevitably be some impact on switchover but with 10 mS packets it should not be significant.

Handling of failure of the comms links used to coordinate RTP packet transmission on APS switchover may be performed in the following ways:
If the comms links used direct Ethernet connections link failure could be detected by the router. Protocols such as 802.3 AD could be used to load share the links. Other alternatives include SCTP and multicast.
If the MG receives no response on the comms links then a ping of the router itself could distinguish between comms link failure and MG failure, i.e. if ping works comms links are working.
MG failure could be deduced from RTCP reports received by the standby MG indicating packet loss. MG failure is to be distinguished from CMTS failure.
The EMS may resolve.

An embodiment addresses synchronization problems in unidirectional APS mode if a Dragon is line timed. The local exchange could be taking its signal from the transmit side of a Dragon which has lost its incoming link and is therefore in holdover. An embodiment takes a timing reference to the Dragon from the one which is still locked to the PSTN i.e. the router provides sync outputs.

TDM to TDM Connections

In some applications it is important for an embodiment of the present invention to support local TDM to TDM connections. To reduce delay and dependence on the IP network (since these connections could, for example, be used to offload traffic to the PSTN when an IP network failure occurs) these connections would ideally be switched within the Dragon rather than being looped via the IP network.

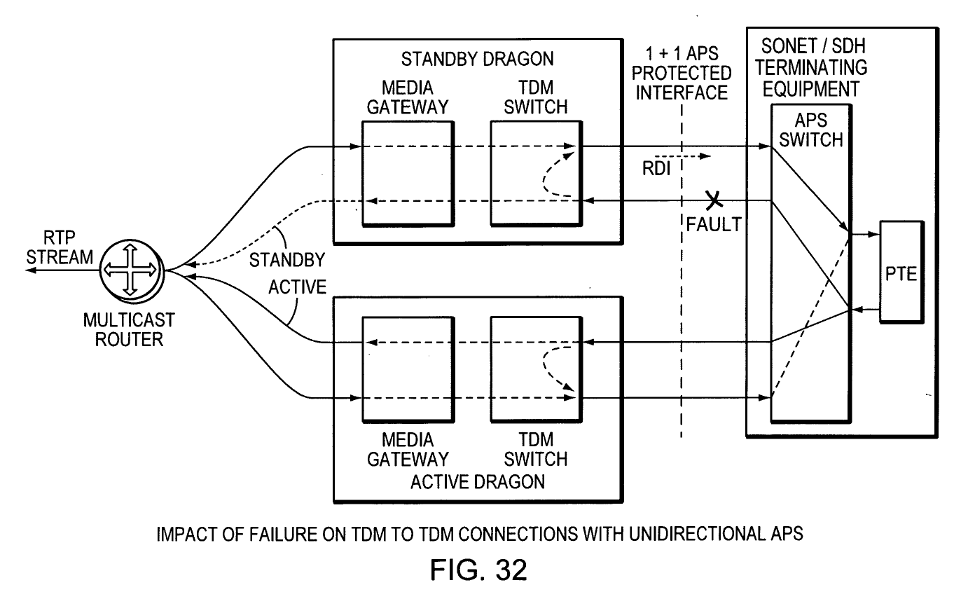

Unfortunately as shown in FIG. 32 this approach leads to problems for 1+1 APS resilience.

The figure shows the flow of normal IP to TDM connections via RTP streams. The TDM to TDM connections are also shown in the figure. The problem is that one Dragon is using the payload from the standby APS link to generate the outgoing payload for TDM to TDM connections.

If a failure affects one of the APS links as shown in FIG. 32 then that Dragon loses the source for its TDM to TDM connections. In the case of unidirectional APS, which is the default option for 1+1 operation, the SONET/SDH equipment in the PSTN could have selected this as the active link. Of course the Dragon will send back the appropriate remote alarm indication (e.g. RDI) but the APS specifications only require a protection switch based on local alarm conditions since both links usually carry the same payload.

Therefore the PSTN end could be using failed TDM to TDM connections in this case even though the IP to TDM connections are okay and the active APS link is working. This situation would not be acceptable. Solutions to these problems include:
1. An embodiment forces a changeover at the PSTN side under these conditions by failing the transmit link from the affected Dragon. This could be achieved by sending AIS on the line.
2. Another embodiment uses local DS0 TDM connections but switches to RTP connections on the standby Dragon during failure. Alternatively the active Dragon always uses local TDM to TDM connections but the standby uses the RTP connection from the active. This option has several drawbacks including different delays on active and standby links. Depending on the link selected by the PSTN end it may or may not experience the added packet delay. In addition switchover requires the Dragon to rearrange any TDM to TDM connections which could take significant time if there were a large number of these connections. Finally the connection software becomes much more complex.
3. Another embodiment connects TDM to TDM connections via IP streams. This has the disadvantage of introducing the additional packet delay. It may also be unacceptable in applications where TDM to TDM connections are used to protect against IP network failures. However it does solve the resilience problem and simplifies connection control.
4. Another embodiment is similar to option three but seeks to reduce the additional delays. NxDS0 streams may be used for the TDM to TDM connections thus reducing packetisation delay or to optimize frame sizes and buffering based on the knowledge that these are local connections. These approaches could reduce delay but at the cost of more complex control.
5. Another embodiment provides direct TDM links between Dragons. This gives each Dragon access to the payload from the active APS link. However it incurs the cost (and space) of additional TDM links even if they are not used in the specific application.

The third embodiment is the preferred approach. Since applications benefit from the reduced TDM to TDM delay if both sides of the connection happen to be on the same Dragon the additional delay is not normally an issue. However there may be exceptions (e.g. use of TDM connections for protection or to offload certain types of connection.) and local TDM to TDM connections should be retained as an option. Direct TDM to TDM connections are also preferred for load sharing or simplex scenarions.

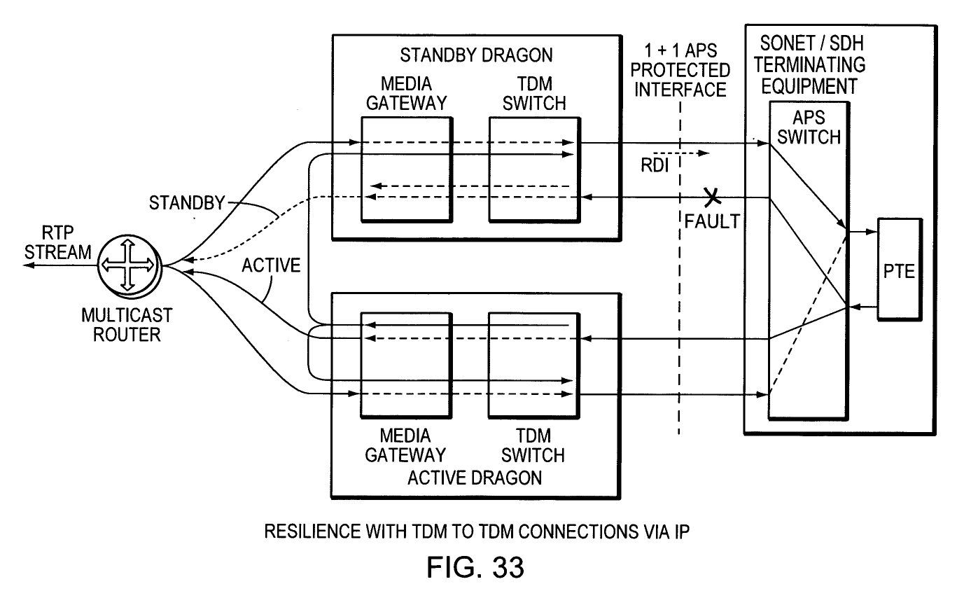

The data flows for option three are shown in FIG. 33. The TDM to TDM connections are shown in the figure. The RTP packet flows are generated by the active Dragon and are multicast to both Dragons. Just as with TDM to IP flows the standby Dragon does not send the RTP packet streams. Both Dragons are now building the TDM payload from the active streams.

When a switchover occurs the media gateway functions stop the RTP streams from the old active MG and start sending from the new active MG. This same mechanism should handle the “TDM to TDM” streams.

APS, Delay and Echo Cancellation

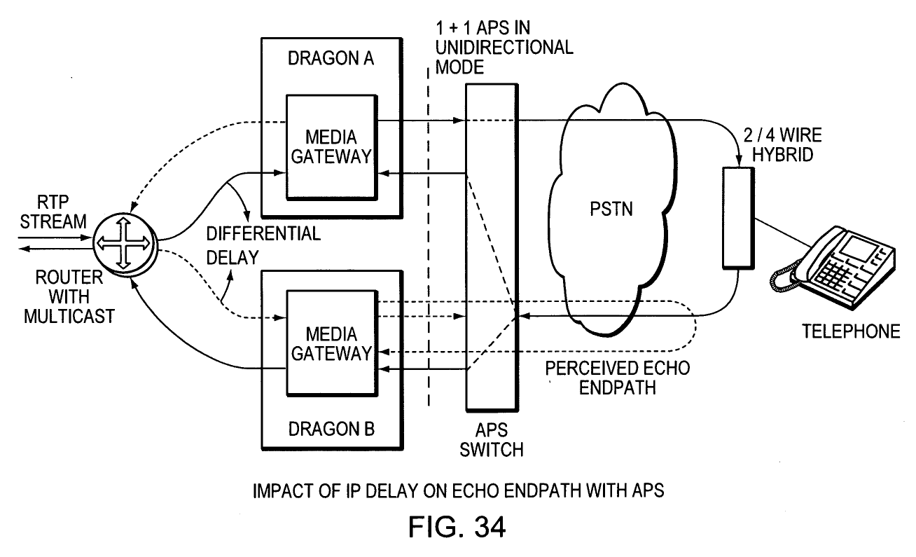

The default mode of operation of 1+1 APS (MSP) is unidirectional, which means that each end can choose its active link independently. This could cause a problem if there is a significant difference in the delay affecting the multicast RTP streams arriving at both Dragon media gateways. The issue is illustrated in FIG. 34. The solid line flows depicts the active voice path through Dragon A from the MTA to the PSTN (as selected by the APS switch in the PSTN equipment) and through Dragon B in the direction from the PSTN to the MTA.

Assume that the RTP delay to the Dragon A MG is lower than the delay to the Dragon B MG by D mSec. The signal follows the path from Dragon A to the hybrid at the telephone and the echo of this signal returns to Dragon B. For Dragon B, which is generating the RTP packets towards the MTA, the perceived echo endpath is from its TDM transmit port to its TDM receive port as shown by the dashed line in the bottom right-hand side of FIG. 34.

If the actual echo endpath delay on the PSTN is E mSec the echo canceller in Dragon B sees a reduced echo endpath of E-D mSec. If the differential delay in the IP access network becomes too big the perceived echo endpath could become negative and no echo cancellation would occur. If the differential delay (D) is kept low this could only happen where the PSTN endpath delay is short and so it should not be an issue as long as the absolute delay through the IP access network is controlled.

Of course if the differential delay affecting the multicast RTP paths was the other way around in FIG. 34 then it would add to the echo end path so as to make the perceived echo endpath longer. An embodiment controls this to avoid reducing the range of the echo canceller in the Dragon.

Approaches to Early Echo Problem

Extend the echo canceller window. One approach to dealing with the delay differences is to extend the window of each echo canceller to include the maximum possible time delta between the two IP data sources. In addition, a fixed delay on the return path (Send In) would match the maximum possible time delta. For example, if the signal to Dragon A could arrive as much as 5 msecs before Dragon B and we desire to cancel 55 msec tails, we would make each echo canceller 60 msecs in capacity. That way it would adaptively handle both the echo path delay and the extra delay.

Cross-couple the RTP streams. In this technique, the data is replicated across the Dragons so that echo path source signal (Receive Out) is guaranteed to be the same. A similar effect could be established by cross-coupling the TDM outputs. In this case, the Receive Out signals are identical across both Dragons and there is no delay difference to worry about.

Measure and adjust the time difference. In this technique, we implement a version of Network Time Protocol (NTP) and use it to measure the difference between the real-time clocks on each of the two Dragons. Then each of the Dragons also compares the real-time stamp on playout of an RTP packet by using its timestamp compared to the real-time clock on board. The jitter buffer playout delay is adjusted by the quicker of the two Dragons to force the RTP stream delta to less than a frame. (It could be less than any fixed amount but a frame is nicest.) Essentially, then the RTP stream that arrives first is delayed through the jitter buffer so that it lines up in time (to within a frame) with the later arriving RTP stream on the other Dragon. This allows the TDM Receive Out streams to be lined up and for the negative echo situation to be avoided.

Generation and Termination of SONET/SDH Path Overheads

APS operates with separate lines and therefore the section and line overhead bytes (regenerator and multiplex section overhead in SDH) are generated independently. However the path overhead normally originates from a single path termination equipment (PTE) whereas Dragon has two separate paths carrying essentially the same payload. This portion of the discussion examines the implications for path overhead under both normal operating conditions and in the presence of path faults.

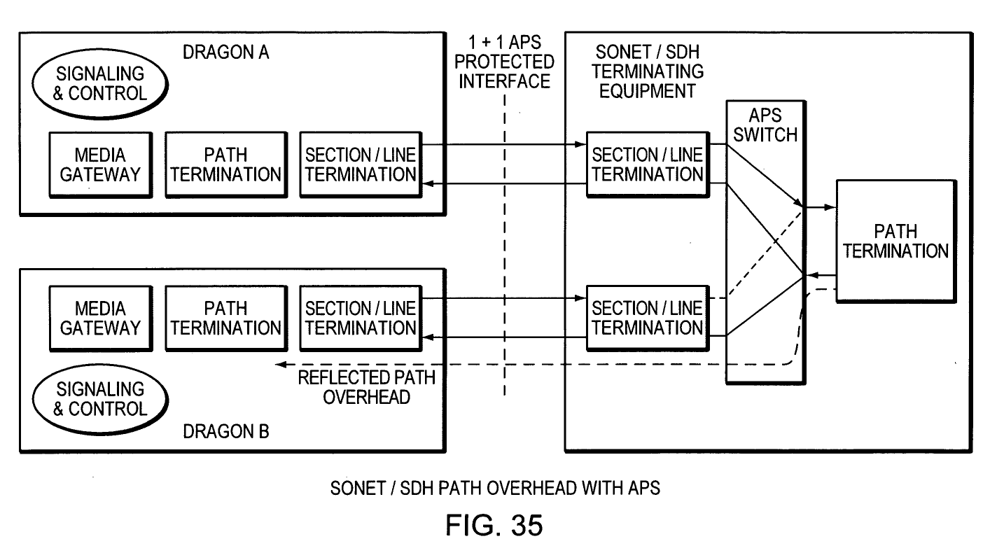

A typical scenario is illustrated in FIG. 35 where the path termination on the standby Dragon sees RDI and REI bits returned based on the path information generated by the active Dragon. This situation is illustrated by the dashed line near the bottom labeled ‘reflected path overhead’. These bits, which are in the G1 byte, are set at the remote equipment by the status of the active path.

Signalling Traffic and Control Flows

Generally the signalling and control flows are terminated on the active control function and are switched to the standby control function in the case of failure or a specific changeover request. In this respect the two Dragons are providing 1:1 equipment redundancy for the control functions as opposed to the 1+1 traffic protection on the APS links. The implications for each protocol will be examined below.

It is important to note that the control functions are assumed not to switchover along with an APS link switchover. One reason for this is that in the case of a quad OC3/STM-1 Dragon the working and protect links for different OC3/STM-1 interfaces can switch independently. This means that it is not valid to assume that the active controller can always be on the same Dragon as the working APS link. A second reason is that controller switchover requires all the signalling stacks to support hot standby and this might not be the case. In any case a controller switch always increases the risk of losing transient calls.

APS Protocol

APS is controlled by codes exchanged in the K1 and K2 bytes of the SONET or SDH line overhead. The bytes which control a changeover are exchanged on the protect line since they are required when the working line fails and since APS is defined for operation in 1:N as well as 1+1 applications.

Since the APS protocol is designed to operate independently on the protect line there appears to be no issues about terminating it. In one embodiment, the K1/K2 bytes are handled by the protect line termination. Also, the K1/K2 byte protocol may control which MG propagates the RTP stream. A control flow may exist between the MGs to ensure that the inactive MG shuts off its RTP stream.

V5.2 Signalling

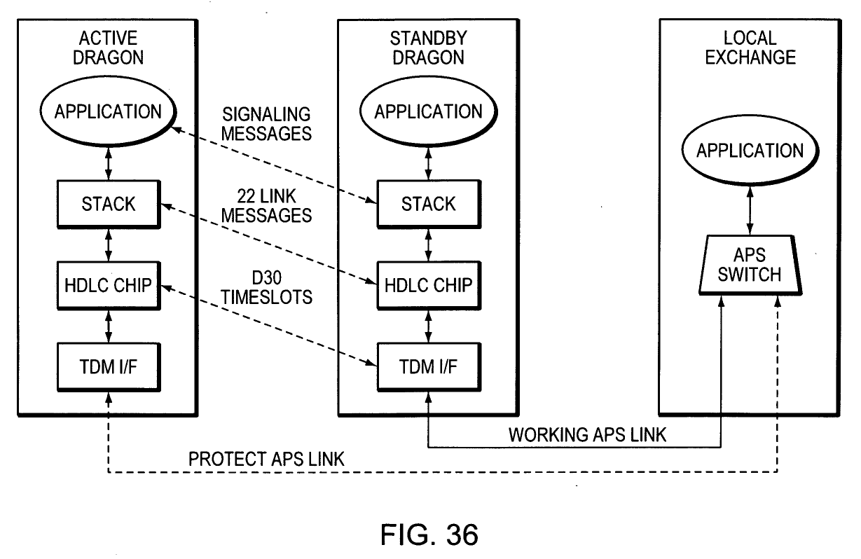

When working with APS the signalling applications in the active Dragon communicate with the local exchange signalling application over the two APS links as shown in FIG. 36. The APS system independently switches between working and protect links so that a signalling application (e.g. in the local exchange) will normally only see one link.

Within a Dragon the active signalling application terminates the signalling messages from the working APS link and sends all messages over both links. For the active Dragon signalling messages simply flow from the application to the signalling stack, then to the HDLC device and the TDM interface.

There are a number of embodiments for transferring signalling messages from the active Dragon to the TDM interface of the standby Dragon (which may actually be driving the working APS link as shown above).

One embodiment is that application level messages could be copied via IP to the top of the stack on the standby Dragon. In this case the stack and HDLC device on the standby Dragon are fully active. This approach has the advantage that IP links between the two Dragons are readily available and passing IP messages between Dragon processes is required for several functions. Unfortunately there may be problems in trying to operate both stacks like this. For example the link layer of most signalling stacks inserts sequence numbers on the messages which must be acknowledged by the receiver. In this case the stack on the working link would get valid acknowledgements but the stack on the protect link would also see the acknowledgements for the working link. Since the two stacks would be assigning sequence numbers independently the stack connected to the protect link would not see valid acknowledgements and consider the link failed.

The embodiment closest to the spirit of APS is to pass the signalling message all the way down the stack on the active Dragon and copy the resulting DS0 streams to the TDM interfaces on both Dragons. This way both links carry exactly the same signalling messages. However this requires TDM links between the two Dragons for signalling and control timeslots. A little more than two E1s worth of capacity is required between Dragons to carry all the possible signalling timeslots in an STM-1 (63 E1).

Another embodiment carries the signalling DS0s between Dragons as RTP streams. This is more flexible than dedicated TDM links. This approach adds packetisation delay for the signalling links but this could be reduced by carrying NxDS0 blocks in each signalling RTP stream.

Another embodiment takes the layer 2 packets which are transferred to the HDLC device and copies them across to the HDLC device on the standby Dragon over IP. This overcomes the sequence number and state problems outlined earlier. However the packets may not be protected by the CRC which the HDLC device adds in the Q.921 frame check sequence (FCS) field.

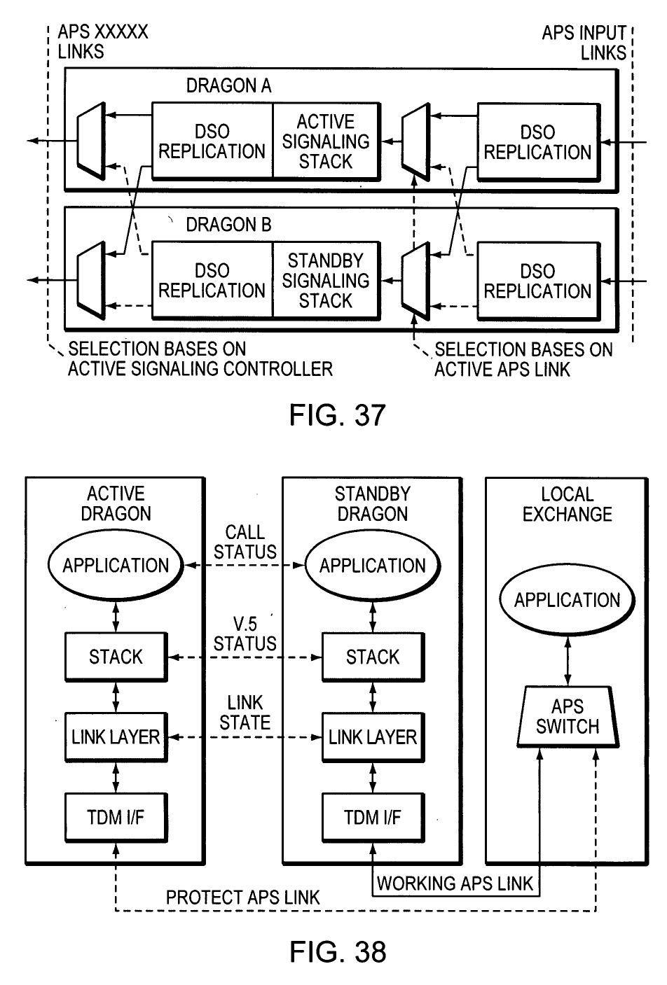

It is preferable to work with a single active stack and copy the DS0 level bit-streams as appropriate. The number of DS0 signalling links to be replicated depends on the number of V5.2 interfaces and the number of signalling and control timeslots allocated per interface (V5.2 allows the use of separate timeslots for control, PSTN signalling etc. if warranted by the message rates). The basic scenario for each signalling or control DS0 replicated is illustrated in FIG. 37.

The incoming signalling DS0 from the active APS link is copied to the active signalling control function. These are independently allocated on either the Dragon so each the Dragon must copy its received signalling DS0s to its partner.

Similarly, the outgoing signalling DS0 from the active stack is replicated to both the Dragons. Therefore each external signalling DS0 requires two DS0s of capacity between the the Dragons.

Another problem is the level of replication required between the active and standby control functions and stacks. This is illustrated in FIG. 38.

Replication is required to ensure that the standby system has sufficient state information to allow for hot standby changeover. In one embodiment, the application level call state information (including the mapping of DS0s to MTA IP addresses, current call state etc.) may be replicated for all calls. This replication may be sufficient to maintain all stable calls or may include more detailed state information to try and maintain transient calls (i.e. calls currently being set up or cleared down.

In another embodiment, replication may be provided for lower levels of the stack if appropriate or they may be restarted depending on the stack architecture. GR303 and Robbed-Bit Signalling (including RTP Events) The most common version of GR303 uses a hybrid signalling approach. The TMC (Timeslot Management Channel) protocol is a message based protocol which handles timeslot assignment across the interface. Once TMC has assigned a channel to a call, line signalling is carried using traditional DS1 robbed bit signalling (RBS). The TMC protocol uses two DS0s in separate DS1s for redundancy. Alternatively GR303 defines a common channel signalling protocol for both timeslot assignment. GR303 also provides an embedded operations channel (EOC) for management purposes which runs on a separate DS0.

All these protocols are message based and run over a LAPD link layer so they can be handled in the same way as the V5 protocols. However the robbed bit signalling introduces problems.

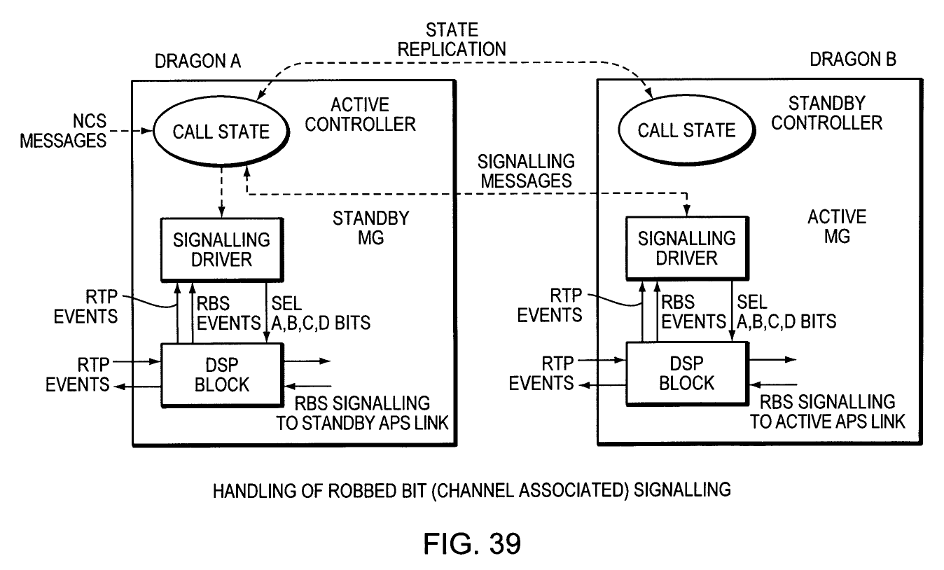

FIG. 39 shows a high level view of the robbed bit (channel associated) signalling with redundant the Dragons. It is assumed that there will be an overall signalling application which handles call state information and is message driven. This call state application operates in an active/standby mode as shown.

The actual RBS bit processing occurs in a DSP block in the media gateway function of each the Dragon. In addition there is some driver level application interfacing to the basic RBS detection block which converts events to messages and vice versa. This also handles very time sensitive events such as hook flashes or message intensive events such as dial pulses. In any case the events are converted to messages, which are sent to the call state machine in the active the Dragon controller.

Since both the Dragon MGs are seeing the same robbed bit signalling events only the MG connected to the active APS link sends a message to the controller. The call state function sets the signalling bit state via a messages to both MGs. This ensures that both active and standby APS links should be carrying the same RBS values (excluding transient situations where the bits are being updated).

As shown in FIG. 39 the active call state machine interworks with the NCS signalling protocol from the MTAs and call state information is replicated to the standby call state machine as required over the inter-the Dragon IP links.

One embodiment uses RTP events to supplement NCS for time sensitive signals such as hook flash. RTP events are multicast to both the Dragon MGs and are detected by the DSP block. They may be used to set the outgoing RBS signals directly on both MGs. The active MG (connected to the active APS link) sends an event message to the active call state machine. In the reverse direction the RBS bits may also generate RTP events. In that case both DSP blocks detect the RBS event but only the active MG actually sends an RTP event message. It may also notify the call state machine on the active controller.

Another embodiment uses RBS carried in DS0 multiframes to the active controller i.e. both RBS streams terminate on the active controller. This is similar to carrying the V5 control DS0s via RTP.

RTCP Messages

Since RTP messages are multicast the corresponding RTCP messages to the same IP address are also multicast. Also since RTCP messages are over UDP and are not acknowledged multicasting them to both MGs does not likely cause problems.

In the reverse direction only the active MG actually sends RTCP reports. Again this is consistent with the behaviour of the RTP packet streams and it is controlled by the same mechanism. Since no acknowledgement is required the RTCP application on the standby MG should behave normally.

RTCP does allow for multiple session listeners so it would be possible for the standby the Dragon to generate Receiver Reports if desired.

Media Gateway Control and Signalling Flows

Various applications for the Dragon use several related control and signalling protocols. In generic SoftSwitch applications embodiments may use MGCP or Megaco to control the the Dragon. In Cable Access SoftSwitch applications the the Dragon is controlled by TGCP, which is a specific profile of MGCP. In Cable Access concentrator applications the Dragon signalling interworking function acts as the MGC side of the NCS protocol, which is also a specific profile of MGCP.

These protocols are not really affected by the use of APS or load sharing on the TDM interfaces but they have common characteristics from the viewpoint of resilience which will be described here rather than duplicating similar descriptions in the application specific scenarios.

Currently MGCP and Megaco/H.248 are the main protocol alternatives for media gateway control applications. While the protocols themselves are quite different the mechanisms they provide for handling resilience and media gateway restarts are quite similar. The main difference is that the Megaco ServiceChange command allows a media gateway to indicate to the MGC that the primary MG is out of service and a secondary MG is taking over. MGCP has no explicit mechanism to cater for redundant MGs.

TGCP, MGCP and Megaco in Media Gateway Mode

This portion of the discussion examines the operation of an embodiment of the present invention as a trunk gateway in SoftSwitch applications. In the following descriptions the MGCP terminology is used. From a Dragon perspective the MGC is in the SoftSwitch and the MG is the Dragon. Specifically the active and standby MG status refers to the agent and control functions in the Dragon rather than APS active/standby which is assumed to operate independently.

There are two main groups of scenarios where these protocols impact resilience. One group is during start-up where a new Dragon checks for an active partner and register with the SoftSwitch etc. The second group involves Dragon failovers and hand-offs between SoftSwitches during normal operation.

Since MGCP and TGCP may not support explicit mechanisms for MG failover a multicast mechanism is used by one embodiment to allow both Dragons see MGC messages. However only the active Dragon control function processes them and responds.

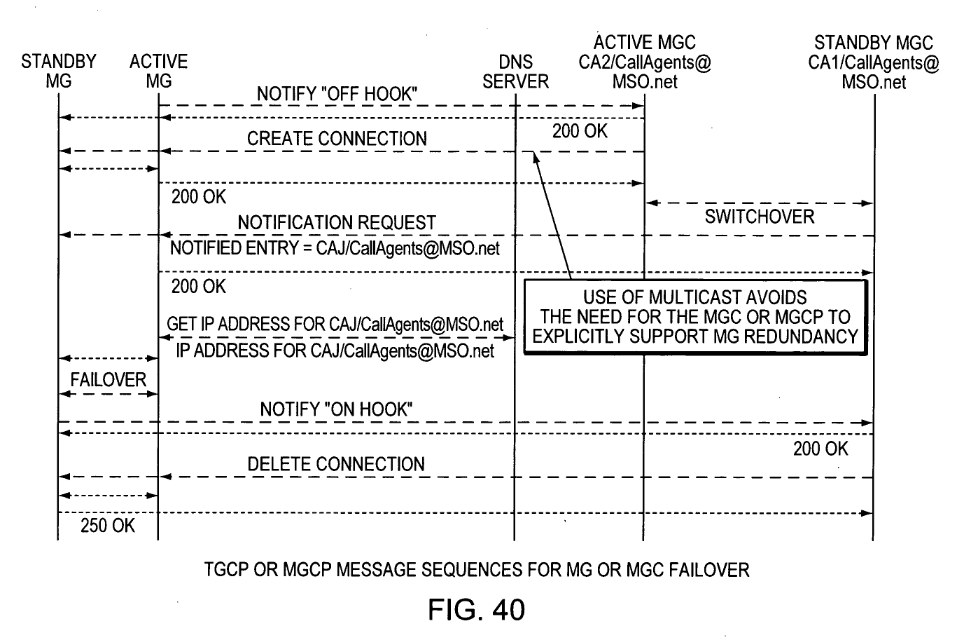

An example failover message sequence is illustrated in FIG. 40. The active MGC initially is CA2 and CA1 takes over part way through the call. The first phase shows a call starting up. The second phase shows an MGC switchover. The third phase shows an MG failover. Finally a disconnection sequence for the call is shown. The dotted arrows between MGs indicate replication flows between the active and standby Dragon control functions.

If the MG is detecting line conditions (based on a notification request) the active MG sends an “Off Hook” notification to CA2 at the beginning of the call. Usually in the trunk gateway scenario this indication is received directly by the SoftSwitch using SS7 messages. The MGC then sends the MG a CreateConnection command. Note that some aspects of the connection (e.g. the ConnectionName) are assigned by the MG. This information is replicated from the active Dragon to the standby Dragon. The command response is shown as a 200 OK in FIG. 40.

Subsequently the active MGC fails and a switchover occurs between the two MGCs. This is not directly visible to the Dragon MG. However the new MGC updates the “notified entity” parameter of the MGs either using the NotificationRequest, as illustrated above, or an Audit command with a new NotifiedEntity value. The MGC could use a single command per MG by using the wildcard convention to identify all endpoints in the MG.

Since the notified entity is a name rather than an IP address a transaction is shown between the active MG and the DNS server to obtain the corresponding IP address. When the DNS server responds the active MG replicates the information to its partner.

The next phase shows a failover occurring between the Dragon MGs. As shown this is not supported by the MGCP protocol and is not communicated to the MGC. The handover just occurs between the Dragons themselves.

Finally the call cleardown sequence is shown being completed between the new Dragon MG and the new MGC. Note that the active Dragon updates the connection status on the standby Dragon via replication.

In the case of Megaco there is a ServiceChange failover command which enables the MG to notify the MGC that another MG is taking over. The benefit of using the Megaco failover message is that it avoids the need for multicast addresses.

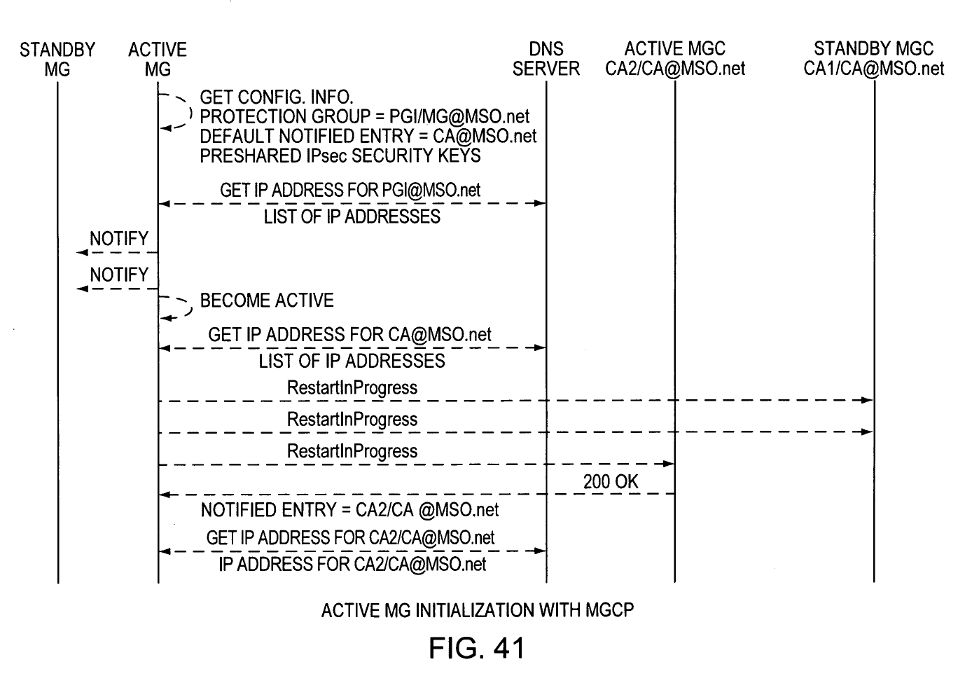

Having looked at the failover mechanisms during normal operation the following paragraphs address the problems of Dragon initialisation and establishing an association with the active MGC. The case where the first Dragon in a protection group starts up and becomes active is outlined in FIG. 41. In this context, protection group as used herein simply refers to the domain name and associated IP address of a group of Dragons providing redundancy, and thus is not necessarily identical to the manner in which the term protection group is used in a MIB context. Note that this implies that the Dragon has already been operating and has been configured as part of a protection group.

When the Dragon MG powers up it must be able to access several configuration parameters from persistent storage. These include the identity of its protection group, the default notified entity name and some preshared IPsec security keys. It will obtain a list of IP addresses for the Dragons in the protection group from a DNS server if it has been configured to be part of a protection group. If it is configured in simplex mode it skips the next phase and becomes an active Dragon controller immediately.

The MG tries to establish communications with an active Dragon controller as indicated by the dashed notify arrows. Assuming it receives no response it re-tries and if there is still no response it will become the active Dragon controller.

An embodiment may use direct links for replication between Dragons (or at least their host routers). In this case, the timeouts for this protocol are kept quite short and more than two attempts should not be required. An embodiment may also include backoff and glare resolution mechanisms to ensure that two Dragons powering up at the same time will not result in deadlock or both becoming active simultaneously.

Having become active the Dragon controller obtains the IP addresses of its default notified entity from the DNS server. This will normally return a list of IP addresses. The Dragon controller then sends a RestartInProgress message to one of these addresses in an attempt to establish contact with its active MGC. These messages are secured by IPsec using the pre-shared secret keys. The restart message uses wildcard notation to identify that all the MG endpoints are being restarted.

If the IP address used is not the active MGC there are two possibilities. One is that there will be no response and the MG tries again after a timeout. The timeouts and retry mechanisms are specified in TGCP and MGCP. Alternatively the standby MGC may acknowledge the message with an error response and a new notified entity name. In that case the MG continues to try registering with the new entity.

After a number of retries and timeouts, as shown in FIG. 41, the MG tries a new IP address from the list. If the restart message is successful the MG will receive a positive response optionally including a new notified entity name.

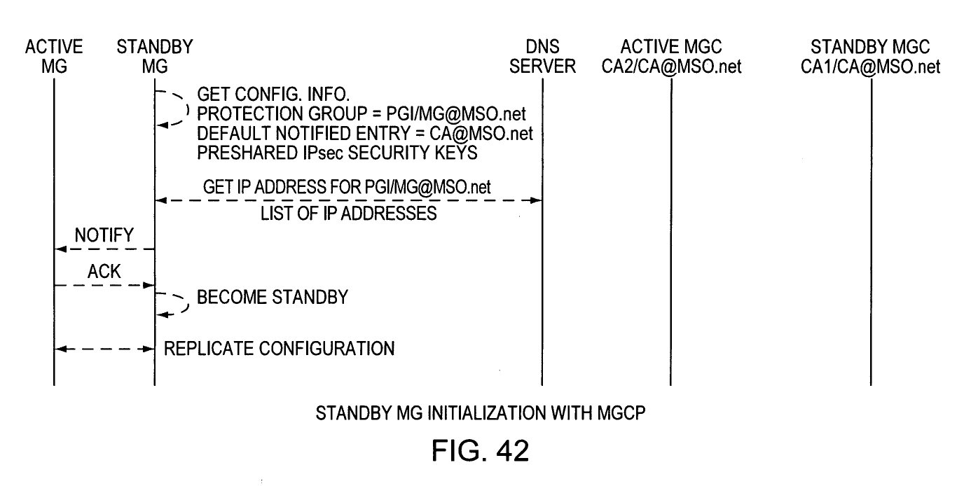

The startup sequence for a standby MG is shown in FIG. 42. The main point in this case is that another Dragon in the protection group is already active and acting as management agent/control function for the group.

The first phase of startup is identical to the previous scenario. However when the Dragon starts the arbitration process as indicated by the Notify arrow it receives an acknowledgement from the active MG. The two Dragons then run a replication process to update the configuration of the standby Dragon. On completion of this process the standby Dragon is operational. There is no exchange of MGCP messages with the SoftSwitch since all MGCP messages interact with the active agent/control function for the group of Dragons.

The replication process provides the address information.

NCS or MGCP in MGC Mode

This portion of the discussion discusses applications, such as cable access concentrators, where Dragon is acting as the controller side of the MGC protocol and managing access device (e.g. MTA) operations based on interworking with V5.2 or GR303 local exchanges. In the following diagrams the MGC function is in the Dragon rather than being in a SoftSwitch.

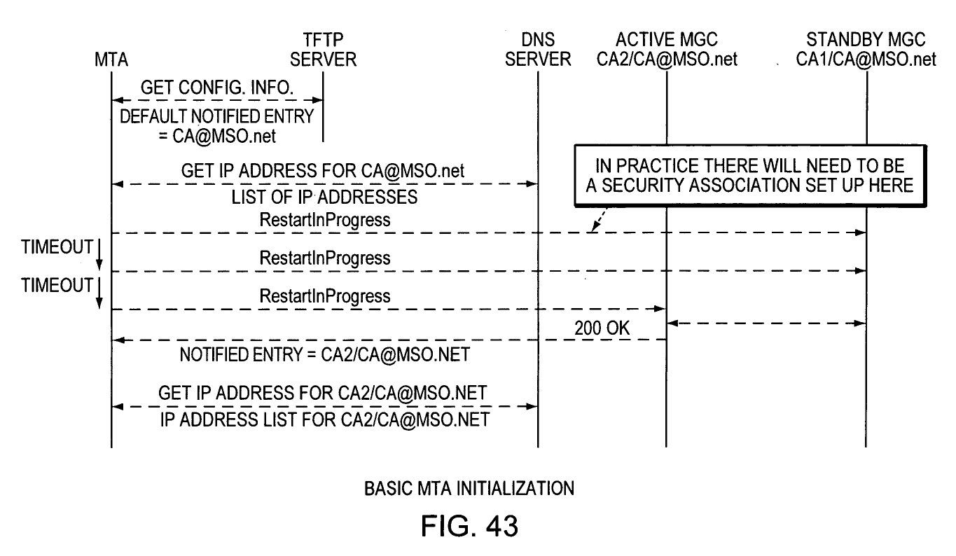

The NCS sequence for MTA initialization is outlined in FIG. 43. The Dragon (MGC) startup sequence is essentially the same as described above. The only real difference is that there is no registration sequence with a softswitch.

When an MTA powers up it downloads a configuration file from a TFTP server which contains, among other things, a default “notified entity” which is the Call Agent (MGC) for the MTA. In one embodiment, the configuration provides a Call Agent name (domain name) which is resolved by DNS rather than an IP address. Several IP addresses may be associated with a domain name and the MTA retries using alternative addresses if its first choice fails.

DNS does not guarantee that the resource records providing IP addresses for a given domain name are returned in any given order or priority. Therefore, in one embodiment, the MTA tries to contact either the active MGC or a standby MGC on restart. It then speeds up the MTA restart process if the standby MGC could respond to a restart notification with the appropriate NCS error response and notified entity information for the active MGC.

The Call Agent may explicitly change the “notified entity” using the optional “Notified Entity” parameter in an NCS command. An embodiment may set up a number of MGC names in the DNS. For example, the default group name (e.g. CallAgents@mso.net) returns a list of IP addresses which the MTA can try to contact. In another embodiment, the DNS may also have specific MGC names (e.g. CA1/CallAgents@mso.net and CA2/CallAgents@mso.net) with individual IP addresses so that the active MGC can modify the MTA's notified entity to one that has its specific IP address. This ensures that the MTA can find an active MGC on start-up and can be redirected to another MGC in the case of switchover on command from the new MGC call agent.

Even a single MGC may have more than one IP address, for example it may be connected via two Ethernet subnets for resilience.

The MGCP standards do not specify how the Call Agents co-ordinate their activity. The same replication methods may be used for MGCP state information as are used for V5 or GR303. Similar methods may also be used to coordinate active/standby operation. For example in FIG. 43 the dashed arrows between the MGCs show that data must be replicated to the standby MGC when an MTA registers. Therefore the standby MGC should have up to date state information when a changeover occurs.

Following a changeover the active MGC may send notification requests to all MTAs identifying itself as the new notified entity and the events to be notified. It is possible that the phone could have gone on-hook or off-hook in the intervening period in which case the line is already in the state requested. In that case the MTA returns an error response indicating the current line state.

The process of notifying all MTAs of a changeover is time consuming. Therefore it is preferred that the MGCs use a multicast address so that both active and standby MGCs can access MTA NCS messages. This is very similar to the method for multicasting TGCP messages to redundant MGs described above. Use of multicast also means that the initial MTA restart messages will go to both active and standby MGCs.

Of course some state information can be inconsistent where calls are being set up or cleared during changeover or failover. Therefore it is preferred that all MTAs be audited by the new MGC following a changeover.

Media Processing

G.711 VoiceCoding

The Dragon supports the adaptation between TDM data streams and VoIP packet streams as G.711 encoded voice (A-law or μ-law). Voice Compression The Dragon supports a family of voice compression techniques that may be applied on a per connection basis (specified at connection set up time). While a given Dragon device ideally can be flexibly used in multiple applications, it should be noted that one application may involve a different set of algorithms than another application. A list of various possible algorithms for voice compression includes, for example: ITU-T G.723.1 at 5300/6300 bps; ITU-T G.726 at 16000, 24000, 32000, 40000 bps; ITU-T G.727 ADPCM; ITU-T G.728 at 16000 bps; ITU-T G.729 Annex A and Annex B at 8000 bps; ITU-T G.729 Annex D at 6400 bps; ITU-T G.729 Annex E at 11800 bps; ITU-T G.729 at 8000 bps (full complexity); GSM Adaptive Multi Rate (AMR); GSM Full Rate (FR); GSM Enhanced Full Rate (EFR); GSM Half Rate (HR); CDMA QCELP; and D-AMPS/TDMA VSELP.

The codec to be used for a particular connection is based on Dragon configuration data (i.e. a preference list of default codecs to use if not otherwise stated), customer specific data (i.e. associated with the end user—typically only applicable where the MGC function is contained in the Dragon) or as specified in MGCP requests.

Voice Processing Delay

Delay through a Dragon is generally driven by the following items: VoIP Frame Size (see 0)—TDM-IP only; Jitter Buffer (see 0)—IP-TDM only; and Internal Processing.

As both VoIP Frame sizes and jitter buffer sizes are configurable, then the only real element of delay that is independent of any specific deployment is essentially the internal processing delay (which includes, for example, echo cancellation, voice compression etc.). Ideally, the Dragon introduces delay (over and above VoIP frame size and jitter buffer induced delays) of no more than 3 mS from the point of entry to the point of exit of G.711 speech in the Dragon module (stated herein as a preferred target value). As a result, the result is that in an ideal scenario (5 mS G.711 VoIP Packets with a default jitter buffer), the delay introduced in the Dragon is no more than 8 mS for TDM-IP voice and no more than 13 mS for IP-TDM voice.

All TDM-TDM connections wholly contained in a single Dragon module ideally introduce no more than 3 mS delay independent of VoIP configurations (stated herein as a preferred target value).

Bearer Capabilities

The Dragon supports the connection of the following bearer types, with no corruption of the data path: Voice (Delivered as G.711, may be compressed—see 0), including the transparent transport of voice frequency tone signals (such as DTMF); Fax/Modem; Switched 56 (SW56) data (i.e. clear channel 56 kb/s pass through); ISDN 64 kb/s data (single channel bit-exact pass through); and ISDN Nx64 kb/s (multi channel bit-exact pass through).

Echo Cancellation

The Dragon provides per call echo cancellation conformant to latest versions of G.168 with a default 64 mS end path. It is possible to configure (as a load option) a Dragon application to support longer end paths (96, 128 mS), at a reduced throughput capacity (note that this configuration would be on a per Dragon and not per DS0 basis).

Echo cancellation is available on the following connection types: IP-TDM (EC applied in direction of TDM interfaces); TDM-TDM (EC applied in either or both directions); and IP-IP. Note that TDM-TDM connections may be realized across pairs of Dragons (either in the same router or in separate routers). In such cases the connections act as two individual TDM-IP and IP-TDM connections.

Echo cancellation is selectable on a per call basis, depending on the following criteria: Signalled information (e.g. MGCP/NCS parameter “Local Connection Options”, V5 Information Element “Attenuation”); and Tone Detection (e.g. echo cancellation is disabled when fax/modem tones or EC 2100 Hz disabling tone are detected in the data path).

VoIP Capabilities

Basic VoIP

The Dragon supports the transmission and reception of VoIP packets via RTP over UDP. The Dragon collects and sends per VoIP connection QoS statistics using the RTCP protocol (VoIP QoS statistics may be used to generate PM data).

The Dragon supports the following VoIP capabilities (selectable on a per connection basis) as appropriate for the voice codec in use: Voice Activity Detection (VAD) and Silence Suppression; Comfort Noise Generation (CNG); and Packet Loss Concealment (PLC).

VoIP Packet sizes are selectable on a per connection basis from a range of 5 to 40 ms in 5 ms steps, with a default packet size of 10 ms for G.711 codecs, and the frame size for other codecs. The default packet size can be changed via configuration.

VoIP Jitter Handling

The Dragon is capable of handling jitter in the IP network. To accommodate this, the Dragon employs a configurable jitter buffer with maximum size of 250 mS and a configurable set-point (the point that the buffer will be allowed to fill to before packets are extracted).

As a default, the jitter buffer established for each connection is four times the VoIP packet size, with a set-point of twice the VoIP packet size.

The default parameters of the jitter buffer for the Dragon may be overridden via configuration to accommodate networks with differing jitter characteristics. The default jitter buffer parameters may also be overridden on a per connection basis; for example, to allow for improved error handling for delay-insensitive media streams such as fax. Such per connection override of jitter buffer size can be an internal Dragon function, and need not be controlled via MGCP.

Handling jitter depends on the availability of clock sources—see additional discussion below.

Ideally, the jitter buffer length and set-point are optimized to minimize the chances of suffering the ill effects of dropped packets. The fax arena, by way of example only, is less impacted by delay than is voice or data modem traffic. When a fax call is carried, especially in a G.711 pass-thru mode, a greater time can be allowed for receiving packets rather than declaring them lost and using some lost frame substitution method to fill the gap by having a longer jitter buffer and a later set-point than would be typical for high quality voice calls. If effectively deployed, the result is fewer dropped calls and fewer errors in fax calls carried in a VoIP system. Other aspects include different jitter buffer lengths for different voice coding methods. The use of longer jitter buffers for G.711 than for compressed codecs could be useful, especially given that there is no algorithmic delay with the G.711. Moreover, the RTP timestamps can be used to determine a nominal transit time, and the jitter buffer can be tuned up to a length that is just short of what is considered a maximum allowable delay before which degradation in speech quality occurs.

Fax/Modem Pass Through

The Dragon provides the ability to detect the fact that a G.711 VoIP connection is carrying fax or modem data (via tone detection) and to switch to “Pass Through” mode (i.e. disable any silence suppression, echo cancellation etc.)

The Dragon provides the ability to detect the fact that a compressed voice VoIP connection is carrying fax or modem data (via tone detection) and to inform the controlling element (MGC or Management System). The controlling element is then capable of renegotiating a G.711 “Pass Through” connection.

Relay Mechanisms

The Dragon supports the following relay mechanisms for non-voice signals: Relay of Fax traffic over IP using the T.38 protocol. This allows for reliable transport of fax that is especially tolerant of packet loss; Relay of DTMF Digits over IP, which allows, for example, transport of digits between end users and intelligent devices (such as online Banking systems that request PINs via DTMF); Relay of network MF tones over IP, which may be used to support inter-PBX signalling; and Relay of Telephony Events (e.g. Off-Hook, Ring) over IP, which may be used as part of GR-303 interworking in the access network, where timing of such telephony events is important.

VoIP Network QoS Mechanisms

The Dragon supports IP mechanisms such as DiffServ or MPLS in order to provide QoS guarantees for VoIP traffic.

### Congestion Detection from IP Delay Monitoring

Most proposals for IP QoS in core networks accept that per call QoS is unlikely to be practical in an IP environment. General approaches are based on DiffServ marking and MPLS paths. However, DiffServ is monitoring and marking packets at the edge of the network without knowledge of traffic flows and failure conditions inside the network. Therefore it cannot guarantee QoS for voice unless voice is a small proportion of traffic. Currently the proposals are traffic engineering based on Diffserv and MPLS or per call reservation of bandwidth with RSVP. The first is statically configured and cannot cope with dynamic traffic changes or failures. The second is not scalable due to the need for core routers to maintain “soft state” information on flows which needs to be refreshed regularly due to the unreliable nature of RSVP signalling messages over UDP.

One approach for managing QoS is to detect congestion dynamically and block the setting up of new calls when congestion occurs. While one way of detecting congestion is based on packet loss, this only shows up once congestion is already causing packet loss. An alternative is to monitor delay in the RTP packet streams, such monitored delay being analyzed as a predictor of congestion since the build up of queues in network routers precedes packet discard.

Separately, but on a related note, compression or silence suppression could be used to alleviate congestion and exploit the flexibility of IP. This could allow the network to still carry a full load with lower quality in the presence of a link/trunk failure without having to double capacity to provide redundant paths.

Connection Control—MGCP

The Dragon supports the MGCP protocol as a Media Gateway for the purposes of connection set-up and tear-down and ancillary functions. Ideally, the Dragon is MGCP 1.0 compliant (see IETF RFC 2705) and allows for its adaptation to various profiles for specific markets/networks.

A profile of MGCP is a particular implementation/deployment that is compliant with a named subset of IETF RFC 2705, and which provides deployment specific detail (such as end point naming conventions) that are not explicitly covered in IETF RFC 2705.

IP Network Resiliency

One approach to providing resilience for VoIP, is to depend on local fast reroute of LSP paths for resilience. In this embodiment, the IP routers support relatively fast reroute mechanisms and may impose topology constraints on the level of meshing required in the network so that recovery LSP paths are available.

Another approach to providing resilience for VoIP is to look at end to end application level protection for voice traffic. This embodiment may minimize the dependency on the IP network, may make it easier to explicitly provision protection paths and takes advantage of VoIP connections readily detecting packet loss.

Other embodiments may involve a blend of these approaches.

### Basic Tandem Application

The following discussion first focuses on embodiments with respect to a tandem network application with Dragons at both ends, and then other embodiments that extend certain aspects of this approach to access networks or situations where the other end is not a Dragon.

The basic idea is that the Dragon A is sending to B via the MPLS path. If B detects a failure (e.g. loss of RTP packets) then it sends a defect indication to A that causes the traffic to be switched to the alternate MPLS path. Since both paths are configured end router to end router via disjoint routes and have associated bandwidth switchover can be quite fast. In this scenario end to end MPLS paths are assumed to exist between the routers to control flow of packets through the network. It is not implied that the paths actually terminate on the Dragon. An option is to terminate the paths on the adjacent router.

At least two embodiments of operation are possible. One embodiment is a 1+1 operation where the Dragons send packets over both paths and the receiver makes the selection. Another embodiment is a 1:1 operation where the Dragon sends over one path and then switches path on request from the far end. In this case the RDI indication is also an APS switch request. An advantage of the 1:1 operation is that the unused bandwidth is available for best effort IP traffic.

A number of problems arise from this basic scenario and solutions to the problems will be discussed below. These problems include: the need for IP crosslinks; methods of detecting LSP failure; switchover and monitoring of the standby path.

IP Crosslinks

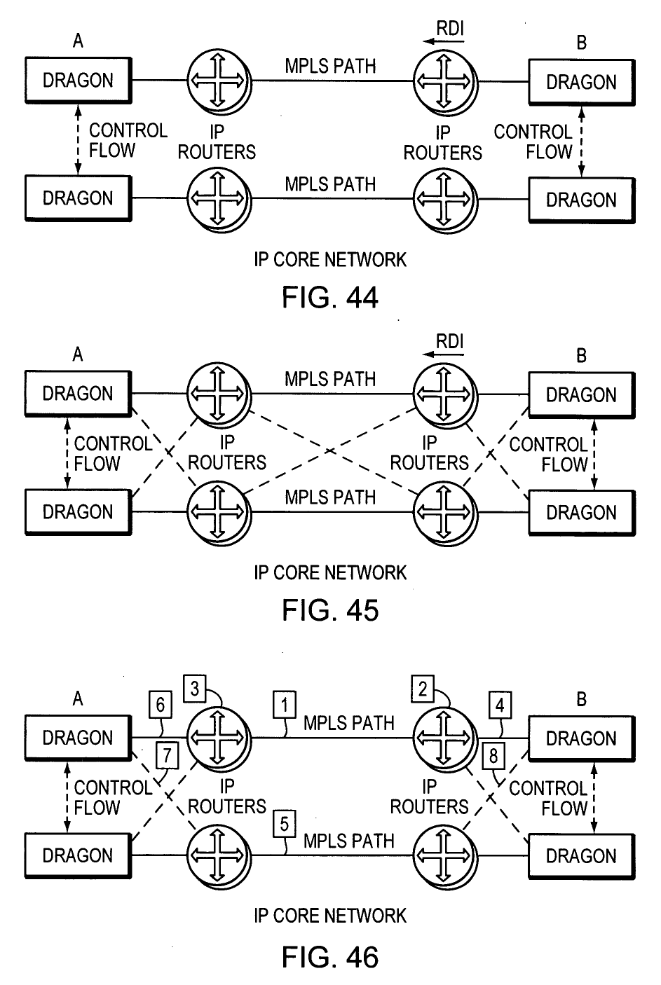

If for example we only have the horizontal MPLS paths between IP routers (which hereinafter may be referred to as “green” lines, links or paths) shown for example in FIG. 44, then any IP network failure forces a switchover between Dragons as well as switching paths. If we add further pairs of Dragons and associated MPLS paths then the failure would force them to switch also. Since one Dragon in each pair is linked to only one Dragon in each other pair there is an avalanche effect if one LSP link fails. The network requires that all upper Dragons or all lower Dragons be active. This seems clearly unacceptable so some IP crosslinks will be required to effectively decouple path and Dragon redundancy.

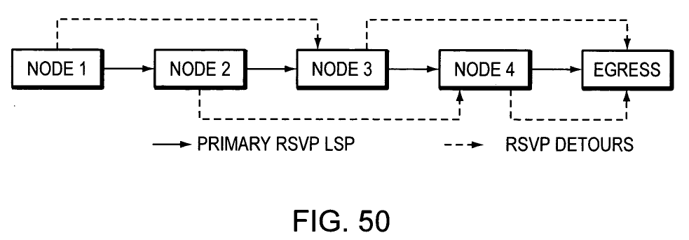

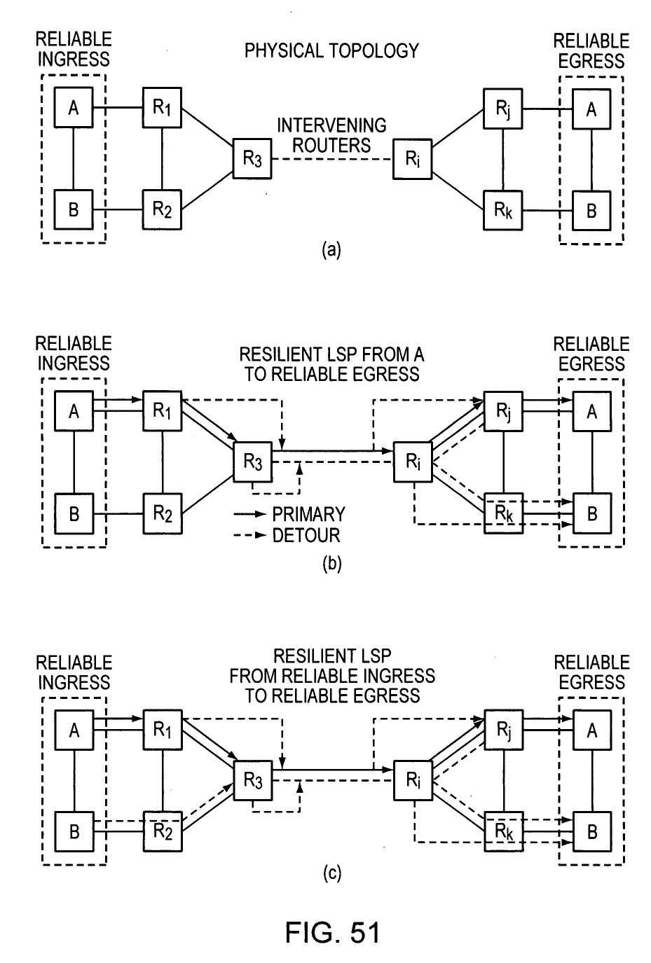

There are a number of embodiments in which the cross-links could be implemented. In FIG. 45, the dashed lines that cross between the left-hand pair of IP routers and the right-hand pair of IP routers (which hereinafter may be referred to as “blue” lines, links or crosslinks) indicate cross-linking via the IP network and the dashed lines that cross between the Dragons and the IP routers on both the left- and right-hand sides of each of FIGS. 50 and 51 (which hereinafter may be referred to as “red” lines, links or crosslinks) indicate local cross-links between the Dragon and router.

In one embodiment, the blue crosslinks avoid extra interfaces on the Dragon. A Dragon could direct its packets through the routers via one LSP or the other unless, of course, it terminates the LSPs. Also, forcing the network to support these additional wide area links may be more costly for an operator than providing local cross-links between the Dragons and routers.

In another embodiment, the red crosslinks are used. Then, the active Dragon decides which path to use simply by sending packets to one router or the other (or indeed both if we want 1+1 operation). As a result of this configuration, the Dragon may support two sets of IP links.

Failure Detection

There are a number of embodiments for LSP path failure detection. On embodiment is that the Dragon detects a loss of RTP packets when an LSP fails. This requires no extra overhead in the IP network and in may provide detection times proportional to the number of active calls on the LSP. Since each call typically expects a packet every 10 mSec, the failure detection time could be of the order of tens of milliseconds depending on how many lost packets constitute a failure. If there are more calls on a path and packet failures are aggregated detection could be even faster.

In this configuration, the packet loss information should be aggregated across all the calls using a common path and mechanisms avoid flooding the Dragon host processor with alarms when a link fails. This means that the frequency with which the DSP cores can generate packet loss reports is likely to be deliberately limited to avoid overloads.

Another embodiment runs a point to point APS style protocol between Dragons over all active and standby LSPs. This provides the benefit of continually checking that the standby path is available and allowing an easy association between the failure condition and consequent action. If the message for a path is lost a number of times then Dragon switches traffic to the standby path. It also means that LSPs are checked even when they are not carrying traffic.

This mechanism also provides a predictable detection time. These messages also add overhead which depends on the desired failure detection time and number of LSPs being monitored. If a packet is sent every 10 mSec, the additional overhead is equivalent to an extra speech channel per LSP. If these messages were sent between Dragons from network processor to network processor then failure detection and switchover may be quite rapid. An alternative embodiment originates these messages from a DSP core.

Another embodiment is that the node detecting failure of the LSP path provides OAM indications to the ends of the path.

Switchover and Standby Path Monitoring

Typically the defect is detected downstream of the failure and in the case of the 1:1 embodiment, a switchover message may be sent to the source end of the path. This message exchange occurs on the standby path to avoid being impaired by the failure condition.

The standby path is monitored so that any failures on it are detected. Both these objectives are achieved by exchanging messages periodically over the standby path. These messages meet similar constraints to those described above.

Tandem Resilience

Taking the various mechanisms discussed above, the various faults are handled as follows.

In one embodiment, the active Dragons exchange path status/APS messages over the LSPs. The traffic is flowing via the upper green LSP initially. Also, status messages may be sent every 10 mSec and use a timeout of 30 mSec.

In the case of an LSP failure on the active path anywhere in the network (Label 1) the active Dragon at B will timeout and indicate an ‘APS’ switchover request in its status messages on the affected path and its protection path. On receipt of this request the Dragon at A will switch all traffic for B to the other router link. Recovery of the path will be detected when status messages are restored over the original path. Traffic could be reverted or not as desired by the customer.

Failure of the B side router node (Label 2) or the link to the Dragon (Label 4) is detected in a similar way. In addition a fast failure indication from the physical layer of the link may be used to trigger the ‘APS’ protocol to request a switchover even more quickly.

Near end failures of the router (Label 3) or link (Label 6) may also be detected rapidly by the local physical layer. This would cause the Dragon to switch all its traffic to the lower router link and request a switchover on all its LSP status messages.

Any failures on the standby path (Labels 5, 7 and 8) will be detected by the LSP status messages and an alarm can be raised.

Overall this scheme provides a stable resilience scheme with minimal requirements on the IP network. In fact even the MPLS paths, as far as resilience is concerned, may be required to ensure consistent diverse routing of packets between active and standby routes. They may not be necessary if the network topology itself ensures this. This scheme may be adapted for access networks.

IP Crosslink Implementation

The following discusses three embodiments for implementing IP cross-links between Dragons for Gigabit Ethernet. This portion of the discussion briefly reviews these embodiments and proposes a preferred embodiment.

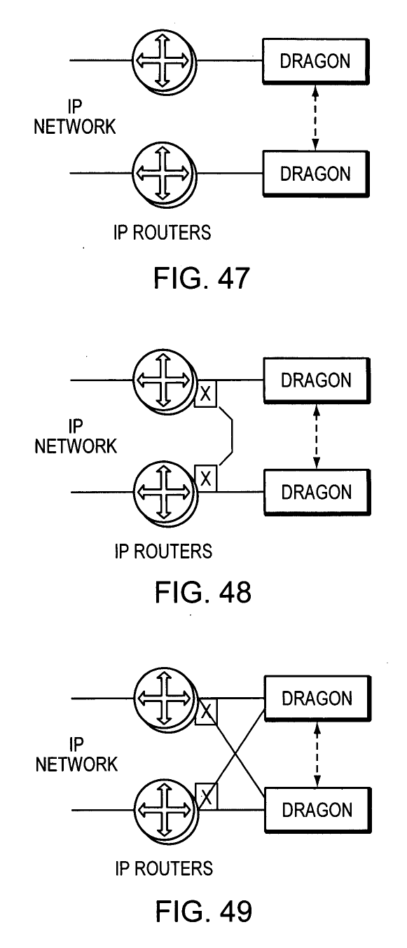

The first embodiment links the Dragons internally so that each Dragon connects to a single router. See FIG. 47. The advantages include: ability to control the traffic on the cross-links and reducing the bandwidth requirements by omitting or compressing parts of the IP header.

In this embodiment, the active MPLS paths from different end points may terminate on either the upper or lower router. In this case a failure of the inter-Dragon link may cause both Dragons to lose part of the incoming traffic. One way to correct this is to fail one on the Dragon to router links and thereby force a changeover of the active MPLS paths on the network side so that they all now terminate on the same router.

Another embodiment uses the bridging capability of the routers to bridge the incoming IP traffic to two ports. See FIG. 48. One port is connected to the Dragon and the other port connects to the corresponding bridge port on the second router. This is logically similar to the previous scenario but depends on links between routers rather than Dragons.

The advantages this embodiment provides are that it avoids the need for additional IP ports on the Dragon and is compatible with later integration in a router. It is also flexible in that changing the type of links used can vary the bandwidth provided between routers. Also a single set of links could be used where there are multiple Dragons on each router.

A failure of the cross-link may result in each Dragon only receiving part of the payload. In this case the routers would probably not see this as a problem since the traffic can reach the same IP address via either Dragon. However, to correct this, interaction with OSPF would show the IP address as unreachable via one of the Dragons.

Another embodiment uses the bridging capability of the router to bridge the IP traffic to two ports which are then connected to both Dragons. See FIG. 49.

The advantage in this case is that failure of any local link still means that one Dragon sees the full payload since one Dragon still has both links available. If the failed link connected to the active Dragon then we switch to the standby Dragon. This may require that the TDM side is also cross-linked so that the failure will not propagate back into the TDM network. Of course a router failure will still require traffic to be re-routed in the IP network. OSPF, LSP fast reroute or the mechanism described herein would all achieve this in varying times.

This approach may require extra IP ports on the Dragon. However it offers a robust solution from a reliability viewpoint.

### MPLS for Resiliency

MPLS is path-oriented and can potentially provide faster and more predictable protection and restoration capabilities in the face of topology changes than conventional hop by hop routed systems. In the Dragon application, the recovery time requirements mandate two key aspects of LSP resilience:
protection switching recovery mechanisms are used that pre-establish a recovery path or path segment, based upon network routing policies; when a fault is detected, the protected traffic is switched over to the pre-established recovery path.
autonomous local repair is used to recover only that part of the LSP that has failed such that the recovery is transparent to the LSP ingress and egress nodes. There are two reasons why local repair is required:
   propagating fault indications to the endpoints (via multiple nodes) may take a significant amount of time
   since the LSPs are inherently unidirectional there is no easy way to signal the fault back to the LSP source (as in traditional TDM schemes)

A proposed RSVP Detours scheme is outlined FIG. 50. The source sets up the LSP using RSVP-TE which is extended by the addition of two new parameters FAST_REROUTE and DETOUR. The FAST_REROUTE parameter is included in the PATH message originated by the sender and requests the intervening routers to establish a protected LSP. The routers do this by forming multiple RSVP Detours (using the new DETOUR parameter) such that every part of the primary LSP is protected by a detour as shown in the figure (obviously protection detours are only possible if the network topology provides alternate physical connectivity). For simplicity the individual detours are shown as direct links but the detour can transit any number of intervening nodes as dictated by the physical topology. The actual detours are calculated by the intervening routers using the existing routing protocols (e.g. OSPF) and are not visible to the endpoints of the LSP; the detour paths are created by the intervening routers using the RSVP PATH message (directed to the router where the detour merges back into the primary LSP) and the new DETOUR object. Just like all RSVP paths, the detours are refreshed by periodically resending the PATH message so adjusting to changes in topology. The scheme requires that adjacent nodes monitor the reachability of their immediate downstream neighbor (either via the data link or the RSVP_TE Hello extension); on detecting loss of reachability the node autonomously switches over to the local detour. The local repair is transparent to other nodes of the LSP including the ingress and egress. If a Detour is not available at a given node then the router is required to silently retry periodically and no error indication is generated. RSVP nodes that don't recognize the FAST_REROUTE object forward it unchanged. Consequently, the LSP is still established even if there are no alternative routes at some nodes or even if some nodes don't support fast reroute; the consequence, of course, is that parts of the LSP are not protected.

### Resilient MPLS in Dragon

Local, fast reroute of LSPs as described earlier effectively provides a protected or resilient LSP between a single ingress node and a single egress node. This resilient LSP provides protection against any single failure within the LSP with traffic disruption limited to the order of 10 s of milliseconds. Given that existing routing technology can inherently not meet the required failure recovery times, a desirable approach is to operate a resilient LSP end-to-end between Dragons. A reliable Dragon node can be formed from a pair of active/standby Dragons which each alone may be considered at least somewhat unreliable. In this context, the protection status active/standby refers only to the IP bearer traffic; it can be decoupled from other protection schemes such as TDM APS and Control/Management. This portion of the discussion demonstrates how to provide a resilient LSP between a reliable ingress node (supported by separate active/standby nodes) and a reliable egress node (supported by separate active/standby nodes). In this scheme protection with the required recovery times is provided against any single failure in the Dragons, their local links, the locally attached routers or the intervening routers. A single traffic flow is transmitted by the active ingress Dragon and will be delivered to the reliable egress node such that:
traffic from a particular ingress Dragon could arrive at either of the physical, unreliable Dragons depending on link availability
Traffic from different ingress Dragons could arrive at different physical, unreliable Dragons depending on link availability

This necessitates an IP crosslink, for incoming traffic only, between the two Dragons so that the total aggregate traffic stream can be delivered to both (i.e. each Dragon forwards traffic received from their attached routers to their peer Dragon. The implementation could decide to strip off unnecessary headers so that the required crosslink bandwidth could be significantly less than the external incoming bandwidth (a single Gigabit Ethernet link would be sufficient).

Establishing a Resilient LSP

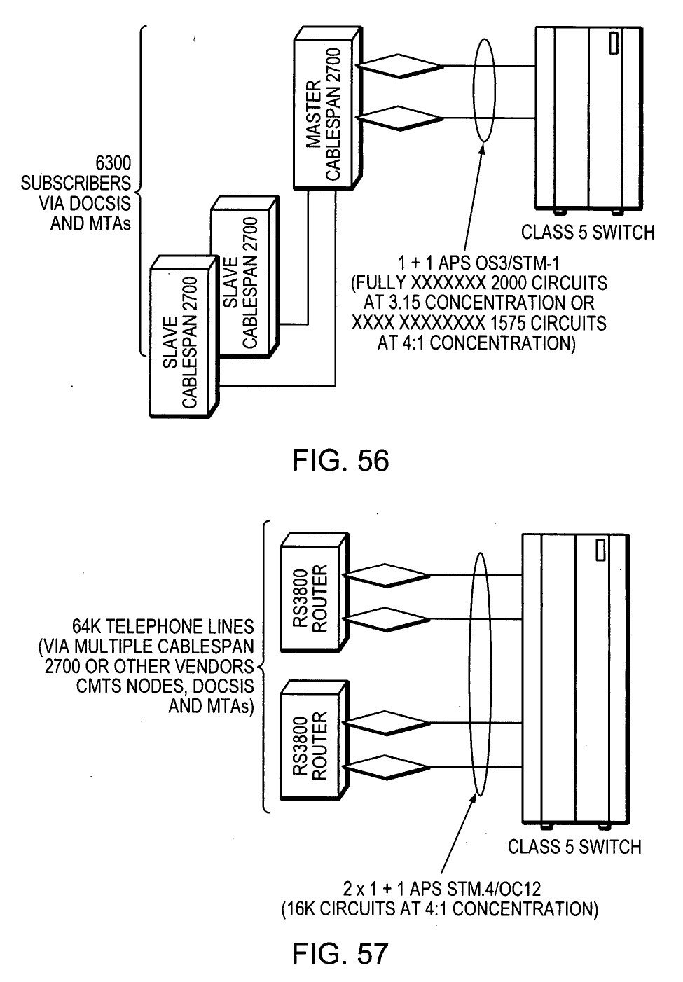

See FIGS. 56(a), (b) and (c).
Physical Topology: Reliable Ingress and Egress nodes are each formed from a pair of Dragons. Each reliable node has a single IP address so appearing as a single node to the routing protocols. The intervening routers between R₃ and Rᵢ are omitted from the illustration for simplicity and clarity purposes. R₂ is shown connected to R₃ for convenience but the only requirement is that there is general connectivity within the IP network so R₂ could connect to any intervening router. Similarly Rₖ is shown connected to Rᵢ but need only be connected to any intervening node. In this example, there is no direct link between R₁, R₂ and between Rⱼ, Rₖ; if such direct links were deployed then it would simplify the subsequent detours.
Resilient LSP from A to Reliable Egress: A requests this LSP via a PATH message referencing the single IP address of the Reliable Egress specifying a Record Route object so that it can determine the next router after its local router (in this case R₃). Final detours initiated by the routers at the end of the LSP terminate on different physical equipment from the primary LSP.
   The routers form the primary LSP and the necessary detours for protection. R₁ and R₃ both initiate detours to intervening routers; similarly a detour will terminate on Rⱼ.
   Router Rᵢ forms a detour to the Reliable Egress via Router Rₖ (since that is the only alternate route).
   Router Rⱼ forms a detour to protect the last link to the Reliable Egress via Rᵢ and Rₖ (since that is the only alternate route). If the physical topology had a direct link between Rⱼ and Rₖ then that would have been used rather that the router Rᵢ.
Resilient LSP from Reliable Ingress to Reliable Egress: Different physical ingress equipment can establish a detour into the primary LSP. In particular, ingress Dragon B sends a separate PATH message with the DETOUR object to R₃ (previously learnt by A from the Record Route object) via R₂.
   Fault Detection and Recovery

Each node in the LSP, including the ingress Dragon, is responsible for detecting a fault in its immediate downstream link, or immediate downstream router, and switching to the pre-established detour on failure. There are three options for fault detection by the ingress Dragon:
Hardware fault director: verifying the link via hardware would be the best option, since it involves the least software interaction.
Link fault detection: verifying the single link via a messaging scheme such as ICMP Ping would be the second best option since there is only one thing to monitor
LSP fault detection: using the RSVP-TE fast Hello mechanism is the least desirable option because the software monitoring load scales directly with the number of LSPs.
   Failure Modes

The initial condition is assumed to be that ingress Dragon A is active and transmitting on the primary LSP such that data arrives at egress Dragon A. Failure conditions are listed starting from the ingress side:
Failure of ingress Dragon A: this is detected (via internal mechanisms) by ingress Dragon B which becomes active and starts transmitting on the detour via R₂.
Failure of router R₁ or its input link: this is detected by ingress Dragon A which signals to B to become active (via internal mechanisms). B starts transmitting data via B's detour
Failure of R₃ or its input link: this is detected by R₁ which switches to its detour link.
Failure of any intervening router or link: this is detected and handled similarly to the R₃ case.
Failure of Rᵢ or its input link: this is detected by the upstream router which will use the detour terminating on Rⱼ.
Failure of Rⱼ or its input link: this is detected by Rᵢ which will switch to the detour via Rₖ; this is the first failure that will cause data to now arrive at egress Dragon B.
Failure of egress Dragon A or its input link: this is detected by Rⱼ which will switch traffic to the detour via Rₖ such that data now arrives at egress Dragon B.
Failure of the IP cross link in the egress Dragon: There are two deployment options to cove this scenario:
   Redundant Dragon IP crosslinks: these are protected via a suitable internal mechanism, the details of which are beyond the scope of this discussion. Consequently, in the absence of double failures the IP crosslink will never fail.
   Single Dragon IP crosslink: on failure the standby Dragon should cause its input link to fail (e.g. stop the fast Hello mechanism) such that the IP network will attempt to deliver all traffic to the active Dragon. In the absence of any other failure within the IP network this will be successful.
      Physical Topology Considerations

The foregoing relies on the final detour terminating on a different physical Dragon from the primary LSP (transparently to the routers). This requires that each Dragon is connected only to a single router via a single (logical) link.

The degree of resiliency (in terms of how many failures can be sustained before the bearer traffic is affected) obviously depends on the degree of physical redundancy. For example, in the previous example embodiment the router link on ingress Dragon A and the router link on egress Dragon B could both fail without any disruption (other than the switching time) to the bearer traffic.

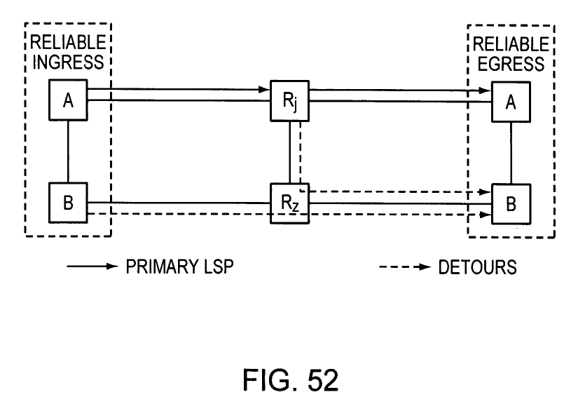

To provide the minimal level of resiliency (which is that bearer traffic is not affected by any single failure), every node in the LSP (including the reliable ingress Dragon) is configured to have one alternate route to some downstream node in the LSP (it doesn't have to be the next but one node). FIG. 52 demonstrates the scheme with a minimal topology.

The normal case uses the primary LSP from ingress A, through R₁ to egress A. Individual failure cases will cause a particular detour to be used such that traffic is still delivered after any single failure (note that traffic from ingress B can only ever reach egress B).

### Additional Detail Regarding Resiliency

One advantage the present invention provides is its resiliency strategy. Other advantages are cost/density and voice performance. One approach to providing resiliency in an IP network is implementing POS (Packet over SONET) links in a 1+1 APS configuration across two routers. Another approach to providing IP resiliency weaves in other elements of a total system-wide solution offering with other benefits (like distributed processing and a solution to the DSP capacity bottleneck).

Resiliency Comments

Several approaches to Dragon resiliency in IP networks are:

1. MPLS. This approach provides fast re-routes of LSP (Label-switched paths) but may not provide benefits for the ingress and egress paths to the LER (Label-edge router).

2. Mirroring. This approach is used in SANs and web server farms but may not operate at the IP level.

3. IP multicast. This approach may be prohibited by TGCP since the transmit and receive IP addresses need to equal and may not be if multicast is used. Also, multicast may not allow us to achieve true route redundancy.

4. Ethernet multicast and/or virtual MAC addresses in Dragon.

5. Bridging the two Dragons together on the two associated routers. This approach adds four additional GigE ports overall.

6. POS with 1+1 APS achieves what we want at the edge of the network.

Problems with IP networks (not counting POS), from Dragon perspective, the present invention addresses includes:

1. It is desirable to have fast fault detection, such as for example, detection times of 2-5 seconds. Many of the protocols and practices are built up on this philosophical base.

2. It is desirable to have fast fault recovery or rerouting typically. Fault recovery often requires a full, network-wide reconvergence of the routing protocol (e.g., OSPF). In order to avoid route flapping, damping timers are set up which enforce this.

MPLS

A key element of one embodiment of the present invention, discussed below, revolves around MPLS. The following are several key points:

1. MPLS permits LSPs to be set up between two MPLS nodes. These paths act to simplify routing decisions but have a side effect which is useful to us of tunneling traffic below the IP routing layer.

2. Generic traffic engineering has the concept of traffic tunnels, which are specific routes that carry traffic between two nodes. In the MPLS case, a traffic tunnel can span multiple LSP tunnels and several traffic tunnels can be carried in a single LSP tunnel.

RSVP-TE with tunnel extensions, hereafter described as RSVP-TE-TUNNEL, is a key element relied on in the embodiment disclosed herein. One of the important things it does is to allow hosts to be MPLS nodes. In other words, Dragons, if they implement RSVP-TE-TUNNEL, can terminate and originate LSPs. RSVP-TE-TUNNEL also includes a new fast hello scheme with default message intervals of 5 msecs.

Additional Detail Regarding Dragon Resiliency Approaches

First, the discussion herein may be applied to bearer traffic (RTP and RTCP packets). Second, this proposal has several different embodiments depending on the degree of resiliency the network operator is looking to achieve. In order to facilitate the discussion, I start with the embodiment that offers high resiliency to the customer. This embodiment may also makes great demands on the customer's network. Therefore, after the first embodiment is presented, other embodiments are discussed, such as those making lesser demands on the customer's network.

“Black-Belt” Approach

This embodiment offers a high amount of bearer resiliency protection to the customer and may be better than a full POS solution. It is called the “Black-Belt” solution. It also has some additional benefits that will be described at the end.

Black-Belt Network Diagram

The basic network configuration in this case is shown and described below. I've focused on the PacketCable application for simplicity. A similar drawing could apply for Application 4 with a Dragon instead of an MTA as the endpoint.

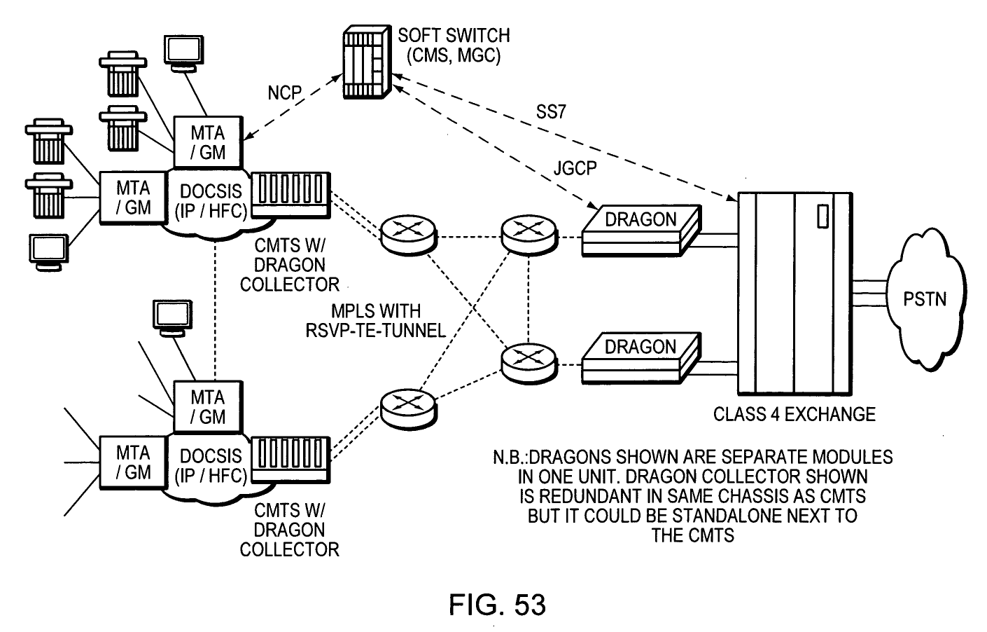

See FIG. 53. At the left of the figure is a pair of Dragons connecting through a pair of routers at the edge of an MPLS-routed network cloud. At the right side of the MPLS-routed network cloud is a new element, “Dragon Collector”. This element is defined later but feeds a CMTS that then connects to a set of MTA's. The key points about this network include:

1. RSVP-TE-TUNNEL is implemented between the Dragons and the adjacent routers and also between the Dragon Collectors and the adjacent routers.

2. All the routers are MPLS and RSVP-TE-TUNNEL enabled routers.

3. There is a separate explicitly routed LSP between each Dragon and Dragon Collector. In another embodiment, there is a fast-reroute option set up to protect each link in the LSP.

4. The new fast hello feature in RSVP-TE-TUNNEL is active between each neighboring set of MPLS nodes on the LSP paths between the Dragons and Dragon Collectors.

5. The 802.3ad mechanism is used to aggregate the 2 GigE links between the Dragon/Dragon Collectors and the associated routers.

6. Traffic multiplexing is done to minimize the header overhead on the LSPs. This may reduce total average traffic demand below 1 Gigabit.

7. Traffic is simultaneously sent and received on both LSPs. The master Dragon (Dragon Collector) is responsible for picking the optimal stream (or particular packet).

8. The Dragons in a pair are cross-coupled on the IP side so that packets received by one Dragon can be routed to the other. This particular aspect of Black-Belt may be avoided if TDM cross-links are implemented, although it may be required for other scenarios such as, for example, the Brown-Belt scenario described below.

Failures

Dragon Failure. If an individual Dragon fails, the other Dragon continues to broadcast its own traffic. The Dragon Collector at the remote end selects the active Dragon's traffic and full end-to-end connectivity remains.

Dragon/Router link failure. If a Dragon/Router link fails, the LSP traffic on that link is impaired or missing entirely. In this case, the Dragon picks the alternate LSP link for the traffic and full end-to-end connectivity remains.

On the router side, no traffic is routed on the LSP associated with the failed link unless fast reroute has been set up. In that case, the Dragon Collector sees a brief interruption in traffic on one of the LSPs until the reroute completes. However, in all cases, full end-to-end connectivity likely remains.

Router failure. As long as the explicit routes chosen (by the Dragons and Dragon Collectors) do not pass through a single router, full connectivity will remain and only one LSP will be affected. If fast reroute is enabled on the adjacent router nodes and the explicit route includes a single router, then traffic will be interrupted for only the fast reroute time.

MPLS Inter-router network link failure. In this case, because we have implemented separate explicit routes, only one LSP will be affected and no interruption is seen by the end users. If we did not use explicit routing or if the explicit routes contained a common link, the failure time will be limited to fast reroute times.

Dragon collector failure. This node is defined later on but contains active and standby units just like Dragon. A single Dragon Collector module failure leaves the other one active to send out the resulting traffic to the CMTS.

Benefits

Full resiliency. The main benefit of this resiliency scheme is that single points of failure, in most cases, involve no interruption in traffic at all. In some cases, a very short hit in traffic is taken on the order of a POS protection switch—certainly short enough to keep a voice call up. However, this scheme is much stronger than a single POS connection since it's fully end-to-end.

Better than OSPF. Another benefit of this scheme is that we get better information for QoS purposes than is available with OSPF. We are informed via RSVP-TE-TUNNEL of any path change and can take action if we wish to compensate for it. In addition, we can set policies ahead of time to enable rapid response to path changes (fast reroutes for example.) OSPF is much slower than this and reports stabilize when convergence happens (many seconds to minutes) and applies to a single autonomous system. RSVP-TE-TUNNEL on the other hand is potentially faster and applies on the full route, not just in one autonomous system.

Better allowance for burst packet loads. Since bandwidth compression is used between the Dragon and Dragon Collector, more headroom remains on each LSP to allow for bursts in traffic load that are common in packet networks. This is balanced, of course, against the additional bandwidth consumed by transmitting everything simultaneously on 2 LSP's.

Dragon collector enables easier implementation for distributed networks. An important side benefit of the resiliency proposal here comes from the Dragon Collector itself. We can deploy this (cheaper) unit across the network as feeder units to centralized Dragons to optimize total cost solution to a customer. Additional information on this topic comes later.

Dragon Collector

The below discussion defines the function of the Dragon Collector.

Dragon Collector (IP in and out). This is exactly like a Dragon with the following exceptions:

1. It is IP in and out. There are no TDM links.

2. There is no DSP processing per se.

3. There is no control link to a softswitch.

4. There is no processing of signaling.

5. The CMTS stream coming in is duplicated into 2 LSPs on output—one to each remote Dragon. It communicates with the remote Dragon to establish the paths over those same paths. It is, basically, like a broadcast unit.

6. It selects between the 2 LSP's to pick the traffic stream to send on to the CMTS. It picks the best one (one with the least errors).

7. Each Dragon Collector communicates with multiple Dragons so the above points apply to each pairing of Dragon and Dragon Collector.

8. The traffic between Dragon and Dragon Collector is ideally multiplexed to save bandwidth and to better allow for bursty traffic peaks. The scheme merges multiple packets into one to save on headers and/or uses header compression.

Dragon Collector (TDM to IP). This embodiment is a variant of the embodiment above and, like the Dragon Collector for IP in and out traffic, this one is a Dragon with some differences. The key differences are as follows:

1. The links between the Dragon Collector and the Dragon are similar to PWE3 links. The goal is to mimic the error performance of standard TDM links so that user performance stays the same with the Dragon remote as with the Dragon installed in the spot where the Dragon Collector appears. This means PCM sample-sized frames probably with forward-error-correction and even, perhaps, redundancies across packets. The scheme permits fax traffic to enjoy the same overall performance with T.38 at the Dragon (and this proprietary link between the Dragon and Dragon Collector) as it would have with T.38 implemented at the Dragon Collector.

2. Depending on the exact “PWE3” mechanism picked above, it may be necessary to detect and generate some signals in the Dragon Collector.

3. Echo cancellation is required.

“Brown-Belt” Approach

In this embodiment, everything is as in “Black-Belt” but there is no Dragon Collector.

Brown-Belt Network Diagram

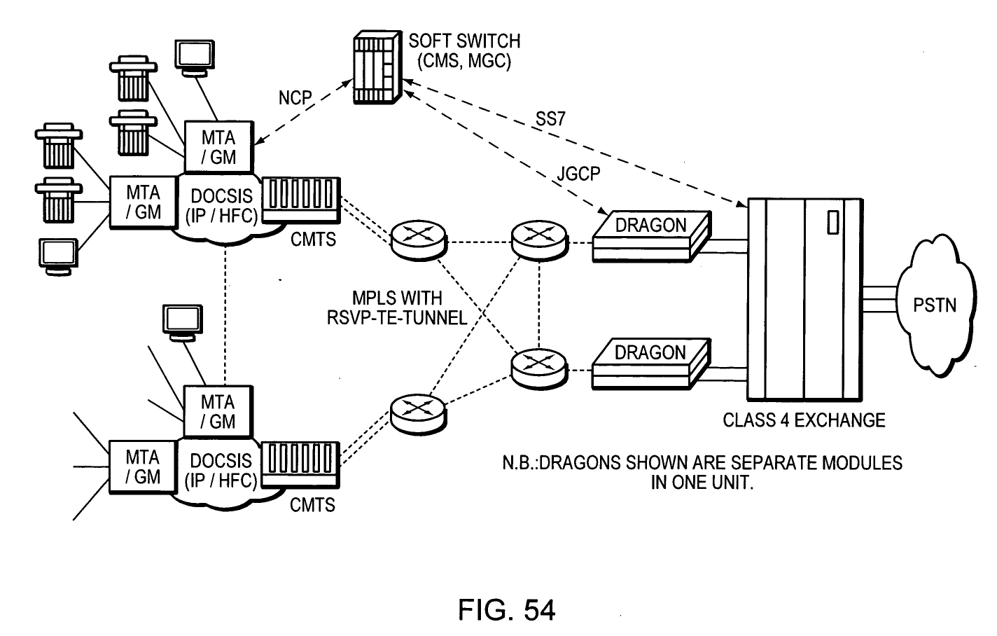

This embodiment is just like Black-Belt except that no Dragon Collector function exists. See FIG. 54. The key differences from the Black-Belt embodiment above are as follows.

1. Traffic is sent on one LSP at a time. Fast reroute is enabled and establishes the second LSP as a backup for the first.

2. There is no Dragon Collector function so the LER at the edge of the inter-router MPLS cloud connects straight to the CMTS. Since the CMTS is a single point of failure here, the LER may not have to be duplicated either. If it is, the VRRP mechanism is to be used at that end.

3. The inter-Dragon IP links are elements of the embodiment. We cannot ensure that the originating LER (next to the CMTS) will send all traffic down one LSP and so the Dragon assumes a mixture of incoming traffic across the LSPs. Notwithstanding the above, since one can set up one LSP as backup for another, to the extent that a policy can be set up to route all traffic to a given IP address down a particular LSP, IP cross-links may not be required for this case either.

Failures

The analysis here is a bit more complicated than the one for “Black-Belt” but is still pretty straight-forward.

Dragon Failure. If an individual Dragon fails, the mated Dragon assumes responsibility. The associated LER, using fast reroute, switches all traffic to the “standby” LSP

Dragon/Router link failure. If a Dragon/Router link fails, the LSP traffic on that link is impaired or missing entirely. In this case, the Dragon gets all traffic from the alternate LSP link for the traffic and full end-to-end connectivity remains.

Router failure. Fast reroute can be set up to route around router failures as well. The fast hello feature in RSVP-TE-TUNNEL can help to ensure that this failure is detected quickly.

MPLS Inter-router network link failure. As above, fast reroute can be set up to route around router failures as well. The fast hello feature in RSVP-TE-TUNNEL helps to ensure that this failure is detected quickly.

Benefits

Full resiliency. Using the fast reroute and the RSVP-TE-TUNNEL hello scheme, failure detection and response are both quick, enabling voice calls to stay up despite a single failure of either Dragon or router or link.

Better than OSPF. As with Black-Belt, RSVP-TE-TUNNEL gives better information about the network for our purposes than OSPF.

Additional Detail Regarding Centralized Access Application

It can be that when Dragons are only at one side of the IP network, the use of the ‘APS’ messages to monitor the paths and initiate switchovers is prevented. The only generally available mechanisms are based on RTP traffic loss or RTCP reports.

Loss Detection Interfaces

RTP packet loss may be used to detect failures from the access network to Dragon quite quickly.

RTCP reports can tell us if traffic is being lost between the MTAs and Dragon. Typically RTCP reports are generated every 5 Seconds for each call in our bidirectional call environment. Therefore failure of a CMTS carrying 100 calls may require a number of 50 mSec periods to detect. If the CMTS fails in both directions then it would be detected by RTP failure. If only the downstream direction failed, RTCP reports indicating packet losses may be needed to detect failure. If there were fewer active calls then detection times would be longer.

Another embodiment uses the ICMP ping messages to monitor the state of the links to the access router. This gives predictable detection times but the maximum rate of sending pings may be limited by the loading on the router.

Another embodiment uses a single looped back RTP stream to monitor each MPLS path. This allows quite fast detection at modest cost.

### Switchover Embodiments

In the direction towards the access network the Dragon redirects its traffic through the alternate router if it detects a failure. This is effective where the failure is between the Dragon and the access router. This favors a ping or loopback mechanism which may be triggered by failures that can be repaired. It may not be desirable to trigger switchovers in response to local MTA or unprotected CMTS based failures.

In the direction from the access network towards the Dragon there are several ways to tell the access router to switch traffic to another path. For example, standard OSPF mechanisms and emerging MPLS fast reroute mechanisms may be used.

In one embodiment, a way to get fast from the access network towards the Dragon, other than MPLS is to use some form of multicast or bridging. TGCP may not allow multicasting (although MGCP may allow the use of multicast addresses). Bridging may cause both voice and data traffic to be bridged towards the core routers. The embodiment ensures that the voice traffic is picked up and forwarded by both routers whereas only one router should forward the normal data traffic.

In another embodiment, remote bridging offers an alternative to IP multicast for access traffic.

Synchronisation

Synchronisation Interfaces

The method of providing synchronisation input to the Dragon can vary depending on the network and application into which it is being deployed. For full flexibility, the Dragon supports each of the following options as synchronisation input: Line Timing—from a single selected Dragon TDM interface; and External Timing Reference via either a Framed DS1 interface (BITS) or 2 MHz G.703 Part 13 interface, depending on the geographical deployment (note that external timing references may be sourced from the host system).

The Dragon supports a user definable hierarchy for the selection of synchronisation source between external references and individual TDM interfaces. In addition, the Dragon supports the distribution of synchronisation via Framed DS1 (BITS) or 2 MHz G.703 Part 13 interface outputs, though as with the external timing reference inputs these may be achieved via the host system. Such outputs allow for synchronisation distribution such that other distinct VoIP components may be locked to the same clock as the Dragon.

Internal Synchronisation

Because requirements on internal synchronisation (including hold-over) can vary depending on exactly where in the network the Dragon is being deployed (e.g. requirements are more stringent for core network elements than for access network elements), the Dragon conforms to the most stringent of such requirements so as to provide the greatest application flexibility for a given Dragon device.

Each Dragon module has an internal clock of accuracy that at least conforms to SDH SEC standards as defined in ETS 300 462 part 5 and SONET Stratum 3 standards defined in T1.101 and GR-1244.

Telco Quality

System Availability

Ideally, the Dragon module supports configurations of multiple modules whereby no single point of failure (hardware or software) will cause an interruption to the overall service of the application in which the Dragon module is deployed. Note that if Dragon modules are deployed into a single host then the host itself may include single points of failure.

System Integrity

System Integrity is the set of capabilities that ensure the availability requirements of applications in which the Dragon is deployed. The Dragon supports the following core capabilities in order to ensure the availability outlined above: Trouble Detection and Reporting; Audits; diagnostics and Repair; Recovery; and Trouble Prevention.

With respect to trouble detection and reporting, the capability to detect failures (both those within the Dragon itself and those associated with its external interfaces) and report them via the management interface defined below. All failure reports (where appropriate, understanding that standard SNMP MIBS could be used that do not support sequence numbering of traps) include the time and date that the failure was detected and a unique sequence number (to enable fault synchronisation at a management system). Note that where the management interface is significantly integrated with that of the host system then it may be unrealistic to expect the host system to support a reliable reporting mechanism as described above.

With respect to audits, the ability to perform functions on an ongoing basis to assess the system health, sanity or operational integrity. In particular this refers to the ability to periodically audit the state of connections within the Dragon (either initiated by the Dragon itself or by a SoftSwitch) in order to ensure that actual connections and perceived connection maps are consistent.

With respect to diagnostics and repair, the capability to isolate root causes of hardware failure via (automatic and on demand) diagnostics, and to identify the necessary repair of such hardware failures.

With respect to recovery, the hardware and software design of the Dragon minimizes the possibility of service affecting troubles arising and degradation of service while action is being taken to identify the cause of troubles (e.g. 1:1, 1:N redundancy schemes between multiple Dragon modules, etc.). General Recovery requirements may be found in GR-474. Various redundancy schemes are discussed herein.

With respect to trouble prevention, the hardware and software design of the Dragon minimizes the possibility of the introduction of trouble conditions into the system, either via human error, database corruption or other (unexpected) occurrence.

Software Upgrade

The Dragon supports the ability to have new software images distributed to individual Dragon modules. The Dragon supports upgrade between software loads either as a set of modules, or individually on identified modules, without overall interruption to service. The intention is that it is permissible to take a single module out of service for the purposes of upgrade, but that it is possible to protect the service offered by that module form another (set of) module(s) in the same protection scheme. It is recognised that in deployments where only a single module comprises the Dragon, then hitless upgrade is not possible. In addition, the Dragon allows for a period (trial period) during software upgrade, where the new software is being executed but from which it is possible to revert to the previous software load without overall interruption to service.

All Software upgrade activities are possible under control from a location remote from the components being upgraded.

If and when two modules are running different versions of software, these modules need to be kept in sync with each other. If the format or content of the data has changed, then some adaptation of the data is required so that it can be understood by the other version of software.

Any redundancy scheme typically requires a synchronization phase, which gets the two modules in sync initially (e.g. after powering up the standby); this involves sending lots of data from the active to the standby. Thereafter, depending on whether an active (event) replication scheme is used or a passive (data) replication scheme, smaller amounts of data may need to be replicated on an ongoing basis.

Software loads for the Dragon can include a “version adapter”, a software component which is capable of taking in a data stream and, if such data stream was generated by a different version of software, the stream is converted/adapted (for example, using XML or a simpler variant thereof) into a form expected by the current version of software. By understanding the type of the data in the stream, the adapter decides to pass it on unchanged, or to discard it, modify it, or provide a default value (for data which is “missing” from the incoming stream). This version adapter can be introduced into the path of the data as it is synchronised/replicated from one module to another.

Time of Day Synchronisation.

The Dragon is normally responsible for time-stamping any data it offloads to external systems (e.g. PM counts, Alarm reports), and thus it supports a synchronised real time clock.

The Dragon also derives time from a real time clock (such, for example, in each Dragon module or as an external clock). This supports the ability to be synchronised from a central source using the NTP protocol.

Note that for specific host systems it may be that alarms and PM data are reported via the hosts management interface, in which case the responsibility for time stamping such data and maintaining real time clock synchronisation can fall on the host itself.

Mechanics

The Dragon conforms to the standard mechanics of the chosen host system, while maximizing flexibility for various deployment applications.

Environmental

The Dragon module conforms with any module level requirements from the relevant environmental and safety standards, including without limitation: EMC, including EN 300 382-6 (v.1.1.3), CISPR 22 Class A, FCC Part 15 Class A, and GR-1089 Issue 2; Environmental, including ETS 300 019 (Storage Class 1.3, Transportation Class 2.3, In Use Class 3.2), NEBS Level 3 (GR-63, GR-1089); and Product Safety, including EN 60950 3rd Edition/IEC 60950 3rd Edition, EN 60825/EEC 825 Laser Safety (Class 1), and UL 1950/CSA 22.2-No. 950.

Visual Indicators

The Dragon supports a set of visual indicators (LEDs) that provide information about the status of particular functions within the server (e.g. power presence, active/standby status, software upgrade in progress etc.)

Operational Management Interface

The Dragon supports an operational management interface to provide remote access to configuration and fault management capabilities (see 0 and 0). This interface can, for example, comprise one or more of the following: SNMP (V2.0, V3.0) Agent; Embedded Java GUI (via Java agent); Embedded HTML GUI (via HTTP agent); and Command Line Interface (CLI).

The CLI interface allows for critical maintenance activity such as providing the basic trouble shooting (e.g. management/control interface status) and configuration capabilities (e.g. IP address configuration, security options enabling/disabling) necessary to establish communications between it and other elements (e.g. SoftSwitch) of the overall application.

It is possible to gain access to the management interface from remote terminals with standard operating systems (UNIX, Windows).

### Management Architecture

In general resilience interacts with element management in two main ways. In the first place the management solution handles the resilience aspects itself (e.g. setting up protection groups, configuring redundant Dragons consistently etc.). In the second place the management solution has sufficient resilience to cope with its own failures.

Some basic resilience embodiments of the management architecture are presented here. However the embodiments are impacted by the architecture of the host system and the EMS solution.

Where Dragons are configured as a redundant pair it is important to ensure that any configuration changes are consistent across both cards. This may mean either setting both to have the same value (e.g. which E1s are on a specific V5 interface) or to complementary values (e.g. one active and the other standby). In either case the management architecture considers how to achieve consistency where the Dragons can be physically located in different routers and have no overall ‘controller’. For example, it is unrealistic to require that an operator input two identical sets of commands via the CLI for two separate Dragons.

Additionally in load sharing configurations it may be necessary for the active Dragon to manage more than two Dragons. The limitation on the number of Dragons which can be managed may be imposed by processing capacity, memory or storage (particularly if flash disks local to the Dragon were used).

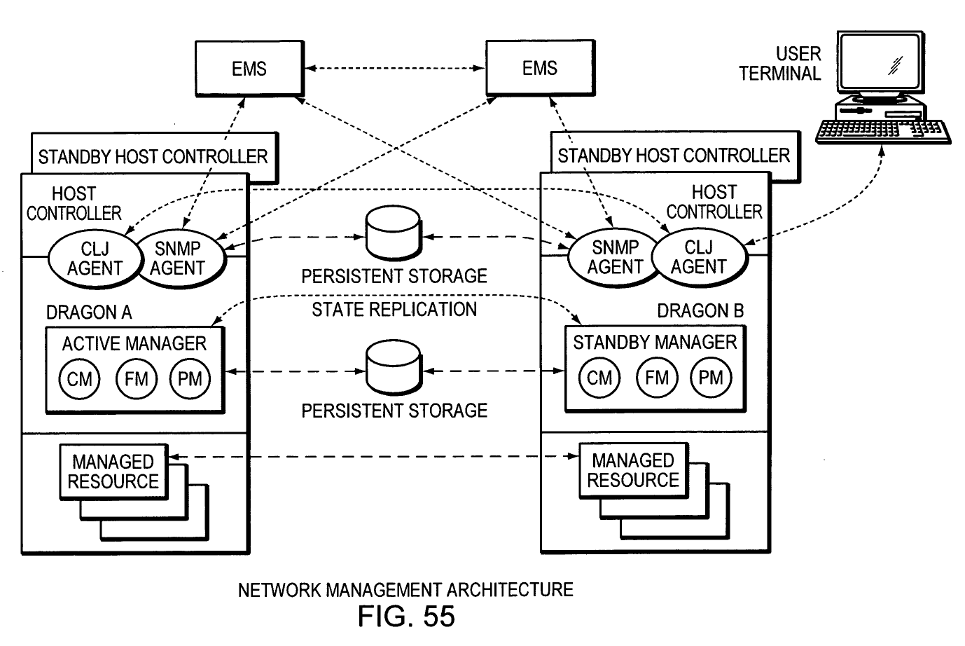

A typical scenario for a pair of Dragons providing a redundant solution is shown in FIG. 55. The Dragons are assumed to be located in different host routers and may either be managed directly from the command line interface (CLI) or via an EMS. The EMS may be redundant.

A number of interactions can be seen between Dragons. The active manager function will have access to the managed resources on both Dragons as shown by the dashed lines near the bottom of FIG. 55. The active manager function will also have links to the standby manager function to ensure that it has valid state information.

The user terminal could potentially be connected to either Dragon. Therefore the CLI agent on the standby Dragon should interact with the active manager function rather than discarding user commands.

Persistent storage will be required for configuration parameters, alarm logs and similar data. This storage could be implemented at a number of levels. Where the agent is on the host system it could be possible to utilise the persistent storage mechanisms provided by the host. This would be invisible to the Dragon itself. However there is a problem when Dragons are in separate routers. In this case the agents are running on separate host processors, each of which may not see all the configuration commands received by the Dragons. This means that the persistent storage implemented by the CLI or SNMP agents will not be able to store the complete configuration.

An embodiment of the present invention solves the problem by managing the persistent storage from the active Dragon manager function. Alternatively another embodiment uses an NFS mounted file systems accessed via IP. Use of an independent persistent storage device, which is accessible to both Dragons, has the advantage of being readily available for a replacement Dragon without needing to copy all configuration information from the active Dragon to the new standby Dragon.

Obviously the EMS configuration depends on the application and cannot be dictated by a Dragon. However two embodiments could be used to allow a Dragon to interact with a redundant or non-redundant EMS. In general a Dragon will either be responding to commands or autonomously reporting events. Command responses should be returned to the source address for those commands. It should be possible to configure a small number of IP addresses to which a Dragon will send autonomous event reports. It may also be desirable to have the concept of a notified entity for a Dragon, this is similar to the operation of an MTA.

There are two embodiments of the Dragon management agent. In the first embodiment, the management agent appears as a single entity to the EMS. In the second embodiment, the EMS is aware of the two Dragon agent functions and which is active. In the first embodiment, the Dragon agent uses either a multicast or a “virtual” IP address. The choice will also be influenced by the host router implementation.

Configuration Management

The Dragon supports the capability for all behavioural affecting internal data to be set, changed and deleted via the management interface as defined in 0. The Dragon performs consistency checks on any request to change such data before applying the requested changes.

The Dragon provides the ability for a check point of its configuration data to be taken via the management interface, as well as the capability to accept a download of, and synchronise to, a new set of configuration data.

Accounting Management

The Dragon is capable of reporting individual (call related) events to external servers, typically the SoftSwitch (using MGCP), so that such information may be correlated into call detail records.

Performance Management

The Dragon collects performance statistics from its various functions and store them for later retrieval by an external system (either via file transfer or via the management interface as defined in 0) Such statistics are recorded at regular intervals (5 minute, 15 minute, 30 minute (longer intervals measurements, such as for example one hour or 24 hours, may be collated from smaller interval measurements by an external system) depending on the measurement itself) and, wherever applicable, are derived from relevant standards documents.

The Dragon is capable of writing all statistics information to storage such that it may be retained for a period of not less than 24 hours; such storage may be offered via some external server.

Statistics can, for example, include the following areas (standards references included where appropriate): Call Processing (e.g. number of completed calls, unanswered calls, etc.)—Note Call Processing statistics are the domain of an MGC function in all applications; Transport Interfaces (G.784; EN 300 417-7; GR-253-CORE); VoIP Performance (e.g. packet counts, lost packets etc.); Control Interface performance (MGCP, NCS etc.); and Signalling Interface Performance (SCTP, V5, GR-303 etc.) (Q.752).

Security Management

Security for Interfaces

The Dragon provides proactive measures, for all control, management and data interfaces, over the packet network, to: protect end user confidentiality and prevent fraud by assuring secure transmission and service provision; protect maintenance and control elements by multi-level user access control, user authentication, role authorisation; and take active measures to detect and repair internal and external service denial attacks, intentional and unintentional.

A level of security is provided for all control/management interfaces to guard against interference (either deliberate or accidental) with the operation of the Dragon from external parties. This security may be realised using a number of mechanisms as agreed with the deploying operator: Provision of physically separate data interfaces to the IP network(s); Allows a physically separate DCN to be connected for internal interfaces, which is more pertinent to the host system than the Dragon module itself—the maximum configuration is two (for resilience) physical interfaces for each of management, control (i.e. MGCP and profiles) and data (VoIP RTP); Provision of distinct IP addresses for each internal interface—while not allowing security itself, this provides the ability to provision secure VPNs across the data network; Support for IP encryption protocols (specifically the encryption protocols defined further below); and Support for authentication based on source IP address (specifically the authentication defined further below).

Wiretap Capabilities

Wiretap (the ability to copy call content data to more than one output stream) is generally required as part of general Law Enforcement (CALEA/Lawful Intercept) capabilities.

The Dragon supports wiretap capabilities (under the control of a SoftSwitch) to provide copied (both way) call data paths to: a specified TDM circuit; or a RTP VoIP stream to a specified destination.

Test Capabilities

The Dragon provides various test capabilities, as necessary or desired for the anticipated range of device applications.

Test Calls

This feature of the Dragon allows the operator to establish test calls to or from a Dragon to flex its signalling interfaces and test the data integrity of its transport interfaces.

The Dragon supports the ability to originate, terminate or transit test calls under control of a SoftSwitch or management system.

Included in this feature is the ability of the Dragon to interwork with specific test equipment for the purposes of supporting test calls. While the requirements for such interworking may vary between operators and national networks, the following minimum Bellcore/Telcordia specified Test Line types ideally are supported by the Dragon: Types 100, 102, 105, 108, 109 (all defined in section 8.5.2.1 of SR-2275).

Voice Path Assurance

This feature defines mechanisms for ensuring the integrity of voice paths across the IP and TDM networks, both as part of call set up and during calls.

The following Voice Path Assurance (VPA) mechanisms are provided by the Dragon: SS7 COT; and In Call Packet Network VPA.

With respect to SS7 COT, The Dragon supports the Continuity Check capabilities defined in Q.764 and GR-246 both in a sending and reception mode. Continuity check capabilities may be invoked on a per call basis (under instruction from the SoftSwitch) and as part of a manual maintenance process on circuits not currently involved in calls. Such Continuity check procedures are exercisable on both TDM circuits connecting the Dragon to TDM exchanges and across the packet network (between Dragons).

With respect to In Call Packet Network VPA, The Dragon provides mechanisms for continuously checking the integrity of voice paths across the IP network for the duration of the establishment of such voice paths. This includes the capability of providing recent statistics on the voice path integrity (potentially as part of call trace or traffic/performance monitoring data), and the reporting of such data to the SoftSwitch for use in future routing decisions. Such VPA mechanisms ideally are operable between pairs of Dragons

Call and Path Trace

The Dragon provides the ability to report the components that are involved in a particular call (DS0 identity, DSP resource etc.) as source input to a higher level Call Trace function (initiated via management or control interface).

Additionally, the Dragon provides the ability to participate in a “path trace function” whereby a test VoIP packet is sent through the IP network and its progress through the Dragon (is tracked). It is assumed that the participation of the Dragon in such a function is the initiation of the test packet, the termination/reception of the test packet and the reporting of these events.

Other Test Capabilities

The Dragon provides the capability for Digital Test Access as defined in Bellcore GR-818-CORE and other relevant standards (i.e. no direct metallic test access port is required). In addition the Dragon provides capability to perform a loop-back of an E1, DS1 or full SONET/SDH Path on its TDM interfaces.

Feature Restrictions

The Dragon includes a mechanism to enable and disable functionality on a per unit basis such that such certain functionality can be, for example, distributed or otherwise enabled or disabled on a case-by-case basis, if desired and as appropriate. Such restrictions could apply to functionalities that may include for example TDM circuit density counts.

Conference Capabilities

Three party calling has been identified as a key Class 5 service, and thus the Dragon supports such services. The Dragon supports the ability to add parties to an existing two party call (under SoftSwitch control) and to aggregate the voice signals such that each end point receives the aggregated signal from all other end points involved in the conference bridge. The Dragon supports two distinct versions of this capability: Three Party Bridge, whereby a single additional party may be added to (and subsequently removed from) an existing two party call; and Multi Party Bridge, whereby any number of additional parties may be added to (and subsequently removed from) existing two party calls.

In the Dragon, there is no restriction on the direction of the connection for each party within a conferenced call.

### Example Possible PacketCable Application Features

This portion of the discussion defines various features which may be more specific to the PacketCable application for a Dragon device. This notwithstanding, many features listed in this portion of the discussion may also be applicable to other applications outside the scope of PacketCable.

This portion of the discussion is divided into those features applicable to each of the application capabilities defined above, i.e.: V5/GR-303 Dragon for PacketCable; Local Exchange Dragon for PacketCable; Local Exchange Dragon for Legacy HFC Networks (this application is not actually defined within PacketCable standards).

V5/GR-303 Telephony Server for PacketCable

Typical Bandwidth Allocations

As described above, the Dragon modules can be deployed, by way of example only, directly in the a CMTS system (low-end system) or in a centralized router (high-end system). Each case is considered separately below, furthermore for the low-end system two cases are considered.

For the low end system, as described above, with 1×6 CMTS modules consider a configuration of three co-located CableSpan 2700 systems, two (slave systems) are fully populated with 10 CMTS modules (in two 1:4 protection groups), 2 multi-interface data cards (typically 16×100BaseT each), 2 controller modules and 2 synchronisation modules. The third (master system) 2700 consists of just 6 CMTS modules (in a 1:5 protection group) and the four remaining slots house 2 Dragons. The OC3 Dragon occupies two slots in the Tellabs 2700 chassis. Each slave system is connected to the master system via multiple 100BaseT interfaces and all three systems also provide connectivity (direct or indirect) to ISPs.

In such a configuration (assuming 75% usage of RF bandwidth) the 21 active CMTS modules would serve about 6,300 Telephony subscribers, thus requiring 1,575 DS0s of TDM connectivity to the Class 5 switch via the Dragon. This would be provided via a redundant OC3/STM-1 optical interface across the two modules and is depicted in FIG. 56. FIG. 56 illustrates a lower-end V5/GR303 Dragon with 1×6 CMTS modules (6,300 lines). The excess capacity in the OC3/STM-1 interface may be used to provide improved Grade of Service (lower concentration ratio) or for future growth options.

This system would be served by multiple V5/GR-303 interfaces.

For a low end system with next generation (5×20) CMTS modules then a single Tellabs 2700 configured in the same way as the master system in FIG. 56 (i.e. with 5 active CMTS modules) or even in a more reliable configuration (with the 6 CMTS modules in two 1:2 protection groups—providing 4 active CMTS modules) could be deployed to serve the same subscriber base of 6,300. In this case the Dragon configuration is identical to that described above, the difference being that there are no slave Tellabs 2700 systems being served.

For an example high end system serving up to 64,000 telephone lines then all V5/GR-303 interfaces would be served by Dragons in a centralised location, deployed for example in two routers for reliability. In this scenario the STM-4/OC12 modules available in router could be deployed. The 64,000 subscribers would require 16,000 DS0s TDM connectivity to the Class 5 switch which can be provided by deploying two Dragons in each router (giving eight 1+1 APS STM-1/OC3 or two 1+1 APS STM4/OC-12). The other slots in the router can be used for high speed interfaces for connecting to ISPs and the served CMTS systems. This is shown in FIG. 57. FIG. 57 illustrates a higher-end V5/GR303 Dragon (40,000 lines).

Note that interface and equipment redundancy schemes are defined in 0 and 0, respectively.

NCS—Controller

In order to control the PacketCable MTA/CM the Dragon supports the Network Call Signalling (NCS) as defined in PKT-TSP-EC-MGCP-102-991201 (a PacketCable profile of MGCP) as a controller.

Note that in a distributed (multi-module) deployment it may be necessary for a controlling Dragon module to control a client Dragon module using some profile of MGCP; although this is viewed as a purely internal interface. In such instances the Dragon module supports MGCP as a gateway.

V5.2_{AN} Interface

When deployed in an ETSI based network the Dragon communicates with the designated local exchange using the V5.2 protocol, acting as the Access Network side of that interface, including termination of the Q.921 data link and support of the following Layer 3 Protocols: PSTN Protocol (including National Variants); Control Protocol; Link Control Protocol; BCC Protocol; and Protection Protocol.

The specific national variants of the PSTN Protocol listed below are supported. Example V5.2 PSTN National Variants: Netherlands; France; Norway; Japan; Austria; and El Salvador.

The Dragon supports up to three distinct V5 interfaces per 500 TDM circuits being supported. This requirement is driven by the Nortel DMS limitation of “small” V5 groups consisting of 672 L3addrs; applying a concentration ratio of 4:1 this would equate to 3 groups per 500 circuits. V5 interfaces may be split across multiple Dragon modules.

GR-303_{RDT} Interface

When deployed in an ANSI based network, the Dragon communicates with the designated local exchange using the GR-303 protocol, acting as the Remote Digital Terminal side of that interface (as defined in GR-303-CORE, GR-303-IMD and GR-303-ILR-IDLC). This includes termination of the Q.921 data links for the Embedded Operations Channel (EOC) and Timeslot Management Channel (TMC), and their respective protocols. Channel associated robbed bit signalling are used for call control purposes.

The Dragon supports up to three distinct GR-303 interfaces per 500 TDM circuits being supported. This requirement is derived from the equivalent V5.2 requirement. GR-303 interfaces may be split across multiple Dragon modules.

Call Control Signal Interworking

The Dragon provides for interworking between the NCS protocol defined above and either V5.2 (above) or GR-303 (above) as appropriate. Interworking may involve use of RTP Event Relay handling as defined above, and may further involve variants (for V5) depending on the National variant of the V5 PSTN protocol being supported.

By virtue of supporting a V5.2 or GR-303 interface the Dragon should not prevent the delivery of standard Class 5 services. These Class 5 services include, for example: hook-flash; ringing suppression; E911 calls; Call waiting; caller ID; fax/modem calls; on-hook data transmission; and telemetry transport.

PacketCable Dynamic Quality of Service (DQOS)

The Dragon supports the PacketCable Dynamic Quality of Service (DQoS), as defined in PKT-SP-DQOS-102-000818, in order to negotiate and set QoS parameters with the CMTS system as part of call/connection set-up.

Security Management

This detailed description defines some generic security mechanisms for control, management and data interfaces. PKT-SP-SEC-102-001229 defines further more specific requirements on such security mechanisms that include methods of encryption and key distribution for each of the following interfaces: NCS Control; TGCP Control; DQOS Control; RTCP Control; and RTP Data. Note the TGCP interface is not required for the V5/GR-3030 Dragon capability.

The Dragon supports each of the above security specifications from PKT-SP-SEC-102-001229 (with the exception of that for the TGCP Control interface) when deployed in a V5/GR303 application.

Security mechanisms may only be disabled and enabled via the critical maintenance interface.

Interoperability with Non-PacketCable Compliant Components

While the PacketCable architecture and specifications attempt to define a set of protocols and capabilities such that all elements (MTAs, SoftSwitches, CMTS systems etc.) may interwork with each other, it should be recognized that, at least in the short to medium term, there will be a number of such elements available on the market that may not fully comply with PacketCable specifications. This may be true in areas such as NCS/TGCP compliance, Security support, DQoS support etc.

The Dragon incorporates mechanisms that allow, as far as possible, for a configuration that interworks with components that do not necessarily conform totally with PacketCable specifications; these may include mechanisms such as the ability to disable security on specific interfaces, the ability to disable DQoS requests, the ability to manually configure IP addresses of MTAs that do not support NCS domain naming conventions etc.

Local Exchange Dragon for PacketCable

Note that as the Dragon only handles trunk side calls in this application there are no specific requirements on it to provide support for Class 5 type services.

Typical Bandwidth Allocations

For the Local Exchange application it makes sense to deploy a high-end system (i.e. Dragons deployed in a centralized router). However low-end configurations are possible and can be deployed in a manner similar to that shown for low-end V5/GR303 configurations.

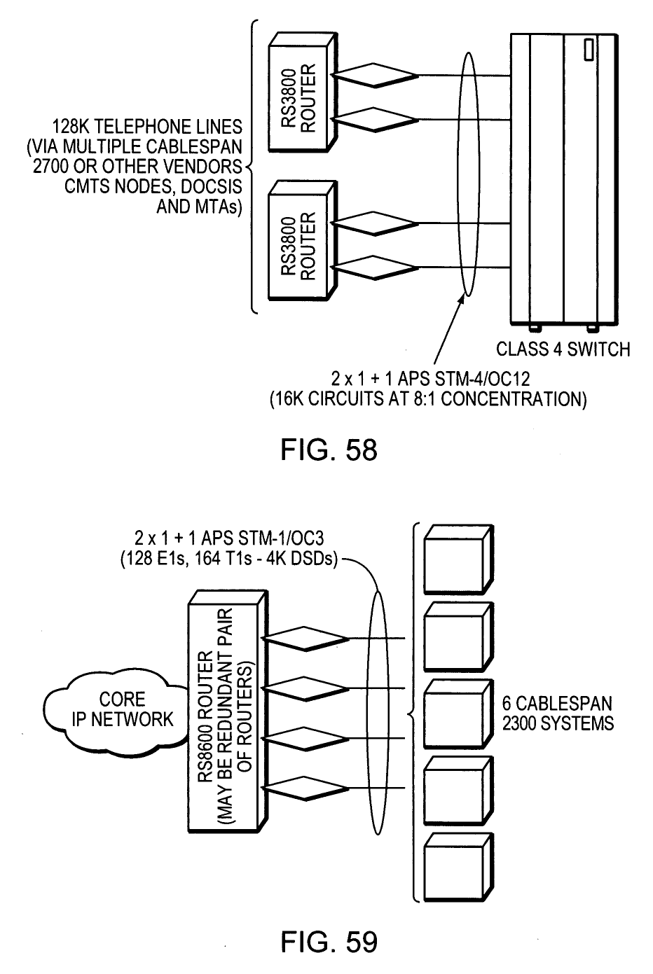

Considering a hypothetical subscriber capacity of 128,000, and assuming a deployment using the STM-4/OC12 Dragon modules in a router, then four Dragon modules would be deployed in two routers (for reliability) offering eight 1+1 APS STM-1/OC3 interfaces or two 1+1 APS STM-4/OC12 interfaces. The other slots in the router can be used for high speed interfaces for connecting to ISPs and the served CMTS systems. This is shown in FIG. 58. FIG. 58 illustrates a local exchange Dragon (128,000 lines).

Features from Above-Described V5/GR-303 Telephony Server for PacketCable

When deployed as a Local Exchange, Dragon the following features already defined in 0 for the V5/GR-303 Dragon can also be useful for: Security Management, for TGCP Control, RTCP Control and RTP Data interfaces for example; and Interoperability mechanisms for non-PacketCable devices.

TGCP-Gateway

In order to allow connection control from a MGC (SoftSwitch), the Dragon supports the Trunking Gateway Control Protocol (TGCP) as defined in PKT-SP-TGCP-101-991201 (a PacketCable profile of MGCP) as a gateway.

Note as TGCP is a profile of MGCP, then this feature is fully consistent with the core feature described above.

Tones and Announcements

The Dragon supports the ability to deliver call progress tones and/or announcements to a call connection, in either the IP or TDM direction, at any time during call set-up or (for the purposes of certain service features) post call set up.

All tones and announcements are programmable on the Dragon either by specification of tone parameters (cadence, frequency, level etc.) for tones, or by download of .wav or equivalent files for announcements.

Each Dragon module supports at least 32 distinct tones and is capable of delivering them to 100% of its connections (assuming an average call hold time of 15 seconds in such cases).

Each Dragon module supports at least 100 distinct announcements, with an overall capacity of at least 900 seconds, and is capable of delivering announcements as per the following discussion.

In normal operation the Dragon is capable of delivering announcements to 20% of its possible total connections (assuming an average call hold time of 15 seconds in such cases). In this case as there is a mix of normal calls and calls with announcement connections then the number of “possible total connections” is interpreted to mean the total available capacity (e.g. 2016 connections per OC3).

In the case of exceptional circumstances (e.g. network failure) the Dragon is capable of broadcasting (in phased fashion) a small number (no more than 5) of distinct announcements to 100% of its connections (assuming an average call hold time of 15 seconds in such cases). In this case, as 100% of connections are having announcements delivered, then the actual number of connections to which announcements can be connected simultaneously is a function of the call performance of the Dragon and the average call holding time. For example the worst case performance requirements for an OC3/STM-1 is 40 calls per second (at 10 calls per second per 500 circuits for mobile trunks circuits), therefore assuming an average call holding time of 15 seconds the maximum number of connections to which announcements would be delivered would be 600.

SS7 Backhaul

Note SS7 is used as the signalling protocol between the PSTN and the MGC.

When deployed in a network where SS7 signalling is transported in associated links (F-links) then the Dragon supports SS7 backhaul functionality to the SG/MGC. This involves the following capabilities: the termination of SS7 MTP2 links on its TDM transport interfaces; the encapsulation of the MTP3 payload in the MTP2-User Adaptation Layer (M2UA—see IETF draft-ietf-sigtran-m2ua-06.txt-SS7 MTP2); and the reliable transport of the M2UA stream to the Signalling Gateway or SoftSwitch via SCTP (ETF RFC 2690).

The Dragon allows for the diverse routing of SS7 links within a linkset using separate SCTP associations, and provides that SS7 link failure will not be caused by other (unrelated) hardware or software failures in the system. “Unrelated” is used here to describe any function that has no involvement in the function of SS7 backhaul, and so it is acceptable that a failure in the core network might affect the links being backhauled. The intention is to ensure that if SS7 backhaul is supported on a multifunctional unit/board, then a failure which only affects one of the other functions of that unit/board would not cause a failure of the backhaul function.

MF Trunk Support

The Dragon hosts trunks to existing PSTN type services such as emergency call centres (911, E-911, 112) and operator support systems (Directory Assistance, etc.). Where these are SS7 controlled trunks then the feature defined in 0 covers such support. However many operators require support for MF based trunks for these services.

The Dragon supports the termination of trunks using MF signalling as defined in section 16 of GR-506-CORE-LSSGR, specifically for the trunks to Operator Support Systems (see GR-1144-CORE) and (emergency) Public Service Access Points (GR-2953). This involves the following capabilities: Recognition of incoming MF signals and their transfer to the MGC via MGCP; and Generation of outgoing MF signals under MGCP control from the MGC.

Local Exchange Dragon for Legacy HFC Networks

Note that PacketCable specifications do not, currently, extend to the specification of interworking with legacy (TDM based) HFC telephony networks. Therefore the specifics included in this portion of the discussion are based, where appropriate on a logical extension of PacketCable requirements.

Typical Bandwidth Allocations

For this application the Dragon modules are deployed in higher-order routers (rather than the lower-level CMTS systems), for example. The Dragons could support multiple CableSpan 2300 systems. This is shown, for example, in FIG. 59. FIG. 59 illustrates a local exchange Dragon for legacy HFC systems (20,000 lines). In the example illustration of FIG. 59, the CableSpan 2300 systems are served by between 6 and 18 V5/GR-303 interfaces (1-3 per 2300) which are split across the Dragon modules for reliability. Note that interface and equipment redundancy schemes are defined above.

Features from Above-Described V5/GR-303 Telephony Server for PacketCable and Local Exchange Dragon for PacketCable

When deployed as a Local Exchange Dragon for Legacy HFC networks the following features already defined above for the V5/GR-303 Dragon and for PacketCable Local Exchange Dragon can also be relevant: Security Management; For MGCP Control (as defined for TGCP), RTCP Control and RTP Data interfaces; Interoperability mechanisms for non PacketCable devices; Tones and Announcements; SS7 Backhaul; and MF Trunk Support.

V5 Backhaul

The Dragon supports the termination of V5.2 signalling links (Q.921 data links) and the transport of the higher layer protocols to a managing SoftSwitch. This involves the following capabilities, for example: the termination of Q.921 links on its TDM transport interfaces; the encapsulation of the higher layer protocols in the V5.2-User Adaptation Layer (V5UA—see IETF draft-ietf-sigtran-v5ua-00.txt—V5.2-User Adaption Layer); the reliable transport of the V5UA stream to the Signalling Gateway or SoftSwitch via SCTP (IETF RFC 2690).

The Dragon supports the above backhaul capabilities for signalling to support up to three distinct V5 interfaces per 500 TDM circuits being supported.

GR-303 Backhaul

The Dragon supports the termination of GR-303 EOC and TMC signalling links (Q.921 data links) and the transport of the higher layer protocols to a managing SoftSwitch. This involves the following capabilities, for example: the termination of Q.921 links on its TDM transport interfaces; the encapsulation of the timeslot management protocol in the ISDN User Adaptation Layer (IUA—see IETF draft-ietf-sigtran-v5ua-00.txt - V5.2-User Adaption Layer, IETF RFC 3057-ISDN Q.921); the reliable transport of the IUA stream to the Signalling Gateway or SoftSwitch via SCTP (IETF RFC 2690); Methods for encapsulation and reliable transfer of the Embedded Operations protocol (CMIP) to the SoftSwitch.

In addition the Dragon is responsible for supporting CAS Robbed Bit Signalling interworking with MGCP to the SoftSwitch, using standard MGCP CAS packages as defined in IETF RFC 3064-MGCP CAS Packages. The Dragon supports the above backhaul capabilities for signalling to support up to three distinct GR303 interfaces per 500 TDM circuits being supported.

Class 5 Support

As the Dragon can effectively provide the access interfaces of a Local (Class 5) Exchange, then it ideally provides some level of support for Local/Class 5 operation and services. This may include (but is not restricted to) the following capabilities: Dial Tone provision (including stutter dial tone); Multi party conference call handling; DTMF Digit Detection/generation; Call Waiting tone insertion; Calling Name/Number signalling (FSK tones).

### Example Possible XDSL Application Features

Dragons can also be configured to support certain XDSL application features.

### Example Possible IP Telephony Tandem Switching Application Features

This portion of the discussion defines various features which may be more specific to the IP Telephony Tandem Switching application. This notwithstanding, many features listed in this portion of the discussion may also be applicable to other applications outside the scope of IP Telephony Tandem Switching.

Features from Other Applications

When deployed as a Dragon for IP Telephony Tandem Switching networks the following features already defined above for the V5/GR-303 Dragon, for PacketCable Local Exchange Dragon and for Local Exchange Dragon for Legacy HFC Networks can also be relevant: Security Management; For MGCP Control (as defined for TGCP), RTCP Control and RTP Data interfaces; Tones and Announcements; and SS7 Backhaul.

PRI Q.931 Backhaul

Note that Q.931 is used as the signalling protocol between ISDN PBXs and the MGC.

When deployed in a tandem network that supports direct connection of ISDN PBXs then the Dragon supports PRI backhaul functionality to the MGC. This can involve the following capabilities, for example: the termination of PRI Q.921 links on its TDM transport interfaces; the encapsulation of the Q.931 payload in the ISDN-User Adaptation Layer (IUA—see IETF draft-ietf-sigtran-v5ua-00.txt, IETF RFC 3057—ISDN Q.921); and the reliable transport of the IUA stream to the Signalling Gateway or SoftSwitch via SCTP (ETF RFC 2690).

This feature also includes PRI infrastructure type support (such as NFAS support, D-Channel backup etc.)

Legacy Interface Support

The Dragon supports legacy trunk interfaces to non-SS7 telephone exchanges and non-ISDN PBXs. This involves the following capabilities: recognition of telephony events on legacy interfaces; transport of event information to the MGC via MGCP; and initiation of telephony events on legacy interfaces under MGCP control.

The legacy interface types supported include, but are not necessarily be restricted to, the following interface types: North American E-911 and Operator Services MF interfaces; CAS Robbed Bit Signalling; CAS TS16 Signalling (e.g. MELCAS); and MF R1, R2 trunk signalling.

### Example IP Business Service Transport Application Features

This portion of the discussion defines various features which may be more specific to the IP Business Service Transport application. This notwithstanding, many features listed in this portion of the discussion may also be applicable to other applications outside the scope of the IP Business Service Transport.

TDM Structure Pseudo Circuit Emulation

The Dragon supports the emulation of TDM structures (such as E1, Nx64 kbit/s etc.) across an IP network between pairs of Dragon modules. This can include the following capabilities: Individual DS0 transport using standard VoIP; Optional Voice Compression; End-to-end transport of the TDM structure overhead (e.g. E1 TS0 S bits); Voice Activity Detection and Silence Suppression on voice/data channels (TDM-IP); and Configurable Comfort Noise or Idle Code Generation for silent voice channels (IP-TDM).

The establishment and disconnect of such emulated circuits are possible via the Dragons management interface.

TDM Signalling Protocol Tunnelling

The Dragon supports end-to-end tunnelling of TDM signalling protocols, for both inter-PBX and PBX-PSTN protocols, such that the signal may be re-constituted at the IP-TDM egress point for delivery to a TDM network element.

Protocols that need to be tunnelled in such a manner may include (but are not necessarily restricted to): Q.931; QSIG; DPNSS; MELCAS; R2 and other MF schemes; and Meridian V.24/V.28 9.6 kbs.

Note that different tunnelling mechanisms can be used for different signalling types (e.g. Sigtran based mechanisms may be available for CCS signalling schemes, MF based schemes may use RFC2833 etc.)

Interworking with IP Telephony Devices

The Dragon support interworking with IP enabled business telephony devices (e.g. IP PBXs) and IP telephony applications (e.g. Microsoft NetMeeting) for the purposes of circuit transport and call set-up between the IP and TDM domains. This capability includes circuit emulation techniques for leased line provision and call control mechanisms.

Call control signalling for IP Telephony interworking can include, for example, the following protocols: SIP; and H.323 (including Clarent and Cisco variants).

When supporting such call control interworking the Dragon acts as if it were itself another IP telephony device. This feature may, in some cases, involve SoftSwitch support.

Manager Integration

If desired, a management interface for a Dragon may be fully integrated with the manager for other network equipment, such that all configuration and fault management associated with the above capabilities may be controlled via a single manager as part of an end-to-end management solution.

### Miscellaneous

This portion of the discussion details (at a high level) certain characteristics that may be pertinent to components of an overall solution, beyond the scope of the Dragon product itself.

Characteristics Related to External Components

The following list details potentially pertinent characteristics on a host system into which the Dragon module embodiment described herein may be integrated:

Host System

The following list details potentially pertinent characteristics on a host system into which the Dragon module embodiment described herein may be integrated: Back-plane Interface; External Interfaces; Synchronisation Sources; and Dragon Integration.

With respect to Backplan Interface, the host may provide an IP based back-plane interface over which the Dragon module can pass and receive IP traffic containing data, control and management paths.

With respect to External Interfaces, the host may provide multiple external IP interfaces (10BaseT, 100BaseT, Gigabit Ethernet, POS) for providing connectivity for data, control and management paths between the Dragon modules and other external components. Typically two physically separate interfaces may be necessary for data, and two for combined management and control.

With respect to Synchronisation Sources, where the host provides a synchronisation source (including interfaces to external references) then this may be used by the Dragon provided that it meets the general details highlighted above in the description regarding Synchronization.

With respect to Dragon Integration, it is possible to integrate the Dragon module into the host system with, for example, certain minimal capabilities including the ability to pass IP data streams to an IP network via the back-plane and external interfaces, and the ability for the host system to recognise/validate the presence of Dragon modules and perform a minimal set of card state management functions on them. In addition the host system may be required to provide some reliable storage capabilities for online storage of PM data, etc.

SoftSwitch

The SoftSwitch may come into play only for the Local Exchange Dragon and IP Telephony Tandem Switching applications; there is no SoftSwitch requirement, for example, for the V5/GR303 Dragon and IP Business Service Transport applications.

Note for the purposes of this portion of the discussion the SoftSwitch entity is assumed to include the Media Gateway Controller (MGC), the Signalling Gateway (SG) and, for the purposes of PacketCable access, the Call Management Server (CMS).

The SoftSwitch in a Dragon VoIP Local Exchange or IP Telephony Tandem Switching application can have the following example capabilities: SS7 Interfaces; V5/GR303 Signalling (VoIP Local Exchange Only); PRI PBX Support (IP Telephony Tandem only); NMf Trunk Signalling Support; Other Legacy Trunk Signalling Interfaces (IP Telephony Tandem only); Real Time Call Control; Connection Control; Call Accounting; End User Services; and CMS Functionality (VoIP Local Exchange only).

With respect to SS7 Interfaces, for call control and transaction capabilities with the PSTN the SoftSwitch ideally supports termination of MTP signalling links for the purposes of transfer of ISUP and TCAP messages (and any other SS7 user parts as appropriate to the particular network).

With respect to V5/GR303 Signalling, for call control capabilities with legacy access networks the SoftSwitch ideally supports network side V5.2 and GR-303 protocols.

With respect to PRI PBX Support, for the support of PBXs that connect to the Dragon via Q.931 PRI interfaces.

With respect to MF Trunk Signalling Support, for the purposes of terminating MF trunks to Emergency and Operator Service centers and as legacy trunk interfaces to other exchanges and PBXs.

With respect to Other Legacy Trunk Signalling Interfaces, in addition to support for MF trunks, the SoftSwitch ideally should be capable of supporting other legacy trunk interfaces such as robbed bit or TS16 CAS interfaces to legacy exchanges and PBXs.

With respect to Real Time Call Control, the SoftSwitch supervises the set-up and tear-down of calls using the Dragon modules and other components to provide the transport and switching capabilities.

With respect to Connection Control, the SoftSwitch uses the MGCP protocol to control connection set up and tear down in the Dragon modules and any MGCP enabled access device.

With respect to Call Accounting, the SoftSwitch records all pertinent data associated with each call and provide such data in a consistently formatted Call Detail record (CDR) for offline processing by some external billing or mediation system.

With respect to End User Services, the SoftSwitch provides value adding subscriber services such as Class 5/Local Exchange services (e.g. Call Waiting, Call Diversion etc.), IN/AIN Services (e.g. Toll Free, LNP, Credit Card Calls) and next generation IP based services, possibly in conjunction with a SIP application server (e.g. IP Centrex, Presence etc.).

With respect to CMS Functionality, the SoftSwitch supports the functions associated with a Call Management Server (CMS) as defined in PKT-TR-ARCH-V01-991201.

IP Access Device

IP Access devices include customer premises devices that provide connectivity across the IP access network; i.e. for PacketCable access this is the Cable Modem and Multimedia Terminal Adapter (CM/MTA).

The access device(s) in a Dragon application can have the following capabilities, for example: Telephony Ports; Connection Control; V5.2/GR-303 Interworking; Voice Encoding/Decoding; IP Addressing; and Access Protocol.

With respect to Telephony Ports, the access device can support (multiple) telephony ports that appear to the end user as a standard POTS port (e.g. RJ45).

With respect to Connection Control, the access device can support the MGCP protocol for the purpose of allowing controlling devices (SoftSwitch or Dragon) to set-up and tear-down connections between its POTS ports and an IP voice path. MGCP can also be used for signalling line state events, such as “Off Hook” and “On Hook”.

With respect to V5.2/GR-303 Interworking, although the access device is not required to support V5.2 or GR-303 interworking directly, there are some implications on it due to the fact that the (upstream) Dragon is supporting such interworking. This includes (but is not necessarily restricted to) the ability to disable digit collection (to allow for DTMF digits to be collected at the LDS) and the ability to transfer line state events (such as “Off Hook” and “On Hook”) via RTP (using IETF RFC 2833) rather than MGCP.

With respect to Voice Encoding/Decoding, the access device can be capable of encoding voice signals received on the POTS port into G.711 PCM stream (or some compression algorithm such as G.723.2, G.729a) and passing the coded signal on a RTP over IP stream over the access IP network. The reverse functionality (i.e. G.711 VoIP-Analogue signal decoding) is also possible and, perhaps, desirable.

With respect to IP Addressing, the access device can possess a unique IP address such that it may be addressed by the MGCP controlling device.

With respect to Access Protocol, the access device can support DOCSIS as an access IP transport layer.

Ideally, the Dragon is also capable of interworking with other IP access devices such as xDSL IADs and SIP Phones, for example.

What is claimed is

1. A method for interfacing between a circuit-switched network and a packet network, the method comprising:
establishing a first gateway device having a first interface configured to interface with the circuit-switched network and a second interface configured to interface with the packet network;
establishing a second gateway device having a first interface configured to interface with the circuit-switched network and a second interface configured to interface with the packet network;
designating one of the two gateway devices as an active gateway device and the other of the two gateway devices as a standby gateway device;
providing communications traffic from the circuit-switched network to the active gateway device and the standby gateway device, and transmitting the communications traffic from the active gateway device to the packet network;
receiving at a receiving end the communications traffic transmitted across a first path of the packet network by the active gateway device; and
upon an occurrence of a fault in the packet network between the active gateway device and the receiving end, transmitting the communications traffic from the standby gateway device and receiving at the receiving end the communications traffic transmitted across a second path of the packet network by the standby gateway device, wherein the receipt at the receiving end of the communications traffic transmitted across the second path of the packet network occurs within 50 milliseconds after the occurrence of the fault.

2. The method of claim 1, wherein the first and second gateway devices are identified with virtual internet protocol (IP) addresses.

3. The method of claim 1, wherein the communications traffic is multicasted.

4. The method of claim 1, wherein the communications traffic from the circuit-switched network to the active gateway device is also transmitted to the standby gateway device upon an occurrence of a fault in the circuit-switched network to the standby gateway device.

5. The method of claim 1, further comprising delaying transmission of the communication traffic through the active gateway device so that it lines up in time with an arrival of the communication traffic to the standby gateway device.

6. The method of claim 1, wherein an outgoing signaling DS0 to each of the first and second gateway device is replicated and transmitted to the other gateway device.

7. The method of claim 1, further comprising ensuring both the first gateway device and the second gateway device have the same robbed big signaling (RBS) values.

8. The method of claim 1, further comprising monitoring delay of packets in the communications traffic between either the first or second gateway devices and the receiving end to detect congestion.

9. The method of claim 1, wherein the communications traffic transmitted across the second path of the packet network by the standby gateway is routed from a router on the second path of the packet network to a router on a portion of the first path of the packet network not affected by the fault.

10. The method of claim 1, wherein the first and second path of the packet network utilize multiprotocal label switching (MPLS).

11. The method of claim 1, wherein a collector is coupled to each of the first and second gateway devices.

12. A method for interfacing between a circuit-switched network and a packet network, the method comprising:
establishing a first gateway device having a first interface configured to interface with the circuit-switched network and a second interface configured to interface with the packet network;
establishing a second gateway device having a first interface configured to interface with the circuit-switched network and a second interface configured to interface with the packet network;
designating one of the two gateway devices as an active gateway device, and the other of the two gateway devices as a standby gateway device;
upon an occurrence of a fault across a first path of the packet network between the active gateway device and a receiving end, transmitting communications traffic across a second path of the packet network between the standby gateway device to the receiving end, wherein receipt of the communications traffic from the second path of the packet network occurs within 50 milliseconds after the occurrence of the fault.

13. The method of claim 12, wherein the communications traffic from the circuit-switched network to the active gateway device is also transmitted to the standby gateway device upon an occurrence of a fault in the circuit-switched network to the standby gateway device.

14. The method of claim 12, further comprising delaying transmission of the communication traffic through the active gateway device so that it lines up in time with an arrival of the communication traffic to the standby gateway device.

15. The method of claim 12, further comprising monitoring delay of packets in the communications traffic between either the first or second gateway devices and the receiving end to detect congestion.

16. The method of claim 12, wherein the communications traffic transmitted across the second path of the packet network by the standby gateway is routed from a router on the second path of the packet network to a router on a portion of the first path of the packet network not affected by the fault.

17. The method of claim 12, wherein the first and second path of the packet network utilize multiprotocal label switching (MPLS).

18. The method of claim 12, wherein a collector is coupled to each of the first and second gateway devices.

19. A gateway system, comprising:
a first gateway device having a first interface to interface with a circuit-switched network and a second interface to interface with a packet network, wherein the first gateway device is designated as an active gateway device to transmit communications traffic to a receiving end in the packet network across a first path of the packet network; and
a second gateway device having a first interface to interface with the circuit-switched network and a second interface to interface with the packet network, wherein the second gateway device is designated as a passive gateway device to transmit communications traffic to the receiving end in the packet network across a second path of the packet network upon an occurrence of a fault on the first path.

20. The method of claim 19, wherein receipt of the communications traffic from the second path of the packet network occurs within 50 milliseconds after the occurrence of the fault.
